(19) United States
(12) Patent Application Publication
(10) Pub. No.: US 2021/0110369 A1
(43) Pub. Date: Apr. 15, 2021

(54) INFORMATION PROCESSING METHOD, PROGRAM, AND TERMINAL

(71) Applicant: LINE PAY CORPORATION, Tokyo (JP)

(72) Inventors: Ryosuke Hamasako, Tokyo (JP); Yosuke Mazaki, Tokyo (JP)

(73) Assignee: LINE PAY CORPORATION, Tokyo (JP)

(21) Appl. No.: 17/129,346

(22) Filed: Dec. 21, 2020

Related U.S. Application Data
(63) Continuation of application No. PCT/JP2020/022296, filed on Jun. 5, 2020.

(30) Foreign Application Priority Data
Jul. 24, 2019 (JP) 2019-136336
Jul. 24, 2019 (JP) 2019-136337

(51) Int. Cl. G06Q 20/20; G06Q 20/40; G06K 19/06; G06Q 20/32

(52) U.S. Cl. CPC G06Q 20/202; G06Q 20/4037; G06K 19/06112; G06K 2007/10524; G06Q 20/208; G06K 19/06028; G06K 19/06037; G06Q 20/3276

(57) ABSTRACT

An information processing method to be carried out by a terminal may be provided. The information processing method may include: obtaining a payment request; receiving payment processing information from a server to process a payment based on the payment request; and adjusting a payment setting regarding at least one of an amount of money to be used for the payment, and a user authentication for the payment, based on a communication state of the terminal.

### CROSS-REFERENCE TO RELATED APPLICATIONS

This application is a continuation of International Application No. PCT/JP2020/022296 filed on Jun. 5, 2020, which claims priority from Japanese Patent Application No. 2019-136336, filed on Jul. 24, 2019, and Japanese Patent Application No. 2019-136337, filed on Jul. 24, 2019, in the Japanese Patent Office, the disclosures of which are incorporated herein by reference in their entireties.

### BACKGROUND

### 1. Field

The present disclosure relates to an information processing method, a program, and a terminal.

### 2. Description of Related Art

Nowadays, mobile payments or electronic payments are widely used as popular alternatives to traditional payment models. Mobile and/or electronic payment services allow users to send and receive funds from person to person, through mobile devices (e.g., smartphones and tablets), and also allow businesses to process payments that are made in-store through mobile devices.

### SUMMARY

According to an aspect of an example embodiment, there is provided an information processing method to be carried out by a terminal configured to execute a payment processing operation related to a payment based on first information for making the payment using a code image, the information processing method including: receiving, by a communication interface of the terminal, the first information transmitted from a server; storing, by a processor of the terminal, the first information in a memory of the terminal; and controlling, by the processor, a payment setting related to the payment that is based on the first information, based on a communication state of the terminal.

When the communication state is a first communication state, the processor may be configured to set the payment setting to a first payment setting, and when the communication state is a second communication state, the processor may be configured to set the payment setting to a second payment setting which is different from the payment first setting. A second communication amount of communicated information in the second communication state may be smaller than a first communication amount of communicated information in the first communication state.

The payment setting may include an amount setting related to an amount that to be used for the payment.

The payment setting may include an authentication setting related to authentication of a user of the terminal, the terminal being configured to execute the payment processing operation related to the payment.

The processor may be configured to: control the authentication as the payment setting when more than a first payment amount is paid as an amount of the payment and the communication state of the terminal is a first communication state; and control the authentication as the payment setting when more than a payment second amount is paid as the amount of the payment and the communication state of the terminal is a second communication state. The second amount may be smaller than the first amount, and a second communication amount of communicated information in the second communication state may be smaller than a first communication amount of communicated information in the first communication state.

The information processing method may further include: displaying a first code image that is based on the first information in a display region of the terminal, wherein, when the communication state of the terminal is such that a communication amount of the terminal is smaller than a set communication amount, the processor may be configured to control the authentication as the payment setting, based on the first code image that is hidden from the display region.

When the communication state of the terminal is such that a communication amount of the terminal is smaller than a set communication amount, the processor may be configured to control the authentication based on a duration during which the communication amount is smaller than the set communication amount.

The information processing method may further include: displaying a first code image that is based on the first information in a display region of the terminal, wherein the payment setting may include a validity period setting related to a period of validity of the first code image.

The information processing method may further include: acquiring, by the processor, store information related to a store at which the payment is to be made; and controlling, by the processor, the payment setting based on the communication state of the terminal and reliability of the store.

The information processing method may further include: displaying a first code image that is based on the first information in a display region of the terminal; and controlling a display of the terminal, by the processor, to display second information based on the communication state of the terminal, in the display region in which the first code image is displayed.

The second information may include a notification related to hiding of the first code image when the communication state of the terminal is such that a communication amount of the terminal is smaller than a set communication amount.

When the communication state of the terminal is a first communication state, the processor may be configured to control a display of the terminal to display first validity period information related to a first period of validity as the second information in the display region of the display. When the communication state of the terminal is a second communication state, the processor may be configured to control the display to display second validity period information related to a second period of validity as the second information in the display region. The second period of validity may be shorter than the first period of validity. A second communication amount of communicated information in the second communication state may be smaller than a first communication amount of communication information in the first communication state. When the second period of validity has expired, the processor may be configured to control the display to hide the first code image from the display region of the display.

The terminal may include a first communication interface and a second communication interface which is different from the first communication interface. The communication state of the terminal may be a first communication state of the first communication interface of the terminal. The information processing method may further include, when the communication state of the terminal is such that a communication amount of the terminal is smaller than a set communication amount, controlling a display of the terminal, by the processor, to hide the first code image from the display region of the display based on payment completion information related to completion of the payment, the payment completion information being transmitted from a communication device and received by the second communication interface of the terminal.

The information processing method may further include: displaying a first code image that is based on the first information in a display region of the terminal; controlling a display of the terminal, by the processor, to hide the first code image from the display region of the display; and transmitting, by the communication interface, third information indicating that the first code image is hidden from the display region to the server.

The third information may be transmitted by the communication interface to the server based on the communication state of the terminal.

The third information may be transmitted by the communication interface to the server at a set timing.

The information processing method may further include: displaying a first code image that is based on the first information in a display region of the terminal; and when the communication state of the terminal is such that a communication amount of the terminal is smaller than a set communication amount, disabling, by the processor, the first code image based on the first code image being hidden from the display region.

The second information may be information related to a period of validity of the first code image, and the information processing method may further include: when the communication state of the terminal is such that a communication amount of the terminal is smaller than a set communication amount and the period of validity has not expired, controlling a display of the terminal, by the processer, after hiding the first code image from the display region of the display, to display the first code image in the display region based on input in respect with the terminal by a user of the terminal, and when the communication state of the terminal is such that the communication amount of the terminal is smaller than the set communication amount and the period of validity has expired, controlling the display, by the processor, to disable the first code image.

A plurality of the first information may be stored in the memory, and the information processing method may further include: displaying a first code image that is based on one of the plurality of the first information, in a display region of the terminal; and when the communication state of the terminal is such that a communication amount of the terminal is smaller than a set communication amount, controlling a display of the terminal, by the processor, after hiding the first code image from the display region of the display, to display a second code image which is different from the first code image in the display region based on input in respect with the terminal by a user of the terminal, the second code image being based on one of the plurality of the first information.

The information processing method may further include: when the communication state of the terminal is such that a communication amount of the terminal is smaller than a set communication amount, displaying, in a display region of the terminal, communication status information indicating that communication cannot be performed by the terminal; and displaying, in the display region, a setting of communication performed by the terminal based on an input by a user of the terminal with respect to the communication status information indicating that communication cannot be performed.

The communication status information indicating that communication cannot be performed indicates that the first information cannot be received from the server.

According to an aspect of another example embodiment, there is provided a non-transitory computer readable storage medium storing program instructions that are executable by a processor of a terminal, to perform an information processing method, the terminal being configured to perform a payment processing operation related to a payment based on first information for making the payment using a code image, the information processing method including: receiving, by a communication interface of the terminal, the first information transmitted from a server; storing, by the processor, the first information in a memory of the terminal; and controlling, by the processor, a payment setting related to the payment that is based on the first information, based on a communication state of the terminal.

According to an aspect of another example embodiment, there is provided a terminal configured to execute a payment processing operation relating to a payment based on first information for making the payment using a code image, the terminal including: a memory configured to store computer-readable program instructions; and one or more processors configured to execute the program instructions to: receive the first information from a server, control the memory to store the first information in the memory of the terminal, and control a payment setting related to the payment that is based on the first information, based on a communication state of the terminal.

### BRIEF DESCRIPTION OF THE DRAWINGS

FIG. 1 is a diagram showing an example of a configuration of a communication system in an aspect of an embodiment.

FIG. 2 is a diagram showing an example of a system configuration of a store point-of-sale (POS) system in an aspect of an embodiment.

FIG. 3A is a flowchart showing an example flow of processing that is executed by various devices in an aspect of an embodiment.

FIG. 3B is a diagram showing an example of a display screen of a terminal in an aspect of an embodiment.

FIG. 3C is a diagram showing an example of a display screen of a terminal in an aspect of an embodiment.

FIG. 3D is a flowchart showing an example flow of processing that is executed by various devices in an aspect of an embodiment.

FIG. 4A is a diagram showing an example of functions implemented by a controller of a server according to a first embodiment.

FIG. 4B is a diagram showing an example of information stored in a storage of the server according to the first embodiment.

FIG. 4C is a diagram showing an example of user registration data according to the first embodiment.

FIG. 4D is a diagram showing an example of store registration data according to the first embodiment.

FIG. 4E is a diagram showing an example of a payment management database according to the first embodiment.

FIG. 4F is a diagram showing an example of a code management database according to the first embodiment.

FIG. 4G is a diagram showing an example of functions implemented by a controller of a terminal according to the first embodiment.

FIG. 4H is a diagram showing an example of information stored in a storage of the terminal according to the first embodiment.

FIG. 4I is a diagram showing an example of first terminal-display-code stock data according to the first embodiment.

FIG. 4J is a diagram showing an example of second terminal-display-code stock data according to the first embodiment.

FIG. 4K is a diagram showing an example of first payment data according to the first embodiment.

FIG. 4L is a diagram showing an example of first code-related information display control data according to the first embodiment.

FIGS. 4M and 4N are diagrams showing examples of a display screen of the terminal according to the first embodiment.

FIG. 4O is a diagram showing an example of a display screen of the terminal according to the first embodiment.

FIG. 4P is a diagram showing an example of a display screen of the terminal according to the first embodiment.

FIG. 4Q is a flowchart showing an example flow of processing that is executed by various devices according to the first embodiment.

FIG. 4R is a flowchart showing an example flow of first code display processing according to the first embodiment.

FIG. 4S is a diagram showing an example of a display screen of a terminal according to a first variation.

FIG. 4T is a diagram showing an example of a display screen of the terminal according to the first variation.

FIG. 4U is a diagram showing an example of a display screen of the terminal according to the first variation.

FIG. 4V is a diagram showing an example of a display screen of the terminal according to the first variation.

FIG. 4W is a diagram showing an example of a display screen of the terminal according to the first variation.

FIG. 4X is a diagram showing an example of a display screen of the terminal according to the first variation.

FIG. 4Y is a flowchart showing an example flow of processing that is executed by various devices according to the first variation.

FIG. 5A is a diagram showing an example of functions implemented by a controller of a terminal according to a second embodiment.

FIG. 5B is a diagram showing an example of information stored in a storage of the terminal according to the second embodiment.

FIG. 5C is a diagram showing an example of second payment data according to the second embodiment.

FIG. 5D is a diagram showing an example of first payment-related setting control data according to the second embodiment.

FIGS. 5E to 5G are diagrams showing an example of a display screen of the terminal according to the second embodiment.

FIG. 5H is a diagram showing an example flow of payment-related setting control processing according to the second embodiment.

FIG. 5I is a diagram showing an example of second payment-related setting control data according to a second variation.

FIG. 5J is a diagram showing an example of third payment-related setting control data according to the second variation.

FIG. 6A is a diagram showing an example of second code-related information display control data according to a third embodiment.

FIG. 6B is a diagram showing an example of a display screen of a terminal according to the third embodiment.

FIG. 6C is a diagram showing an example of a display screen of the terminal according to the third embodiment.

FIG. 6D is a diagram showing an example of a display screen of the terminal according to the third embodiment.

FIG. 6E is a diagram showing an example of a display screen of the terminal according to the third embodiment.

FIGS. 6F to 6H are diagrams showing an example of a display screen of the terminal according to the third embodiment.

FIG. 6I is a flowchart showing an example flow of second code display processing according to the third embodiment.

FIG. 6J is a flowchart showing an example flow of third code display processing according to the third embodiment.

FIG. 6K is a diagram showing an example of a display screen of a terminal according to a third variation.

FIG. 6L is a diagram showing an example of a display screen of the terminal according to the third variation.

FIGS. 7A to 7C are diagrams showing an example of a display screen of a terminal according to a fourth embodiment.

FIGS. 7D and 7E are diagrams showing an example of a display screen of the terminal according to the fourth embodiment.

FIGS. 7F to 7H are diagrams showing an example of a display screen of the terminal according to the fourth embodiment.

FIG. 7I is a flowchart showing an example flow of first code redisplay processing according to the fourth embodiment.

FIG. 7J is a flowchart showing an example flow of second code redisplay processing according to the fourth embodiment.

FIG. 8 is a flowchart showing an example flow of processing that is executed by a terminal and a server according to a fifth embodiment.

FIG. 9A is a flowchart showing an example flow of processing that is executed by a terminal and a server according to a sixth embodiment.

FIG. 9B is a flowchart showing an example flow of processing that is executed by the terminal and the server according to the sixth embodiment.

FIG. 9C is a flowchart showing an example flow of processing that is executed by the terminal and the server according to the sixth embodiment.

FIG. 9D is a diagram showing an example of a display screen of the terminal according to the sixth embodiment.

FIG. 9E is a diagram showing an example of a display screen of the terminal according to the sixth embodiment.

FIG. 9F is a diagram showing an example of a display screen of the terminal according to the sixth embodiment.

FIG. 9G is a diagram showing an example of a display screen of the terminal according to the sixth embodiment.

### DETAILED DESCRIPTION

Example embodiments are described in greater detail below with reference to the accompanying drawings.

In the following description, like drawing reference numerals are used for like elements, even in different drawings. The matters defined in the description, such as detailed construction and elements, are provided to assist in a comprehensive understanding of the example embodiments. However, it is apparent that the example embodiments can be practiced without those specifically defined matters. Also, well-known functions or constructions are not described in detail since they would obscure the description with unnecessary detail.

Expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, all of a, b, and c, or any variations of the aforementioned examples.

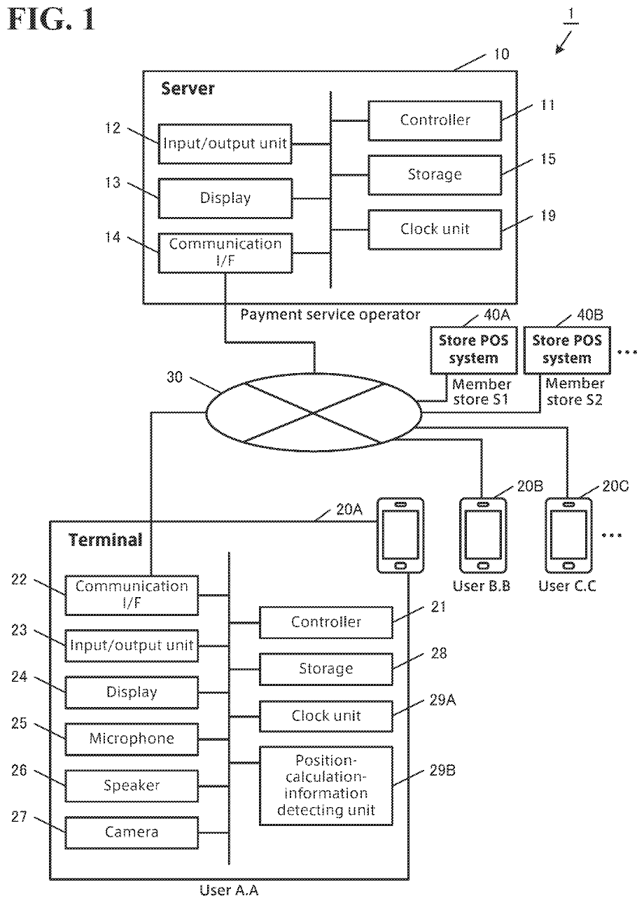

FIG. 1 is a diagram showing an example of a configuration of a communication system 1 according to an embodiment of the present disclosure.

As shown in FIG. 1, in the communication system 1, a server 10, terminals 20 (terminals 20A, 20B, 20C, . . . ), and store POS systems 40 are connected to each other via a network 30.

The server 10 provides, via the network 30 to the terminals 20 used by respective users, a service for enabling the terminals 20 to transmit and receive content including messages and the like. Also, the server 10 provides a service (hereinafter referred to as a “payment service”) for processing an electronic payment (a non-limiting example of payment) by communicating with the terminals 20. Note that there is no limitation on the number of terminals 20 connected to the network 30.

The network 30 serves to connect one or more terminals 20, one or more servers 10, and one or more store POS systems 40 to each other. That is, the network 30 serves as a communication network that provides a connection path to enable the various types of devices described above to transmit and receive data after the devices are connected to each other.

One or more portions of the network 30 may be a wired network or a wireless network. Non-limiting examples of the network 30 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the public switched telephone network (PSTN), a mobile phone network, integrated service digital networks (ISDNs), a radio LAN, long term evolution (LTE), code division multiple access (CDMA), Bluetooth (registered trademark), satellite communication, and a combination of two or more of these networks. The network 30 may be constituted by a single network 30 or a plurality of networks 30.

Each of the terminals 20 (terminals 20A, 20B, 20C, . . . , each being a non-limiting example of a terminal or an information processing device) may be any information processing terminal that is capable of implementing functions described in embodiments. Non-limiting examples of the terminals 20 include a smartphone, a mobile phone (e.g., a feature phone), a computer (non-limiting examples of which include a desktop, a laptop, and a tablet), a media computer platform (non-limiting examples of which include cable and satellite set-top boxes and a digital video recorder), a handheld computer device (non-limiting examples of which include a personal digital assistant (PDA) and an electronic mail client), a wearable terminal (e.g., an eyeglasses-type device, a watch-type device, etc.), and other types of computers and communication platforms. The terminals 20 may also be referred to as “information processing terminals”.

Configurations of the terminals 20A, 20B, and 20C are substantially the same as each other. Also, a terminal that is used by a user X will be referred to as a “terminal 20X”, and user information that is associated with the user X or the terminal 20X in a predetermined service will be referred to as “user information X”, as necessary. The user information is information regarding a user associated with an account that is employed by the user in the predetermined service. Non-limiting examples of the user information include information that is input by the user or is assigned by the predetermined service, and is associated with the user, such as user's name, an icon image of the user, user's age, user's gender, user's address, user's hobbies/preferences, and user's identifier, and the user information may be any one of or a combination of two or more of these pieces of information.

The server 10 (a non-limiting example of a server, an information processing device, or an information management device) is configured to provide a predetermined service to the terminal 20. The server 10 may be any information processing device that is capable of implementing functions described in embodiments. Non-limiting examples of the server 10 include a server device, a computer (non-limiting examples of which include a desktop, a laptop, and a tablet), a media computer platform (non-limiting examples of which include cable and satellite set-top boxes and a digital video recorder), a handheld computer device (non-limiting examples of which include a PDA and an electronic mail client), and other types of computers and communication platforms. The server 10 may also be referred to as an “information processing device”. If there is no need to distinguish the server 10 and the terminal 20, either one or both of the server 10 and the terminal 20 may be referred to as an “information processing device”.

In the following embodiments, the server 10 may provide a payment service that is implemented using a payment application.

Each store POS system 40 is a POS system that is installed in and is used in a store that is tied up with a business operator that operates the server 10.

The store POS system 40 includes a store code reader device 50, a code register 60, and a store server 70, for example, without limitation thereto.

### Hardware (HW) Configurations of Devices

HW configurations of the devices included in the communication system 1 will be described.

### (1) HW Configuration of Terminal

FIG. 1 shows an example of the HW configuration of the terminal 20.

The terminal 20 includes a controller 21 (e.g., a CPU or a processor), a storage 28, a communication I/F (e.g., a communication interface) 22, an input/output unit (e.g., an input/output interface) 23, a display 24, a microphone 25, a speaker 26, a camera 27, a clock unit 29A, and a position-calculation-information detecting unit 29B. The HW constituent elements of the terminal 20 are connected to each other via a bus B, for example, without limitation thereto. Note that the HW configuration of the terminal 20 does not necessarily have to include all of the constituent elements. The terminal 20 may be configured such that one or more constituent elements such as the microphone 25 and the camera 27 are removable.

The communication I/F 22 transmits and receives various types of data via the network 30. The communication may be carried out in a wired or wireless manner, and may be based on any communication protocol that enables mutual communication to be carried out. The communication I/F 22 may communicate with various types of devices such as the server 10 via the network 30. The communication I/F 22 transmits various types of data to the various types of devices such as the server 10 in accordance with instructions from the controller 21. Also, the communication I/F 22 receives various types of data transmitted from the various types of devices such as the server 10 and conveys the data to the controller 21. The communication I/F 22 may also be simply referred to as a “communication unit”. The communication I/F 22 may also be referred to as a “communication circuit” in cases where the communication I/F is constituted by a physically structured circuit.

The input/output unit 23 includes a device that inputs various operations made to the terminal 20 and a device that outputs a result of processing performed by the terminal 20. The input/output unit 23 may be constituted by an input unit and an output unit that are configured as a single unit or are separate from each other.

The input unit is implemented by any one of or a combination of two or more of all types of devices capable of accepting input from a user and conveying information regarding the input to the controller 21. Non-limiting examples of the input unit include a touch panel, a touch display, hardware keys of a keyboard or the like, a pointing device such as a mouse, a camera (input of operations via moving images), and a microphone (input of operations using voice).

The output unit is implemented by any one of or a combination of two or more of all types of devices capable of outputting a result of processing performed by the controller 21. Non-limiting examples of the output unit include a touch panel, a touch display, a speaker (which is configure to output an audio signal), a lens (which is configured to produce a three-dimensional (3D) image output and/or a hologram image output), and a printer.

The display 24 is implemented by any one of or a combination of two or more of all types of devices capable of providing display in accordance with display data written in a frame buffer. Non-limiting examples of the display 24 include a touch panel, a touch display, a monitor (non-limiting examples of which include a liquid crystal display and an organic electroluminescence display (OELD)), a head mounted display (HMD), and devices capable of displaying images, text information, and the like using projection mapping or holograms, or in the air (may optionally be a vacuum). Note that the display 24 may be capable of displaying a 3D image.

If the input/output unit 23 is a touch panel, the input/output unit 23 and the display 24 may also have substantially the same size and shape and be arranged opposing each other.

The clock unit 29A is a built-in clock of the terminal 20 and outputs time information (time measurement information). The clock unit 29A is configured to include a clock that employs a crystal oscillator, for example, without limitation thereto. The clock unit 29A may also be referred to as a “time measurement unit” or a “time information detecting unit”, for example, without limitation thereto.

Note that the clock unit 29A may include a clock to which NITZ Network Identity and Time Zone (NITZ) standards or the like are applied.

The position-calculation-information detecting unit 29B may detect or calculate a location of the terminal 20 to obtain information (hereinafter referred to as “position calculation information”) that is necessary for the controller 21. The position-calculation-information detecting unit 29B may also be referred to as a “position calculation sensor unit”, for example, without limitation thereto.

Note that the position-calculation-information detecting unit 29B is not essential and may also be excluded from the constituent elements of the terminal 20.

Non-limiting examples of the position-calculation-information detecting unit 29B include a satellite positioning sensor (a satellite positioning unit) that is a sensor or a unit for calculating the position of the terminal 20 using a satellite positioning system such as Global Positioning System (GPS) and an inertial measurement sensor (e.g., Inertial Measurement Unit (IMU)) that is a sensor or a unit for calculating the position of the terminal 20 using an inertial navigation system.

The satellite positioning unit includes a Radio Frequency (RF) receiving circuit that converts RF signals, which include a positioning satellite signal emitted from a positioning satellite and received by an antenna, into digital signals and a baseband processing circuit that captures the positioning satellite signal by performing correlation operation processing or the like on a digital signal output from the RF receiving circuit and outputs information such as satellite orbit data and time data that are taken from the positioning satellite signal, as position calculation information, for example, without limitation thereto.

The inertial measurement unit includes an inertial sensor that detects information necessary to calculate the position of the terminal 20 through an inertial navigation operation. The inertial sensor includes a three-axis acceleration sensor and a three-axis gyroscope sensor, for example, without limitation thereto, and outputs acceleration detected by the acceleration sensor and angular velocity detected by the gyroscope sensor, as position calculation information.

The controller 21 includes a physically structured circuit for executing functions that are implemented in accordance with codes or commands included in a program, and is implemented by a data processing device embedded in hardware, for example, without limitation thereto. Accordingly, the controller 21 may be also referred to as a “control circuit”.

Non-limiting examples of the controller 21 include a central processing unit (CPU), a microprocessor, a processor core, a multiprocessor, an Application-Specific Integrated Circuit (ASIC), and a Field Programmable Gate Array (FPGA).

The storage 28 may store various programs and various types of data that are necessary for the terminal 20 to operate. Non-limiting examples of the storage 28 include various storage media such as a Hard Disk Drive (HDD), a Solid State Drive (SSD), a flash memory, a Random Access Memory (RAM), and a Read Only Memory (ROM). The storage 28 may be also referred to as a “memory”.

The terminal 20 stores a program P in the storage 28, and the controller 21 executes the program P to perform operations according to the program P while serving as units that are included in the controller 21. That is, the program P stored in the storage 28 causes the terminal 20 to implement functions executed by the controller 21. The program P may be also referred to as a “program module” or “computer-readable instructions.”

The microphone 25 is used to input audio data. The speaker 26 is used to output audio data. The camera 27 is used to acquire moving image data.

### (2) HW Configuration of Server

FIG. 1 shows an example of the HW configuration of the server 10.

The server 10 includes a controller (e.g., a CPU or a processor) 11, a storage 15, a communication interface (I/F) 14, an input/output unit (e.g., an input/output interface) 12, a display 13, and a clock unit 19. The HW constituent elements of the server 10 are connected to each other via a bus B, for example, without limitation thereto. Note that the HW configuration of the server 10 does not necessarily have to include all of the constituent elements. HW of the server 10 may be configured such that the display 13 is removable.

The controller 11 includes a physically structured circuit for executing functions that are implemented in accordance with codes or commands included in a program, and is implemented by a data processing device embedded in hardware, for example, without limitation thereto.

The controller 11 may include a central processing unit (CPU), and may be implemented as a microprocessor, a processor core, a multiprocessor, an ASIC, or a FPGA. In the present disclosure, the controller 11 is not limited to these examples.

The storage 15 may store various programs and various types of data that are necessary for the server 10 to operate. The storage 15 is implemented by various storage media such as an HDD, an SSD, and a flash memory. However, in the present disclosure, the storage 15 is not limited to these examples. The storage 15 may be also referred to as a “memory”.

The communication I/F 14 transmits and receives various types of data via the network 30. The communication may be carried out in a wired or wireless manner, and may be based on any communication protocol that enables mutual communication to be carried out. The communication I/F 14 may communicate with various types of devices such as the terminal 20 via the network 30. The communication I/F 14 transmits various types of data to the various types of devices such as the terminal 20 in accordance with instructions from the controller 11. Also, the communication I/F 14 receives various types of data transmitted from the various types of devices such as the terminal 20 and conveys the data to the controller 11. The communication I/F 14 may also be simply referred to as a “communication unit”. The communication I/F 14 may also be referred to as a “communication circuit” in cases where the communication I/F is constituted by a physically structured circuit.

The input/output unit 12 is implemented by a device that inputs various operations that are made to the server 10. The input/output unit 12 is implemented by any one of or a combination of two or more of all types of devices capable of accepting input from a user and conveying information regarding the input to the controller 11. The input/output unit 12 is implemented by hardware keys, a typical example of which is a keyboard, and a pointing device such as a mouse. Note that the input/output unit 12 may include a touch panel, a camera (input of operations via moving images), or a microphone (input of operations using voice). However, in the present disclosure, the input/output unit 12 is not limited to these examples.

The display 13 may be implemented as a display monitor. Non-limiting examples of the display 13 may include a liquid crystal display, an organic electroluminescence display (OELD), and a head mounted display (HMD) or the like. The display 13 may display a 3D image. In the present disclosure, the display 13 is not limited to these examples.

The clock unit 19 is a built-in clock of the server 10 and outputs time information (time measurement information). The clock unit 19 is configured to include an Real Time Clock (RTC) as a hardware clock, a system clock, and the like, for example, without limitation thereto. The clock unit 19 may also be referred to as a “time measurement unit” or a “time information detecting unit”, for example, without limitation thereto.

### (3) Configuration of Store POS System

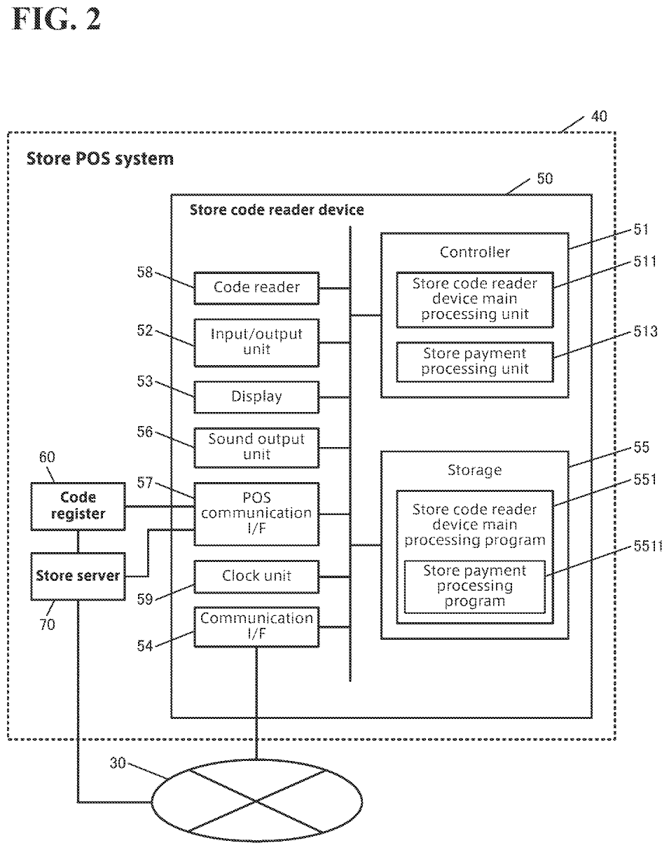

FIG. 2 shows an example of a system configuration of a store POS system 40.

The store POS system 40 is a POS system that is installed in and is used in a store that is tied up with the business operator operating the server 10, and includes the store code reader device 50, the code register 60, and the store server 70, for example, although there is no limitation thereto.

The store code reader device 50 is communicably connected to the code register 60 and the store server 70 by means of a POS communication I/F 57 (non-limiting examples of which include a wired communication I/F and a wireless communication I/F in the store), and reads a terminal display code image that is displayed in the display 24 of the terminal 20 when payment is to be made using the code register 60. Upon reading the terminal display code image, the store code reader device 50 transmits payment request information by means of a communication I/F 54 to the server 10, and receives information (e.g., a store payment completion notification, which will be described later) regarding a payment result from the server 10 by means of the communication I/F 54 after payment is carried out by the server 10.

The store code reader device 50 includes a controller 51, an input/output unit 52, a display 53, the communication I/F 54, a storage 55, a sound output unit 56, the POS communication I/F 57, a code reader 58, and a clock unit 59, for example, without limitation thereto.

The code reader 58 is for reading two-dimensional codes, and the code reader 58 described in the present specification includes a two-dimensional code reader (e.g., a QR code reader) for reading terminal display codes that are two-dimensional codes (e.g., QR codes (registered trademark)) displayed in the display 24 of the terminal 20 and presented by the user of the terminal 20.

The code register 60 is communicably connected to the store code reader device 50 and the store server 70 by means of the POS communication I/F 57, for example, without limitation thereto, and issues a receipt on which information such as the total amount of sold goods and the balance of electronic money of the user of the terminal 20 is printed based on a store payment completion notification received by the store code reader device 50 from the server 10. It is also possible to provide a display that is provided together with the code register 60 as a single unit or is separate from the code register 60, and includes a display surface configured to face a customer. The code register 60 is a register that is configured to support the payment application, and can also be referred to as a stationary terminal that supports the payment application.

The store server 70 manages various types of information such as store information regarding the store, information regarding goods sold at the store, information regarding services provided at the store, and information regarding sales of goods sold at the store and services provided at the store, for example, without limitation thereto. The store server 70 is configured to communicate with the store code reader device 50 and the code register 60 by means of the POS communication I/F 57 and communicate with external devices such as the server 10 via the network 30.

Note that the store server 70 does not necessarily have to be configured to directly communicate with the store code reader device 50, and may also be configured to communicate with the store code reader device 50 via the code register 60. For example, a configuration is also possible in which a store payment completion notification received by the store code reader device 50 from the server 10 is transmitted to the code register 60, and thereafter transmitted from the code register 60 to the store server 70.

### (4) Others

The server 10 stores the program P in the storage 15, and the controller 11 executes the program P to execute processing while serving as units that are included in the controller 11. That is, the program P stored in the storage 15 causes the server 10 to implement functions executed by the controller 11. The program P may also be referred to as a “program module” or “computer-readable instruction.”

This also applies to other devices.

Embodiments of the present disclosure are implemented by enabling CPU(s) of the terminal 20 and/or the server 10 to execute the program P.

This also applies to other devices.

Note that the controller 21 of the terminal 20 and/or the controller 11 of the server 10 may perform operations by using not only the CPU(s) including a control circuit, but also a logic circuit (hardware) or a dedicated circuit that is formed on an integrated circuit (e.g., an Integrated Circuit (IC) chip or a Large Scale Integration (LSI) chip) or the like. Also, these circuits may be implemented by one or more integrated circuits, and a plurality of types of processing described in the embodiments may be implemented by a single integrated circuit. LSI may be referred to as VLSI, super LSI, ultra LSI, or the like depending on the degree of integration. Accordingly, the controller 21 may optionally be referred to as a “control circuit”.

This also applies to other devices.

The program P (non-limiting examples of which include a software program, a computer program, and a program module) in the embodiments of the present disclosure may optionally be provided in a state where the program is stored in a computer-readable storage medium. The program P can be stored in a “non-transitory tangible medium”. Also, the program P may be a program for implementing some of the functions described in the embodiments of the present disclosure. Furthermore, the program P may be a differential file (differential program) that is configured to implement the functions described in the embodiments of the present disclosure in combination with a program P that is already recorded in a storage medium.

The storage medium may include one or more semiconductor-based or other integrated circuits (ICs, non-limiting examples of which include field programmable gate arrays (FPGAs) and application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM drives, secure digital cards, drives, any other appropriate storage media, and a suitable combination of two or more of these storage media. Where appropriate, the storage medium may consist only of a volatile storage medium or a non-volatile storage medium, or a combination of volatile and non-volatile storage media. Note that the storage medium is not limited to these examples, and may be any device or medium that is capable of storing the program P. Also, the storage medium may be also referred to as a “memory”.

The server 10 and/or the terminal 20 can implement functions of a plurality of functional units described in the embodiments by reading the program P stored in the storage medium and executing the read program P.

This also applies to other devices.

The program P according to the present disclosure may be provided to the server 10 and/or the terminal 20 via any transmission medium (a communication network, broadcast waves, etc.) that is capable of transmitting the program. The server 10 and/or the terminal 20 implement(s) the functions of the functional units described in the embodiments by executing the program P downloaded via the Internet or the like, for example, without limitation thereto.

This also applies to other devices.

The embodiments of the present disclosure can also be implemented in the form of a data signal in which the program P is embodied through electronic transmission.

At least a portion of processing in the server 10 and/or the terminal 20 may be implemented through cloud computing constituted by one or more computers.

At least a portion of processing in the terminal 20 may be carried out by the server 10. In this case, the server 10 may carry out at least a portion of processing carried out by functional units of the controller 21 of the terminal 20.

At least a portion of processing in the server 10 may be carried out by the terminal 20. In this case, the terminal 20 may carry out at least a portion of processing carried out by functional units of the controller 11 of the server 10.

In the embodiments of the present disclosure, configurations for determination are not essential unless explicitly mentioned otherwise, and predetermined processing may be activated in case a determination condition is satisfied, or predetermined processing may be activated in case a determination condition is not satisfied, without limitation thereto.

The program according to the present disclosure is implemented using a script language such as ActionScript or JavaScript (registered trademark), a compiler language such as Objective-C or Java (registered trademark), or a markup language such as HTML5, for example, although there is no limitation thereto.

In the present specification, the expression “by means of a communication I/F” is used as appropriate. This expression means that a device transmits and receives various types of information and data via the communication I/F (via a communication unit) based on control performed by a controller (a processor, etc.), for example, although there is no limitation thereto.

Also, in the present specification, the word “time limit” indicates a certain period of time. However, the word “period” may also be used instead of the word “time limit”.

The word “time limit” may also be used with the meaning of a time point or date and time (a certain time point or certain date and time) at which the period ends.

### First Embodiment

Recent years have seen widespread use of applications (application software) relating to network services such as applications (payment applications) for making electronic payments using electronic money, applications (remittance applications) for sending electronic money, and payment applications into which some or all functions of these applications are integrated, and the user of the terminal 20 can use various services relating to electronic money by using these applications.

The following embodiments are embodiments in which payment is performed using a payment application that is stored and executed in the terminal 20, by the user of the terminal 20, for example, without limitation thereto. Specifically, methods for making payment commonly in an online state and an offline state are proposed.

In the following description, a business operator that provides a payment service using the payment application will be referred to as a “payment service operator”. Note that the payment service operator may be also referred to as an “operator providing the payment application” or an “operator of the server 10”.

Also, in the following description, it is assumed that the server 10 is operated and managed by the payment service operator. Also, in the following description, the payment application is appropriately referred to as “Payment App” and shown as such in the drawings.

The payment application may be provided by the server 10 as an independent application that does not include functions of a messaging service (MS) or a composite application that includes the functions of an MS. Also, the messaging service may include an instant messaging service (IMS) that enables transmission and reception of content such as simple messages between terminals 20.

Also, the payment application may be provided by the server 10 as an independent application that does not include functions of a social networking service (SNS) or a composite application that includes the functions of an SNS.

Note that the MS (including the IMS) can also be considered as being a form of an SNS. Accordingly, the MS and the SNS may be distinguished from each other, but do not necessarily have to be distinguished from each other.

Also, stores that are tied up with the payment service operator will be referred to as “member stores”, and are shown as “member store S1”, “member store S2”, and so on in FIG. 1.

The term “electronic money” may refer to electronic money that is distinguished from physical money and is owned and managed by a user of the terminal 20 through a payment application installed on the terminal 20. and the term “payment” may refer to electronic payment that is made using the electronic money.

The term “electronic money” may be also referred to as “digital currency (digital money)”.

Also, legal tender or a virtual currency may also be used as “electronic money” or “digital currency (digital money)”.

Also, cryptocurrency (crypto-assets) may also be included in “electronic money” or “digital currency (digital money)”.

Also, coupons, offers, promotion codes, and deals may also be included in a virtual currency.

### Payment Method

### (1) Online Payment

First, a method for making an online payment will be described as an aspect with reference to a flowchart.

In the following description, the term “online” indicates that the terminal 20 can communicate with an external device, such as the server 10, and an “online state” indicates a state of the terminal 20 that allows the terminal 20 to communicate with an external device, such as the server 10. Also, the term “online payment” indicates payment that is carried out by the server 10 in the online state.

The “online state” is an example of a first communication state.

Note that in the following description, it is assumed that communication between the terminal 20 and the server 10 is implemented using a first communication method in which a frequency band different from that used in wireless LAN communication is used, via base stations and the like that are installed by a telecommunications company (communication carrier), for example, without limitation thereto. The first communication method includes packet communication (mobile data communication in the terminal 20), for example, without limitation thereto.

Also, a second communication method that is different from the first communication method may optionally be used as a communication method. The second communication method includes wireless LAN (e.g., WiFi (registered trademark)), for example, without limitation thereto.

Also, a state where the terminal 20 and the server 10 can communicate with each other using at least one of the first communication method and the second communication method may be defined as the “online state”.

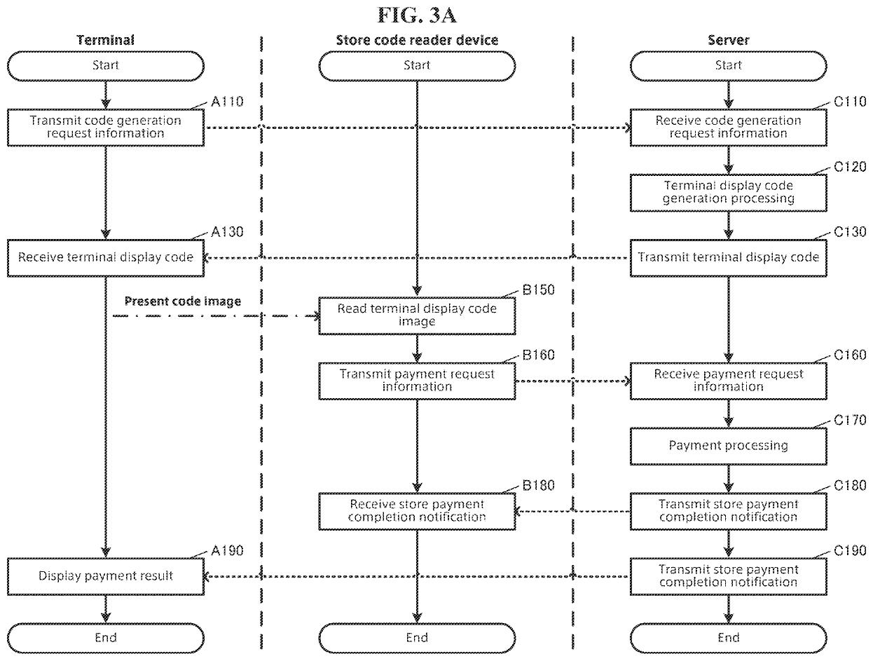

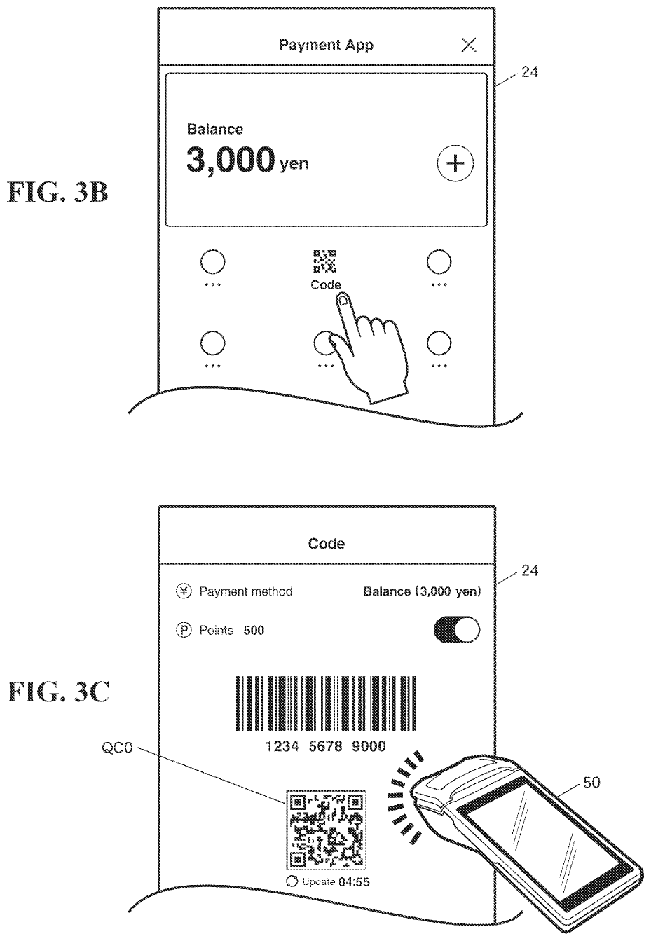

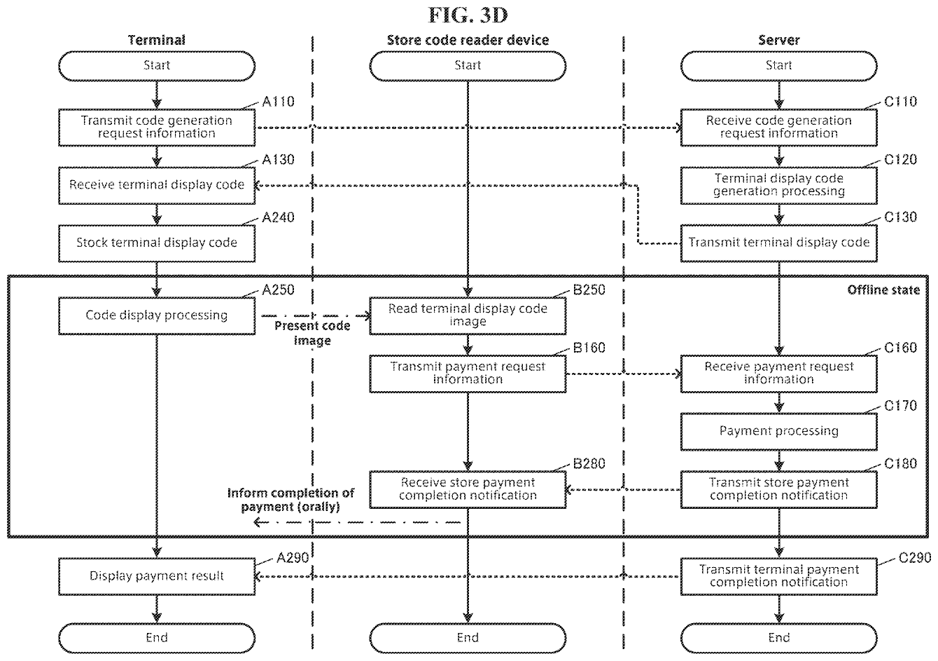

FIG. 3A is a flowchart showing an example flow of processing that is executed by devices in this case. Examples of operations which are executed by the controller 21 of the terminal 20, the controller 51 of the store code reader device 50, and the controller 11 of the server 10 are shown in FIG. 3A.

Also, the flowchart described below shows an example of operations carried out in the present embodiment, and some operations in the flowchart may also be omitted or additional operations may be added to the flowchart.

This also applies to other flowcharts described in the present specification.

First, upon receiving a payment request from a user or an external device, the controller 21 transmits code generation request information to request generation of a terminal display code to the server 10 through the communication I/F 22 (via the communication I/F 22) (operation A110).

In the following description, “code information” will be described as a concept that includes information (hereinafter referred to as “original information”) that is to be stored or has been stored in a code image through encoding or the like and the “code image” in which the original information is stored, for example, without limitation thereto. That is, the “code information” includes the “original information” and the “code image”.

The “original information” may be also referred to as “encoded information”, “stored information”, or the like.

Also, in the following description, “code” has substantially the same meaning as “code information”, for example, without limitation thereto.

However, these definitions are merely examples, and there is no limitation thereto.

For example, the word “code information” may be used as having the meaning of “original information”.

Also, the word “code” may be used as having the meaning of “code image”.

In the present embodiment, a “payment number” is described as an example of the “original information.” The payment number may be a random number having a predetermined number of digits and may be uniquely generated by the server 10 for each terminal 20 that has transmitted the code generation request information or the user of the terminal 20. The payment number may be also referred to as information that is associated with the terminal 20 or the user of the terminal 20 and is used for payment carried out by the server 10.

In the following description, a payment code that is generated by the server 10 based on the code generation request information will be referred to as a “terminal display code”, and a code image of the terminal display code will be referred to as a “terminal display code image”.

Although details will be described later, the payment number described above is stored in the terminal display code image.

The terminal display code image and the payment number are examples of “first information” for making a payment using a code image, and are transmitted from the server 10. The “first information” may contain information that enables a fund transfer from a mobile terminal (e.g., the terminal 20) to the store POS system 40, and may be presented to a product seller or a service provider (e.g., the store code reader device 50 of the store POS system 40) so that a customer (e.g., the user of the terminal 20) tenders a payment in exchange for goods and services. The “first information” may be also referred to as payment processing information which may be required by the store POS system 40 to process an electronic payment made by the terminal 20.

The following describes a case in which the code generation request information is information that requests the server 10 to generate the terminal display code image described above. That is, in this operation, the terminal 20 requests the server 10 to generate the terminal display code image, for example, without limitation thereto, and the code generation request information that requests generation of the terminal display code image is transmitted to the server 10 in operation A110.

Also, in the present specification, the “terminal display code” will be described as a code that is used for a payment of a payment type “terminal code display”.

When the user of the terminal 20 makes a payment of the payment type “terminal code display” in a store or the like, the user presents the terminal display code image displayed in the terminal 20 to a clerk at the code register 60 of the store, using the payment application stored in the terminal 20. Then, the terminal display code image is read by the store code reader device 50 or the like to process the payment.

The terminal display code is a code (code image) that is presented by the user of the terminal 20 to a clerk of a store or the like, and therefore can also be referred to as a “presentation code” or a “user presentation code”.

Identification information for identifying the terminal 20 or the user of the terminal 20 can be included in the code generation request information transmitted in operation A110, for example, without limitation thereto. Examples of the identification information include terminal identification information (e.g., a terminal ID) for identifying the terminal 20, user identification information (e.g., a user ID) for identifying the user of the terminal 20, and account information (e.g., an application ID) of the payment application.

Upon receiving the code generation request information from the terminal 20 by means of the communication I/F 14 (operation C110), the controller 11 performs a terminal display code generation operation (operation C120).

Specifically, the controller 11 generates a random number having a predetermined number of digits (e.g., about 10 to 12 digits) as a payment number by using a method (algorithm) for generating random numbers having the predetermined number of digits, for example, without limitation thereto. Then, the controller 11 generates a terminal display code image that includes at least the payment number as original information, for example, without limitation thereto. More specifically, the controller 11 generates the terminal display code image that is represented as an image of a two-dimensional code (e.g., a QR code), by encoding at least the payment number and expressing the payment number as a figure (image). Also, the controller 11 stores identification information regarding the terminal 20 or the user of the terminal 20 included in the received code generation request information and the generated payment number in association with each other in the storage 15.

Next, the controller 11 transmits the generated terminal display code (in this example, the terminal display code image) to the terminal 20 by means of the communication I/F 14 (operation C130). The terminal 20 receives the terminal display code (in this example, the terminal display code image) from the server 10 by means of the communication I/F 22 (operation A130). In this case, the controller 21 displays the received terminal display code image in the display 24, for example, without limitation thereto.

Thereafter, when the terminal display code image displayed in the display 24 is presented by the user of the terminal 20 to a store clerk or the like, the controller 51 controls the code reader 58 to read the terminal display code image displayed in the display 24 of the terminal 20 (operation B150).

Thereafter, the controller 51 accesses the server 10 by means of the communication I/F 54 using, for example, an application interface (API) that is provided (distributed) by the payment service operator and is associated with the payment application, and transmits, to the server 10 by means of the communication I/F 54, payment request information that includes at least the payment number acquired from the read terminal display code image through decoding, identification information (hereinafter referred to as “store identification information”) for identifying the store or the store code reader device 50, and an amount to be paid (hereinafter referred to as a “to-be-paid amount”) (operation B160).

Upon receiving the payment request information from the store code reader device 50 by means of the communication I/F 14 (operation C160), the controller 11 performs a payment processing (operation C170). Specifically, the controller 11 determines whether or not the payment number included in the received payment request information is stored in the storage 15 in association with identification information regarding the terminal 20 or the user of the terminal 20. If the payment number is stored, the controller 11 determines that “payment can be made”, and carries out payment by subtracting the to-be-paid amount from the balance of electronic money on the terminal 20 or of the user of the terminal 20 identified from the identification information stored in association with the payment number (i.e., the balance of electronic money associated with an application ID of the payment application (hereinafter simply referred to as the “balance”)).

Thereafter, the controller 11 transmits a payment completion notification for the store (hereinafter referred to as a “store payment completion notification”) to the store code reader device 50 by means of the communication I/F 14 (operation C180). The store payment completion notification includes a notification indicating completion (success) of the payment, date and time of the payment (payment date and time), and store payment information such as an amount that has been paid (paid amount), for example, without limitation thereto.

Also, the controller 11 transmits a payment completion notification for the terminal (hereinafter referred to as a “terminal payment completion notification”) to the terminal 20 by means of the communication I/F 14 (operation C190). The terminal payment completion notification includes a notification indicating completion (success) of the payment, and terminal payment information such as date and time of the payment (payment date and time), store identification information regarding the store to which the payment has been made (payment store identification information), and the amount paid (paid amount), for example, without limitation thereto.

Note that here, the store payment completion notification and the terminal payment completion notification are transmitted from the server 10 if the payment has been successfully carried out by the server 10, but there are cases where the server 10 cannot carry out the payment since the balance is insufficient, for example. In such a case, a notification (e.g., a payment error notification or a failed payment notification) indicating that the payment could not be carried out can be transmitted to the store code reader device 50 and the terminal 20.

Upon receiving the store payment completion notification from the server 10 by means of the communication I/F 54 (operation B180), the controller 51 ends the payment processing operation.

Also, upon receiving the terminal payment completion notification from the server 10 through the communication I/F 22, the controller 21 updates the balance that is stored as data regarding the payment application in the terminal 20, based on the received terminal payment completion notification. Also, the controller 21 displays a payment result in the display 24 (operation A190). Then, the controller 21 ends processing.

FIG. 3B is a diagram showing an example of a top screen that is displayed by the payment application executed in the terminal 20.

The top screen is a display screen that is displayed when the payment application is launched, and the name of the payment application “Payment App” is displayed in an upper portion of the screen. The balance (in this example, “3000 yen”) is displayed within a frame below the name, and a reload button for reloading (adding) electronic money is displayed beside the balance. Also, a plurality of function icons that correspond to various functions of the payment application are displayed below the frame.

Among these function icons, an icon shown as “code” is a “code icon” for displaying a code display screen in the display 24, for example, without limitation thereto. When the code icon is touched by the user of the terminal 20, the code generation request information is transmitted from the terminal 20 to the server 10, and the terminal display code is generated by the server 10, for example, without limitation thereto. Then, the generated terminal display code is transmitted from the server 10 to the terminal 20, and a code display screen shown in FIG. 3C is displayed in the display 24 of the terminal 20.

FIG. 3C is a diagram showing an example of the code display screen.

In the code display screen, characters “code” are displayed in an upper portion of the screen, and a payment method, points possessed by the user, and a point tab for setting whether or not to make payment using the points are displayed below “code”.

Also, in different regions of the display screen below the payment method, the points, and the point tab, a one-dimensional terminal display code image that is represented as a barcode and a two-dimensional terminal display code image QC0 that is represented as a QR code are displayed as code images of the terminal display code acquired from the server 10. Also, a 12-digit payment number is displayed below the one-dimensional terminal display code image, for example, without limitation thereto.

In this example, the terminal display code displayed in the code display screen has a time limit (hereinafter referred to as a “code use time limit” or “code valid time”) within which the code can be used for payment.

The code use time limit can also be referred to as a period of validity associated with the code.

The code use time limit can be set to a “period from a first point in time at which the terminal display code is displayed (i.e., display of the code is started) in the terminal to a second point in time at which a code use period or a code valid time elapses”. Although setting of the code use period can be appropriately changed, the code use period can be set to “5 minutes”, for example, without limitation thereto.

In the following description, the time point at which the terminal display code is displayed (i.e., display of the code is started) in the terminal will be referred to as a “code display time point”. This may also be referred to as “code display date and time”, replacing the time point with date and time.

Note that the code use time limit may be defined as a time point (date and time) at which a period during which payment can be made using the code ends (expires).

The remaining time of the code use time limit is displayed in a countdown manner together with an update mark and characters “update” below the two-dimensional terminal display code image QC0. The remaining time is displayed based on information obtained through time measurement by the clock unit 29A of the terminal 20.

If the remaining time is “0”, the code can no longer be used. Therefore, if the user of the terminal 20 wants to make a payment after the remaining time becomes 0, the user needs to reacquire a terminal display code from the server 10.

The user of the terminal 20 makes a payment by presenting the code display screen shown in FIG. 3C to a clerk of the store at the code register 60 so that the terminal display code image can be read by the store code reader device 50 within the code use time limit. In this case, the store code reader device 50 accesses the server 10 through the communication I/F 54 using the API described above or the like, and transmits information necessary for the payment to the server 10. As a result, payment processing is carried out by the server 10.

An example of processing an online payment has been described. In this processing, the terminal display code that is generated by the server 10 and is transmitted to the terminal 20 is immediately used for payment, for example, without limitation thereto.

However, there are cases where the user wants to use the terminal display code received from the server 10 later to make a payment, rather than immediately use the terminal display code.

Also, in order to apply the processing described above, it is necessary that the terminal 20 and the server 10 are in a state (i.e., an online state) where the terminal 20 and the server 10 can communicate with each other. Of course, it is also necessary that the store code reader device 50 and the server 10 are in a state where the store code reader device 50 and the server 10 can communicate with each other.

One or more other embodiments are provided in a case where the terminal 20 and the server 10 cannot communicate with each other (or have difficulty in communicating) and it is difficult to make a payment (e.g., a case where the payment is to be made at a place, such as somewhere underground, where radio wave conditions are poor, a case where the payment is to be made at an event site or the like in a situation in which lines are congested). Also, one or more other embodiments are provided in a case where an amount of communication performed by the terminal 20 (or an amount of data transmitted or received through the communication) during a predetermined period (e.g., one month) has exceeded a predetermined amount and a restriction is imposed on the amount or the speed of communication.

Therefore, the following embodiments are described as an example of a method for processing a payment even in such cases.

Note that a payment method described below can be similarly applied to both the online state and the offline state, but will be described as a method for processing a payment in the offline state.

### (2) Offline Payment

A method for making an offline payment will be described as an aspect with reference to a flowchart.

In the following description, the term “offline” indicates that the terminal 20 cannot communicate with the server 10 or cannot appropriately communicate with the server 10 (communication is difficult or unstable), and the term “offline state” indicates such a state. Also, the term “offline payment” indicates a payment that is processed by the server 10 in the offline state.

Note that it is assumed that the store code reader device 50 can communicate with the server 10.

The “offline state” is an example of a second communication state (a communication state where the amount of communicated information is smaller than that in the first communication state).

The “offline state” can also be referred to as a communication state where a communication amount of the terminal 20 is smaller than a set communication amount.

As described above, the offline state can also be referred to as a communication state where the amount of communicated data is smaller than that in the online state or a communication state where the communicated data amount of the terminal 20 is smaller than a set communication data amount. Such communication states can include a state where the terminal 20 and the server 10 cannot communicate with each other at all and a state where the terminal 20 and the server 10 can communicate with each other, but cannot appropriately communicate with each other as described below, for example.

(1) A state where the time taken for communication is longer than a predetermined time (e.g., a state where communication is unstable and delay (delay time) is long (latency is high)).

For example, the terminal 20 can exchange information with the server 10, but when information is transmitted to the server 10, the time it takes for completion of the transmission of information is longer than a predetermined time.

For example, the terminal 20 can exchange information with the server 10, but when information is received from the server 10, the time it takes for completion of the reception of information is longer than a predetermined time. As a result, in cases where display is performed based on received information, for example, the time it takes for the information to be displayed is longer than a predetermined time.

(2) A state where the communication speed is lower than a predetermined speed (e.g., a state where the amount of data that can be transmitted per unit time is reduced (throughput is reduced)).

Note that it is also possible to consider that the lower the latency is, the higher the performance regarding data access is, and the better the communication state is. Also, it is possible to consider that, if the latency is high, communication will be unstable even if the throughput is good.

FIG. 3D is a flowchart showing an example flow of processing that is executed by the devices in this case. This flowchart is to be viewed in the same manner as that of the flowchart described above.

The flowchart shown in FIG. 3D is modified from the flowchart shown in FIG. 3A to be adapted to the offline state. Differences from the flowchart shown in FIG. 3A are processing steps (e.g., operation A240) in the online state, processing steps (e.g., operations A250, B250, and B280) in the offline state, and processing steps (e.g., operations A290 and C290) when the communication state has returned from the offline state to the online state, for example, without limitation thereto.

After operation A130, the controller 21 stocks the received terminal display code (in this example, the terminal display code image) in the storage 28 (operation A240).

Here, the term “stock” means storing the received terminal display code in the storage 28 so that the terminal display code can be used later.

Note that in the present specification, the term “stock” may also be simply referred to as “store”. Also, stocking a terminal display code may also be referred to as “storing a terminal display code in terminal-display-code stock data”.

In this processing, the terminal display code (in this example, the terminal display code image) acquired from the server 10 in the online state is stocked (stored) in the storage 28 of the terminal 20 to enable an offline payment. Then, when payment needs to be carried out in the offline state, the stocked terminal display code is used to make payment without communicating with the server 10.

This will be described in more detail. Assume that the communication state has entered the offline state after operation A240.

Here, the terminal 20 detects that the communication state has entered the offline state by using any one of the following methods, for example, without limitation thereto.

(A) A connection confirmation request is transmitted from the server 10 to the terminal 20 periodically or at predetermined point in time while the payment application is executed in the terminal 20, and a connection response including identification information (e.g., an application ID) is transmitted from the terminal 20 to the server 10 in response to the connection confirmation request. In this case, if the connection confirmation request is not received from the server 10, the controller 21 of the terminal 20 determines that the communication state has entered the offline state.

(B) A connection notification including identification information (e.g., an application ID) is transmitted from the terminal 20 to the server 10 periodically or at a predetermined point in time while the payment application is executed in the terminal 20, and a connection confirmation is transmitted from the server 10 to the terminal 20 in response to the connection notification. In the offline state, the terminal 20 cannot transmit the connection notification to the server 10. Therefore, if the occurrence of an error in transmission of the connection notification is detected, the controller 21 of the terminal 20 determines that the communication state has entered the offline state, for example, without limitation thereto.

Note that the terminal 20 may determine whether or not the communication state has entered the offline state by acquiring information regarding the communication state (communication conditions) of the terminal 20 using a library, an application, or the like for acquiring network connection conditions, for example, without limitation thereto.

When a code display operation is performed by the user of the terminal 20 in the offline state, for example, without limitation thereto, the controller 21 performs code display processing (operation A250). Specifically, the controller 21 displays a code display screen including the terminal display code image that has been stocked in operation A240, in the display 24, for example, without limitation thereto. When the code display screen is presented by the user of the terminal 20 to a store clerk or the like, the controller 51 controls the code reader 58 to read the terminal display code image in the presented display screen (operation B250). Then, the controller 51 proceeds to operation B160.

When the store payment completion notification is received from the server 10 through the communication I/F 54 after operation B160 (operation B280), the store clerk or the like orally informs the user of the terminal 20 that the offline payment is complete (successful) based on the received store payment completion notification.

After operation C180, the controller 11 transmits the terminal payment completion notification to the terminal 20 (operation C290). However, the terminal 20 cannot receive the terminal payment completion notification in the offline state.

When the terminal 20 has returned to the online state, the terminal payment completion notification transmitted from the server 10 is received by the terminal 20. Upon receiving the terminal payment completion notification from the server 10 through the communication I/F 22, the controller 21 displays a payment result in the display 24 based on the received terminal payment completion notification (operation A290). Then, the controller 21 hides the code display screen.

The processing described above is an example of processing for making an offline payment.

Note that the code generation request information may be information that requests generation of a single terminal display code, or information that requests generation of a plurality of (two or more) terminal display codes. Specifically, in the terminal 20 or the server 10, an upper limit is set for the number of codes for which the terminal 20 requests code generation at a time (or the number of codes to be generated by the server 10 at a time), for example, without limitation thereto, rather than terminal display codes being added one-by-one. The user of the terminal 20 may acquire the upper limit number of terminal display codes through a single operation. In this case, a plurality of terminal display codes can be generated by the server 10, the generated terminal display codes can be transmitted to the terminal 20, and the received terminal display codes can be stocked in the terminal 20.

The processing described above can be similarly applied to the online state. That is, in any of the following cases, a terminal display code that is generated and transmitted by the server 10 in the online state is stocked in the terminal 20 as described above.

(1) A case where a payment is to be made using the terminal display code later in the online state.

(2) A case where an offline payment is to be made.

Then, a payment can be made using the terminal display code stocked in the terminal 20.

However, if information that is displayed on the display 24 of the terminal 20 is the same between the case of an online payment and the case of an offline payment, it may be difficult for the user to know whether the current communication state of the terminal 20 is the online state or the offline state.

### Functional Configuration

### (1) Functional Configuration of Server

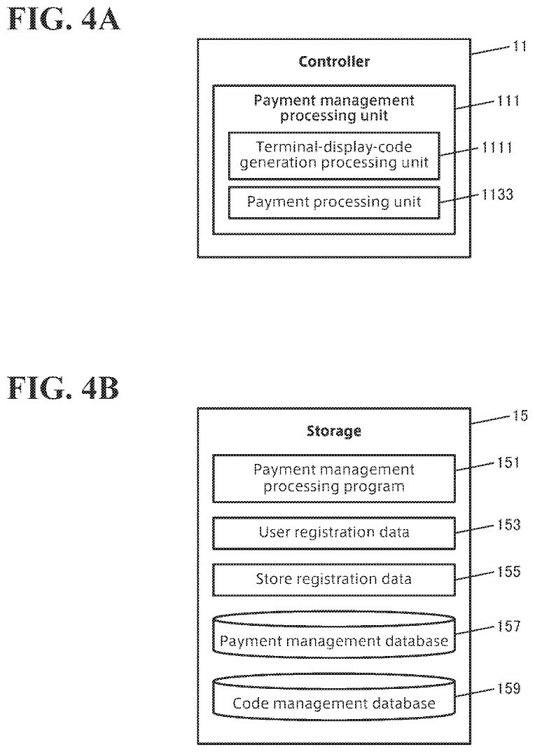

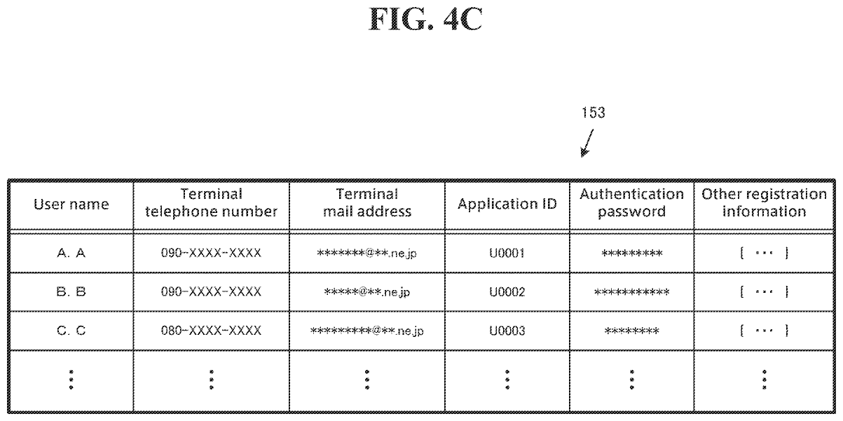

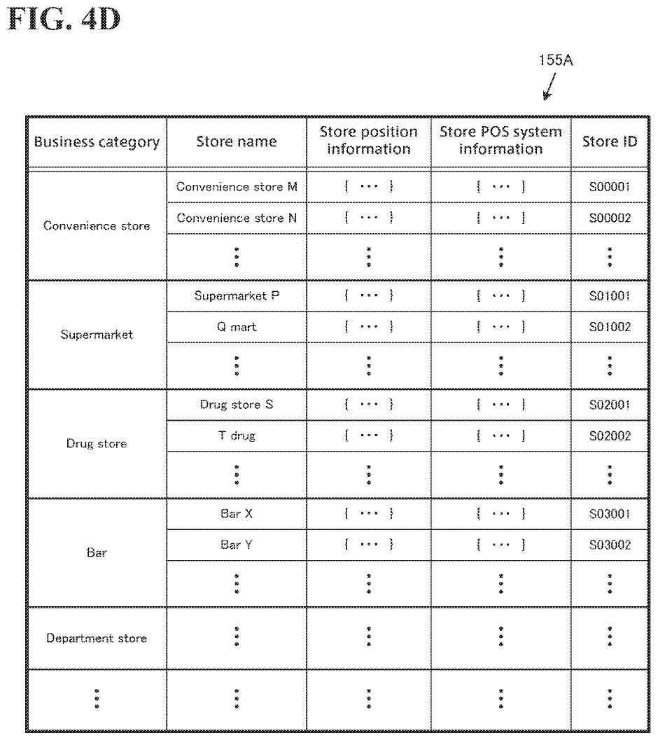

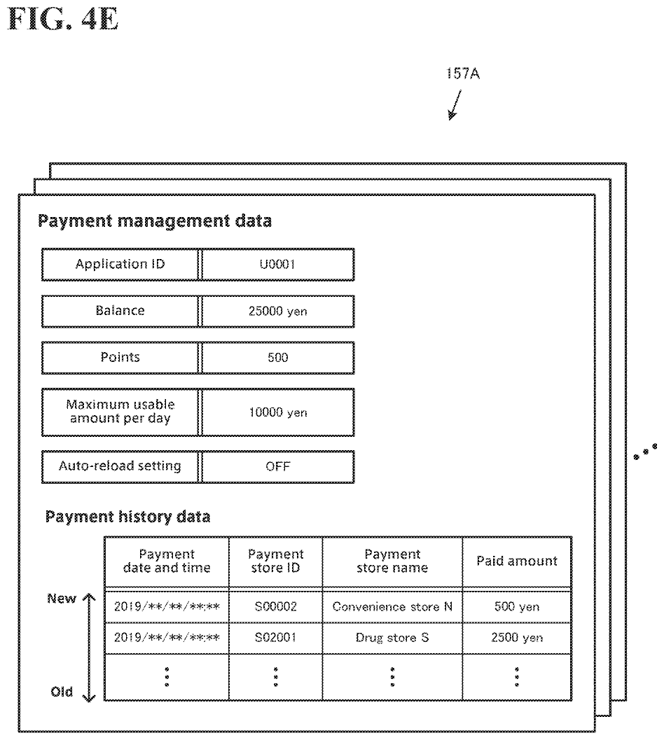

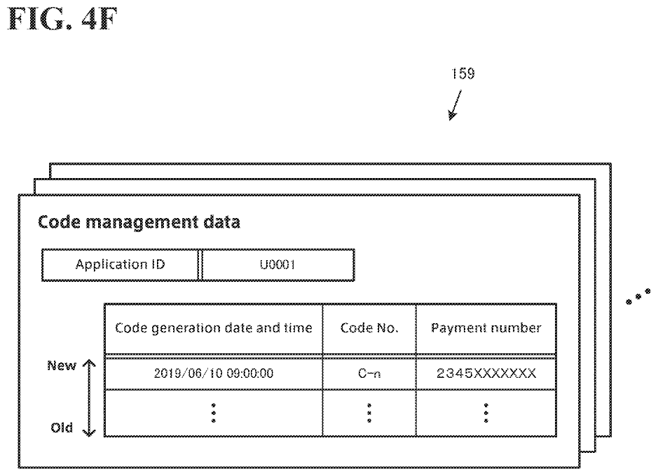

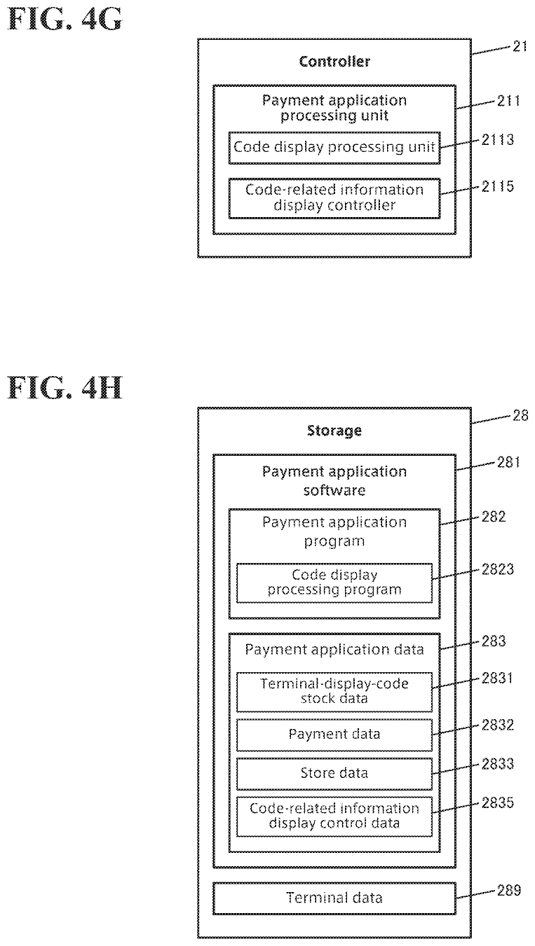

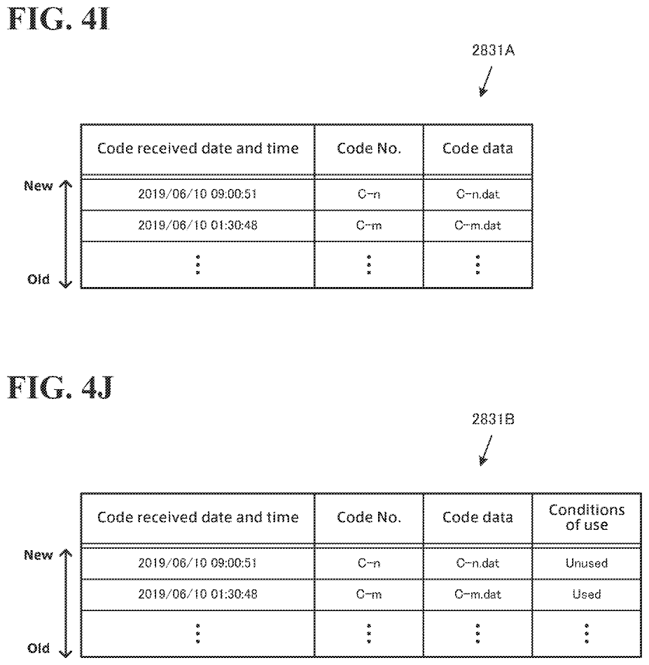

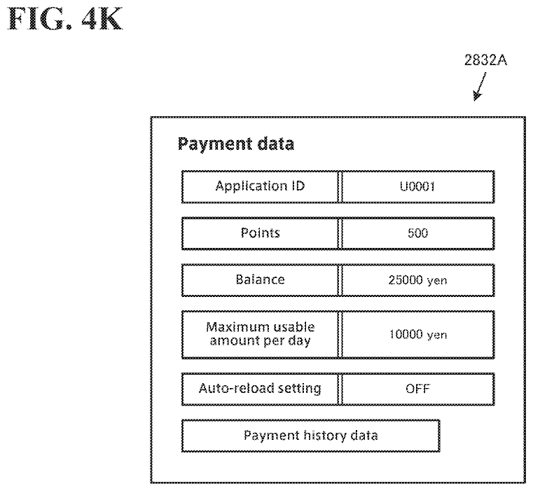

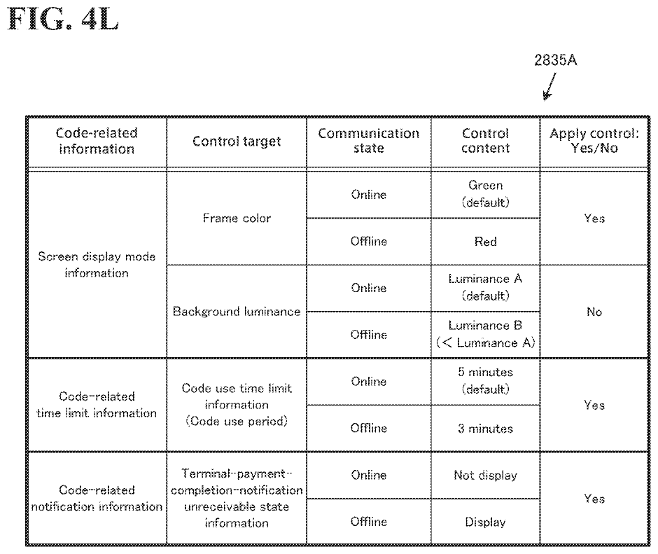

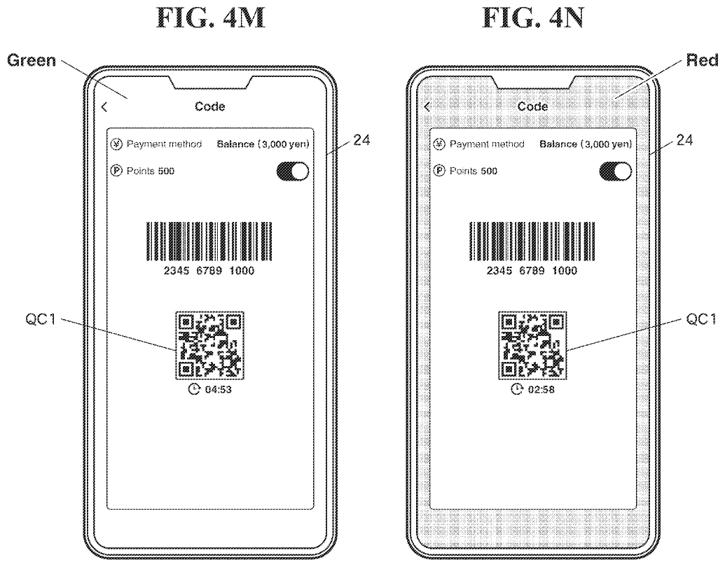

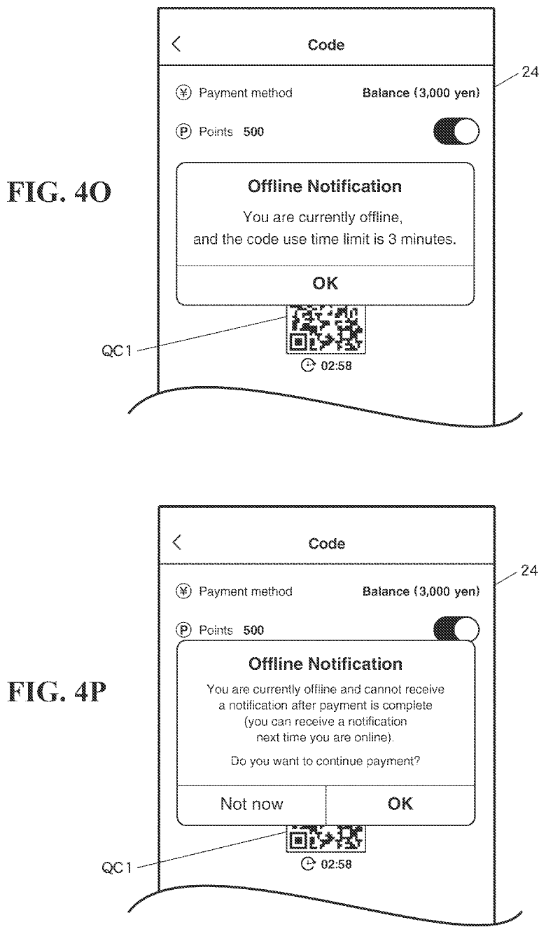

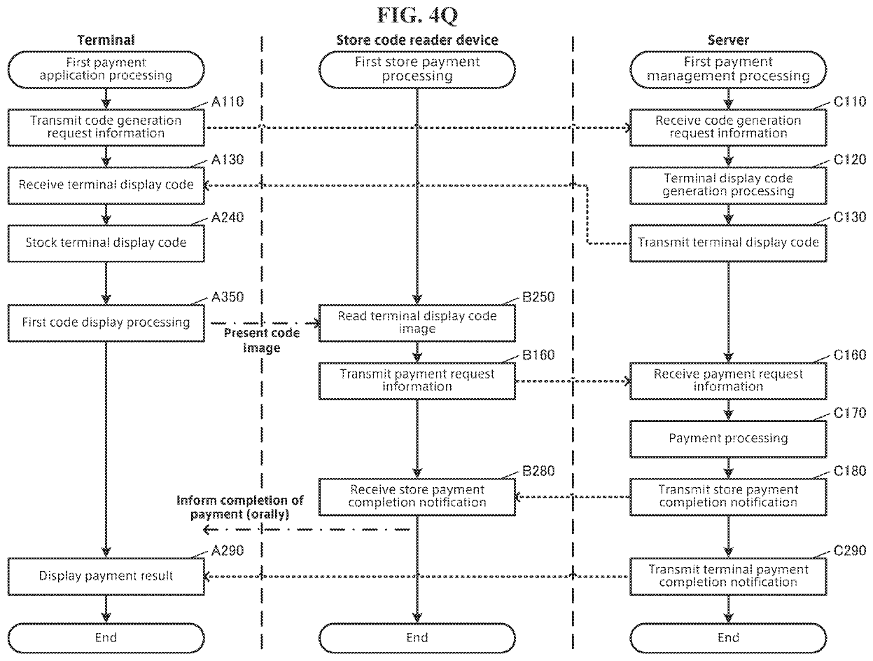

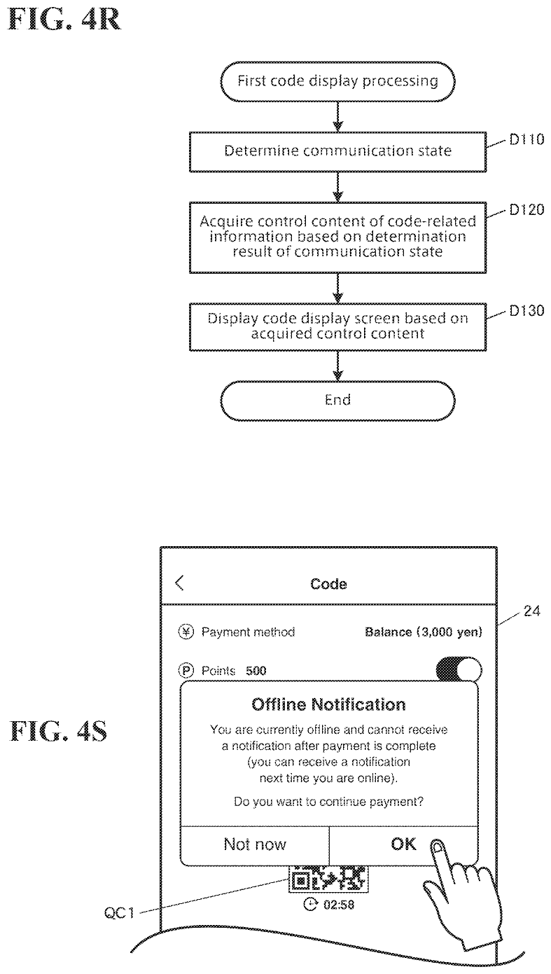

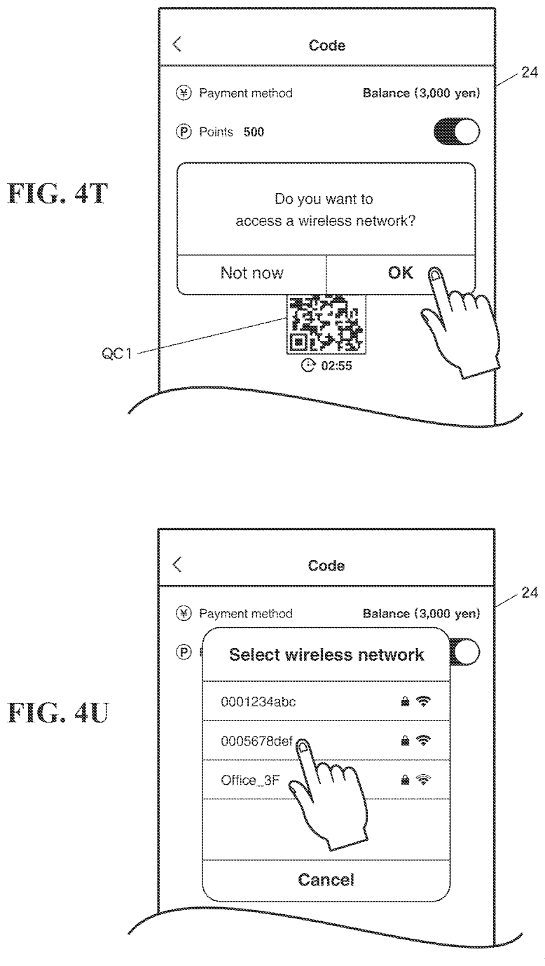

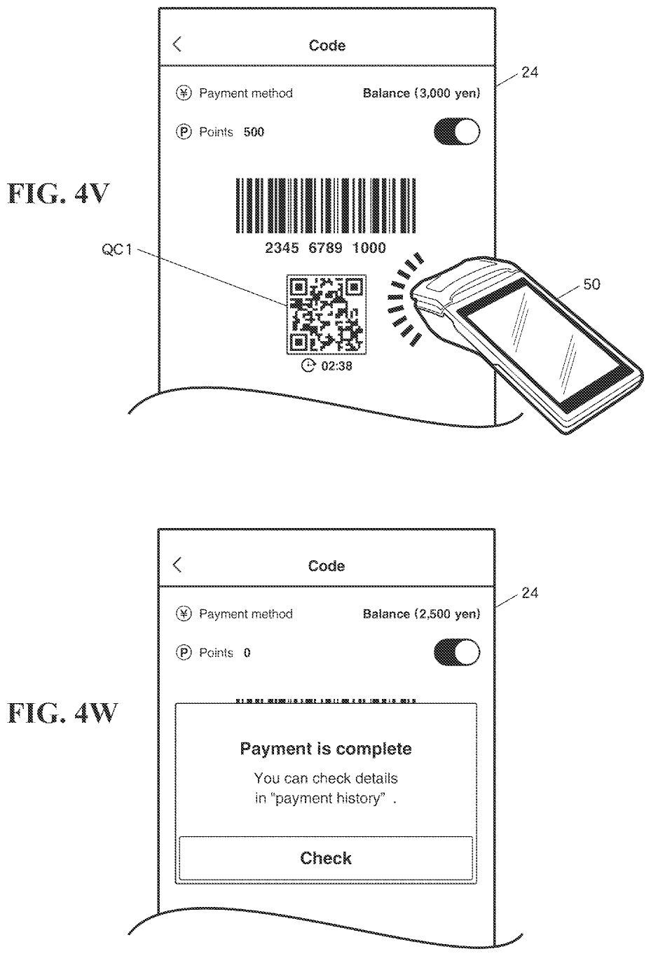

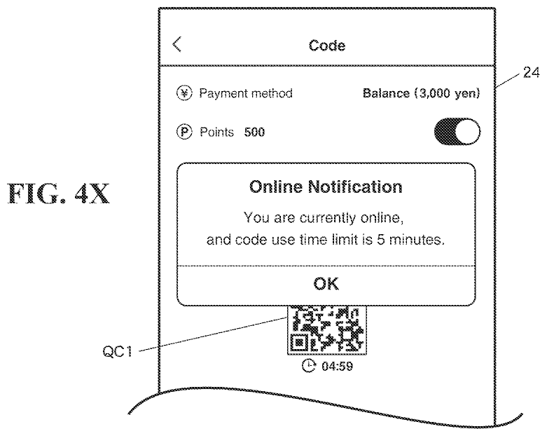

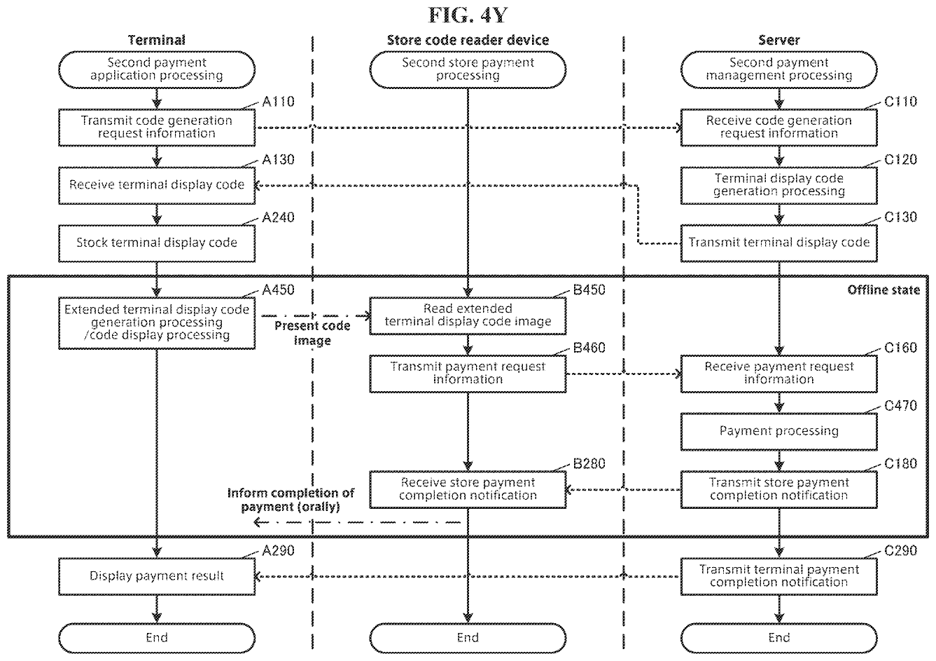

FIG. 4A is a diagram showing an example of functions implemented by the controller 11 of the server 10 in the present embodiment.

The following describes a case where the user of the terminal 20 makes a payment of the payment type “terminal code display” described above, for example, without limitation thereto, by using the payment application stored in the terminal 20.

The server 10 includes a payment management processing unit 111 as a function implemented by the controller 11.

The payment management processing unit 111 may manage various types of information and data regarding the payment application executed in the terminal 20 and execute payment management processing for managing payment that is made using electronic money by the terminal 20 or the user of the terminal 20, in accordance with a payment management processing program 151 that is stored in the storage 15.

In the present embodiment, the payment management processing unit 111 executes the processing shown in FIG. 3D, for example, as the payment management processing in accordance with the payment management processing program 151 stored in the storage 15.

The payment management processing unit 111 includes a terminal-display-code generation processing unit 1111 that generates a terminal display code through terminal display code generation processing and a payment processing unit 1113 that executes payment through payment processing, for example, without limitation thereto.

The terminal-display-code generation processing unit 1111 generates a terminal display code image that is represented as a two-dimensional code, for example, without limitation thereto. Two-dimensional codes are codes that include information in the horizontal direction and the vertical direction, such as matrix-type codes (hereinafter referred to as “matrix codes”) in which small squares are arranged in the vertical and horizontal directions and stack-type codes (hereinafter referred to as “stack codes”) in which a plurality of one-dimensional codes (non-limiting examples of which include barcodes) are stacked in the vertical direction.

In the present embodiment, a QR code (registered trademark), which is an example of widely used matrix codes, will be described as an example of the terminal display code for the sake of convenience of description.

Note that, unlike the present embodiment, it is also possible to use SP Codes, VeriCodes, MaxiCodes, CP Codes, Chameleon Codes, and the like as matrix codes other than QR codes. Alternatively, it is also possible to use various types of stack codes, rather than matrix codes.

Also, the terminal-display-code generation processing unit 1111 may generate a one-dimensional code (non-limiting examples of which include barcodes) as the terminal display code, in addition to the two-dimensional code (non-limiting examples of which include QR codes). This is because, depending on the store, there are cases where two-dimensional codes cannot be read, but one-dimensional codes can be read.

The payment processing unit 1113 functions to perform the payment processing based on information that is transmitted from the store POS system 40 and information that is transmitted from the terminal 20, for example, without limitation thereto.

FIG. 4B is a diagram showing an example of information that is stored in the storage 15 of the server 10 in the present embodiment.

The payment management processing program 151 that is read by the controller 11 and is executed as the payment management processing is stored as a program in the storage 15, for example, without limitation thereto.

Also, user registration data 153, store registration data 155, a payment management database 157, and a code management database 159 are stored as data in the storage 15, for example, without limitation thereto.

The user registration data 153 is registration data of terminals 20 and users of the terminals 20 who use the payment service, and an example of a data structure of the user registration data 153 is shown in FIG. 4C.

A user name, a terminal telephone number, a terminal mail address, an application ID, an authentication password, and other registration information are stored in association with each other in the user registration data 153, for example, without limitation thereto.

The user name is the name of a user of a terminal 20 who uses the payment service, and is registered by the user of the terminal 20 when the user uses the payment service.

The terminal telephone number is the telephone number of the terminal 20 of the user corresponding to the user name, and is registered by the user of the terminal 20 when the user uses the payment application.

The terminal mail address is the mail address of the terminal 20 of the user corresponding to or associated with the user name, and is registered by the user of the terminal 20 when the user uses the payment application.

The terminal telephone number and the terminal mail address are examples of identification information (hereinafter referred to as “terminal identification information”) for identifying the terminal 20.

The application ID is an account (account information) of the payment application, based on which the terminal 20 or the user of the terminal 20 can be identified. A unique ID is set by the server 10 and is stored as the application ID, for example, without limitation thereto.

The authentication password is a password for authentication, input of which is requested to the user when authentication processing for payment (hereinafter simply referred to as “authentication processing”) is performed in the terminal 20 of the user corresponding to the user name, and the authentication password is set by the user.

Note that authentication processing for payment does not necessarily have to be performed, and may be omitted. In this case, there is no need to store the authentication password in the user registration data 153.

The other registration information is other registration information regarding the user corresponding to the user name, and includes a user icon image, which is image data of an icon that is used by the user in the payment application, a profile of the user, and the like, for example, without limitation thereto.

The store registration data 155 is registration data of stores that are tied up with the operator providing the payment application (the operator of the server 10). FIG. 4D shows an example data structure of store registration data 155A, which is an example of the store registration data 155.

A business category, a store name, store position information, store POS system information, and a store ID are stored in association with each other as store information in the store registration data 155A, for example, without limitation thereto.

The business category of a store is stored as the business category. Business categories include various categories such as “convenience store”, “supermarket”, “drug store”, “bar”, “department store”, “restaurant”, “bookstore”, and “watch store”, for example, without limitation thereto.

With respect to each business category, the name of a store that is included in (belongs to) the category is stored as the store name.

Position information (hereinafter referred to as “store position information”) regarding the location of the store corresponding to the store name is stored as the store position information. The store position information may indicate the location of the store using two-dimensional or three-dimensional position coordinates or using longitude and latitude (altitude may also be added to longitude and latitude).

Information regarding the store POS system 40 that is used in the store is stored as the store POS system information. The store POS system information includes information that is necessary for the server 10 to communicate with the store code reader device 50 and the store server 70, for example, without limitation thereto.

The store POS system 40 performs processing in cooperation with the server 10, and accordingly, a configuration is also possible in which a software package for the payment application that is provided (distributed) from the server 10 is acquired in advance and is stored in the store code reader device 50 or the store server 70, and is called up from a program for payment processing in the store to be used, for example, without limitation thereto. An application programing interface (API) is an example, and the store code reader device 50 activates the API to transmit information to the server 10 and receive information from the server 10, for example.

Also, the server 10 may receive information such as the business category of the store, the store name, the store position information, and the store POS system information from the store server 70 of the store, for example, without limitation thereto, and store the information in the store registration data 155.

The store ID serves as identification information for identifying the store corresponding to the store name. A unique ID is set for each store by the server 10 and is stored as the store ID, for example, without limitation thereto.

The store ID is an example of store identification information.

The payment management database 157 is a database in which data for managing information regarding payment made by the user of each terminal 20 is accumulatively stored, and FIG. 4E shows an example structure of a payment management database 157A, which is an example of the payment management database 157.

Payment management data that is generated for each terminal 20 or each user of a terminal 20 is stored in the payment management database 157A.

An application ID, the balance, points, the maximum usable amount per day, an auto-reload setting, and payment history data are stored in each piece of payment management data, for example, without limitation thereto.

An application ID that is stored in the user registration data 153 is stored as the application ID.

The balance that is associated with the application ID is stored as the balance.

Points, which can be collected by using various services associated with the payment application and member stores tied up with the payment application operator, are stored as the points. A point has a value that is equivalent to 1 yen, for example, without limitation thereto, and points can be exchanged for gift cards, goods, or the like, and can also be exchanged for cash and used for payment in the payment application.

The maximum amount that can be used for payment per day by the terminal 20 corresponding to the application ID or the user of the terminal 20 is stored as the maximum usable amount per day.

The maximum usable amount per day may be set through a user operation or in the server 10, for example, without limitation thereto.

Note that a method for setting and controlling the maximum usable amount per day in the terminal 20 will be described later in a second embodiment.

The auto-reload setting is a setting as to whether or not to automatically reload or add electronic money or funds to the user's account when the balance is small (e.g., “500 yen”) or “0 yen”, and “ON” is stored if the auto-reload setting is activated by the user of the terminal 20, otherwise “OFF” is stored. Electronic money can be automatically reloaded from a bank account or the like that is linked to the user account of the terminal 20, for example, without limitation thereto.

The payment history data is data regarding a history of payments that have been made by the user corresponding to the application ID, and payment date and time at which payment has been carried out by the server 10, the store ID of a store to which payment has been made, a payment store name that is the name of the store corresponding to the store ID, and a paid amount are stored in association with each other in time series with respect to the application ID, for example, without limitation thereto.

Note that the payment management data described above does not necessarily have to include all of the information described above. A configuration is also possible in which some or all of the points, the maximum usable amount per day, and the auto-reload setting are not stored in the payment management data, for example, without limitation thereto.

A configuration is also possible in which information regarding a history of payments is transmitted to and stored in the terminal 20 every time a payment is made, and the payment history data is not stored in the server 10.

The code management database 159 is a database for managing codes (in the present embodiments, terminal display codes), and FIG. 4F shows an example of a data structure of the code management database 159.

In the code management database 159, code generation date and time, a code No., and a payment number are stored in association with each other in time series together with an application ID, as data that is generated for each application ID of the payment application.

Date and time at which a terminal display code was generated is stored as the code generation date and time based on information obtained through time measurement by the clock unit 19.

A number for identifying the code is stored as the code No. For example, consecutive numbers are set and stored in association with codes in the order of time when the codes are generated.

A payment number that was issued when the terminal display code was generated is stored as the payment number.

Data regarding a terminal display code that is stored in the code management data can be deleted from the code management data after payment processing is carried out using the terminal display code, for example, without limitation thereto.

Note that a flag “usable/unusable” that indicates whether or not a terminal display code can be used may be set in association with data regarding the terminal display code, for example, without limitation thereto, rather than deleting data regarding a terminal display code that is no longer usable from the code management data, as described above. In this case, the flag “unusable” can be set for a terminal display code that is no longer usable.

A configuration is also possible in which the code generation date and time is not stored in the code management data, for example.

Also, terminal identification information such as a terminal telephone number that is stored in the user registration data 153 may be stored in the code management data instead of or in addition to the application ID.

### (2) Functional Configuration of Terminal

FIG. 4G is a diagram showing an example of functions that are implemented by the controller 21 of the terminal 20 in the present embodiment.

The terminal 20 includes a payment application processing unit 211 as a function implemented by the controller 21.

The payment application processing unit 211 may execute payment application processing that is an example of processing for performing processing relating to payment, based on payment application software 281 that is stored in the storage 28.

In the present embodiment, the payment application processing unit 211 executes the processing shown in FIG. 3D, for example, as the payment application processing in accordance with a payment application program 282 that is stored in the storage 28.

In the present embodiment, processing relating to payment is a concept that includes processing that has some relation to payment, such as processing for acquiring a terminal display code from the server 10 (including processing for requesting the server 10 to generate the terminal display code and processing for receiving the generated terminal display code from the server 10), processing for stocking the terminal display code acquired from the server 10, processing (code display processing) for displaying a stocked terminal display code image, processing for instructing (guiding) the user to present the displayed terminal display code image so as to be read by the store code reader device 50, and processing for receiving (acquiring) the terminal payment completion notification from the server 10 after payment is carried out by the server 10, more specifically, all processing that is executed in the terminal 20 as processing relating to payment.

The payment application processing unit 211 includes a code display processing unit 2113 and a code-related information display controller 2115 as functional units, for example, without limitation thereto.

The code display processing unit 2113 executes the code display processing for displaying a code display screen including a terminal display code image in the display 24.

The code-related information display controller 2115 may control the display 24 to display code-related information in the display 24 based on code-related information display control data 2835.

The code-related information is information that is related to a terminal display code stored in terminal-display-code stock data 2831 or a terminal display code (code image) displayed in the code display screen. Details of the code-related information will be described later.

FIG. 4H is a diagram showing an example of information stored in the storage 28 of the terminal 20 in the present embodiment.

The payment application software 281 is stored in the storage 28 as application software that is acquired from the server 10 in advance through downloading, for example, without limitation thereto.

The payment application software 281 includes the payment application program 282 and payment application data 283, for example, without limitation thereto.

The payment application program 282 is a program that is read by the controller 21 and is executed as the payment application processing, and includes, as a sub routine program, a code display processing program 2823 that is executed as the code display processing, for example, without limitation thereto.

Various types of data used in the payment application software 281 is stored in the payment application data 283. The terminal-display-code stock data 2831, payment data 2832, store data 2833, and the code-related information display control data 2835 are stored in the payment application data 283, for example, without limitation thereto.

Terminal display codes acquired from the server 10 in the online state are stocked in the terminal-display-code stock data 2831, and FIG. 4I shows an example data structure of first terminal-display-code stock data 2831A, which is an example of the terminal-display-code stock data 2831.

Code received date and time, a code No., and code data are stored in association with each other in time series in the first terminal-display-code stock data 2831A, for example, without limitation thereto.

The date and time at which the terminal 20 received a terminal display code from the server 10 is stored as the code received date and time, for example, without limitation thereto.

A code number that the terminal 20 received together with the terminal display code from the server 10 is stored as the code No.

Data of a code image of the terminal display code that the terminal 20 received from the server 10 is stored as the code data, for example, without limitation thereto.

Data regarding a terminal display code that is stored in the first terminal-display-code stock data 2831A can be deleted from the first terminal-display-code stock data 2831A after payment processing is carried out by the server 10 using the terminal display code and the terminal payment completion notification is received from the server 10 (in a case where an offline payment is carried out, after the communication state returns to the online state and the terminal payment completion notification is received from the server 10), for example, without limitation thereto.

Note that it is also possible to store information regarding conditions of use of a terminal display code in association with data regarding the terminal display code, as is the case with second terminal-display-code stock data 2831B shown in FIG. 4J, for example, without limitation thereto, rather than deleting a terminal display code that is no longer usable from the terminal-display-code stock data 2831 as described above. In this case, “unused” and “used” may be stored in association with a terminal display code that has not been used and a terminal display code that has been used, respectively.

A configuration is also possible in which the code received date and time is not stored in the terminal-display-code stock data 2831 (the first terminal-display-code stock data 2831A or the second terminal-display-code stock data 2831B), for example.

Also, date and time (hereinafter referred to as “code stored date and time”) at which a terminal display code received from the server 10 was stored in the terminal-display-code stock data 2831 (the first terminal-display-code stock data 2831A or the second terminal-display-code stock data 2831B) may be stored instead of or in addition to the code received date and time, for example, without limitation thereto.

Also, although details will be described later, data of the code image of the terminal display code does not necessarily have to be stored as the code data, and the original information (in the present embodiment, the payment number) regarding the terminal display code may be stored instead of or in addition to the data of the code image.

Also, only a single code acquired from the server 10 in the online state may be stored in the terminal-display-code stock data 2831.

The payment data 2832 is data for payment that is stored in the terminal 20, and FIG. 4K shows an example structure of first payment data 2832A, which is an example of the payment data 2832.

An application ID, points, the balance, the maximum usable amount per day, the auto-reload setting, and payment history data are stored in the first payment data 2832A, for example, without limitation thereto.

The controller 21 stores payment date and time at which payment was carried out by the server 10, the store ID of a store to which payment was carried out by the server 10, a payment store name that is the name of the store corresponding to the store ID, and a paid amount paid by the server 10 in association with each other in time series in the payment history data, for example, without limitation thereto, based on a terminal payment completion notification received from the server 10 after the communication state returns to the online state.

Various types of store information that is stored in the store registration data 155A in the server 10 is stored as the store data 2833, for example, without limitation thereto.

The store data 2833 can be updated with latest store information distributed from the server 10 to the terminal 20 when the payment application software 281 is updated, for example, without limitation thereto.

The code-related information display control data 2835 is data that is used to control display of code-related information, and FIG. 4L shows an example structure of first code-related information display control data 2835A, which is an example of the code-related information display control data 2835.

Code-related information, a control target, a communication state, control content, and apply control: Yes/No are stored in association with each other in the first code-related information display control data 2835A.

The code-related information includes screen display mode information, code-related time limit information, and code-related notification information, for example, without limitation thereto.

The screen display mode information is information regarding a display mode of a code display screen in which a terminal display code is displayed.

The code-related time limit information is information regarding a time limit that is associated with the terminal display code. The code-related time limit information includes the code use time limit described above or information relating to the code use time limit, for example, without limitation thereto.

The code-related notification information is information regarding a notification that is given to the user of the terminal 20 regarding the terminal display code.

Items that are controlled by the code-related information display controller 2115 are set as control targets with respect to the code-related information.

With respect to each control target, “online” that indicates an online state and “offline” that indicates an offline state are set as communication states.

Note that the communication state can also be referred to as communication conditions.

How the code-related information display controller 2115 controls the control target is set as the control content.

Apply control: Yes/No is information (e.g., a flag) that indicates whether or not control of a control target is applied, and “Yes” indicating that control is to be applied is stored in association with a control target for which control is applied, and “No” indicating that control is not to be applied is stored in association with a control target for which control is not applied.

The following describes specific examples in detail.

### (1) Screen Display Mode Information

With respect to the screen display mode information, “frame color” and “background luminance” are set as control targets.

The frame color is the color of a frame (e.g., an outer frame) of the code display screen, for example, without limitation thereto. This is an example of color information regarding a display region.

The background luminance is the luminance (brightness) of the background of the code display screen, for example, without limitation thereto. This is an example of brightness information regarding the display region.

With respect to the control target “frame color”, “green (default)” is set as the control content corresponding to the communication state “online”, and “red” is set as the control content corresponding to the communication state “offline”.

For example, when the terminal 20 is in the online state, the frame of the code display screen is displayed in green, which is the default color, and when the terminal 20 is in the offline state, the frame of the code display screen is displayed in red, which differs from the default color.

Note that the frame colors described above are merely examples and there is no limitation thereto. For example, “white” may be set as the control content corresponding to the communication state “online” and “red” or “green” may be set as the control content corresponding to the communication state “offline”.

Also, the “background color” that is the color of the background of the code display screen may be set as a control target, rather than the “frame color”.

With respect to the control target “background luminance”, “luminance A (default)” is set as the control content corresponding to the communication state “online”, and “luminance B (which is lower than luminance A)” is set as the control content corresponding to the communication state “offline”.

For example, when the terminal 20 is in the online state, the background of the code display screen is displayed with the default luminance A, and when the terminal 20 is in the offline state, the background of the code display screen is displayed with the luminance B that is lower than the luminance A.

Note that lightness may be set as the brightness information regarding the display region instead of or in addition to the luminance.

Also, contrast (difference in brightness) may be set as the brightness information regarding the display region.

With respect to the screen display mode information or display mode information regarding an operation image, it is also possible to vary the display mode of an operation image (e.g., a button or an icon) for displaying the code display screen, according to the communication state, for example, without limitation thereto.

Specifically, the code icon described above can be displayed as “code (online)” in the online state and displayed as “code (offline)” in the offline state, for example. Alternatively, a code icon that is represented as a mark or an image indicating the online state can be displayed in the online state and a code icon that is represented as a mark or an image indicating the offline state can be displayed in the offline state, for example.

### (2) Code-Related Time Limit Information

With respect to the code-related time limit information, “code use time limit information (code use period)” is set as a control target, and “5 minutes (default)” is set as the control content corresponding to the communication state “online”, and “3 minutes” is set as the control content corresponding to the communication state “offline”.

For example, when the terminal 20 is in the online state, the terminal display code is displayed during the code use period, that is set based on the code use time limit for the online state (e.g., 5 minutes), and when the terminal 20 is in the offline state, the terminal display code is displayed during the code use period that is set based on the code use time for the offline state (e.g., 3 minutes), which may be shorter than the default period. The code use period is an example of information regarding a period of validity of the code.

Hereinafter, the code use time limit and the code use period in the online state will be referred to as an “online code use time limit” and an “online code use period”, respectively.

Also, the code use time limit and the code use period in the offline state will be referred to as an “offline code use time limit” and an “offline code use period”, respectively.

### (3) Code-Related Notification Information

With respect to the code-related notification information, “terminal-payment-completion-notification unreceivable state information” is set as a control target.

The terminal-payment-completion-notification unreceivable state information is information that informs the user that the terminal payment completion notification described above cannot be received from the server 10.

Note that the terminal-payment-completion-notification unreceivable state information may be information that informs the user that it is impossible to receive the terminal payment completion notification from the server 10.

That is, the terminal-payment-completion-notification unreceivable state information may also be information that informs the user that, although the terminal payment completion notification cannot be immediately received after payment is carried out by the server 10 because the terminal 20 is in the offline state, the terminal payment completion notification can be received from the server 10 after the terminal 20 returns to the online state, for example.

With respect to the control target “terminal-payment-completion-notification unreceivable state information”, “not display” is set as the control content corresponding to the communication state “online”, and “display” is set as the control content corresponding to the communication state “offline”.

For example, when the terminal 20 is in the online state, the terminal-payment-completion-notification unreceivable state information is not displayed, and when the terminal 20 is in the offline state, the terminal-payment-completion-notification unreceivable state information is displayed.

In the online state, the terminal 20 can receive the terminal payment completion notification from the server 10. However, in the offline state, the terminal 20 cannot receive the terminal payment completion notification from the server 10. Therefore, if the terminal 20 is in the offline state, the user is informed that the terminal payment completion notification cannot be received from the server 10.

Note that the column “apply control: Yes/No” in the data described above does not necessarily have to be provided, and control may be performed with respect to all of the control targets.

Also, the first code-related information display control data 2835A may include priority degrees that indicate which control target among a plurality of control targets is to be controlled. In this case, the controller 21 can control or use control targets which have priority degrees higher than or equal to a predetermined priority degree (or higher than the predetermined priority degree) according to the priority degrees.

Also, terminal data 289 is stored in the storage 28, for example, without limitation thereto.

The terminal data 289 is data regarding the terminal 20, and includes terminal identification information such as the terminal telephone number and the terminal mail address, and information regarding various settings in the terminal 20, for example, without limitation thereto.

### Display Screen Examples

FIGS. 4M and 4N are diagrams showing examples of a code display screen in the present embodiment.

Similarly to the code display screen shown in FIG. 3C, in this code display screen, characters “code” are displayed in an upper portion of the screen, and a payment method, points possessed by the user, and a point tab for setting whether or not to make payment using the points are displayed below “code”.

Also, in different regions below the payment method, the points, and the point tab, a one-dimensional terminal display code image that is represented as a barcode and a two-dimensional terminal display code image QC1 that is represented as a QR code are displayed as code images of a terminal display code stored in the terminal-display-code stock data 2831, for example, without limitation thereto. Also, in these examples, a 12-digit payment number is displayed below the one-dimensional terminal display code image, for example, without limitation thereto.

Also, the remaining time of the code use time limit of the terminal display code is displayed below the two-dimensional terminal display code image QC1, for example, without limitation thereto.

FIG. 4M shows a code display screen that is displayed in the online state, and the frame of the code display screen is displayed in green, which is the default color, for example, without limitation thereto.

Also, since this is the case of the online state, the code use period is set to the online code use period of “5 minutes”, and the remaining time of the online code use time limit is displayed while being counted down from “5 minutes”, for example, without limitation thereto.

FIG. 4N shows a code display screen that is displayed in the offline state, and the frame of the code display screen is displayed in red, which differs from the default color.

Also, since this is the case of the offline state, the code use period is set to the offline code use period of “3 minutes”, and the remaining time of the offline code use time limit is displayed while being counted down from “3 minutes”, for example, without limitation thereto.

FIG. 4O is a diagram showing another example of the code display screen in the present embodiment.

This code display screen is displayed in the offline state, and a pop-up message “Offline Notification You are currently offline, and the code use time limit is 3 minutes” is displayed as an example of the code use time limit information.

Also, an “OK” icon is displayed for the user to approve the content of this notification.

If the screen is displayed as described above, the user of the terminal 20 can recognize that the communication state of the terminal 20 is the offline state and the code use time limit is shorter than that in the online state.

FIG. 4P is a diagram showing another example of the code display screen in the present embodiment.

This code display screen is displayed in the offline state, and a pop-up message “Offline Notification You are currently offline, and cannot receive a notification after payment is complete (you can receive a notification next time you are online). Do you want to continue payment?” is displayed as an example of the terminal-payment-completion-notification unreceivable state information.

Also, an “OK” icon is displayed for the user to approve the content of this notification, and a “not now” icon is displayed to express an intention to make a payment later.

In a case where the user of the terminal 20 makes an offline payment, the user presents the code display screen including the terminal display code image described above to a clerk of the store at the code register 60 to present the terminal display code image so as to be read by the store code reader device 50 within the code use time limit. In this case, the store code reader device 50 transmits, to the server 10, payment request information that includes information (in this example, a payment number) acquired from the read terminal display code image through decoding, to make the server 10 carry out payment, for example, without limitation thereto.

The display screen example described above can improve convenience for the user of the terminal 20 because the user can cause the code display screen to be displayed by touching the code icon, for example, without being conscious of the communication state (online state/offline state) of the terminal 20. That is, the user of the terminal 20 can cause the terminal display code to be displayed in the display 24 through the same operation irrespective of the communication state of the terminal 20. On the other hand, the code display screen is displayed in different display modes according to the communication state (online state/offline state) of the terminal 20, in response to the code display operation, and therefore the user can easily recognize the communication state of the terminal 20 from the different display modes.

### Processing

FIG. 4Q is a flowchart showing an example flow of processing that is executed by the devices in the present embodiment. First payment application processing, which is an example of payment application processing executed by the controller 21 of the terminal 20, first store payment processing, which is an example of store payment processing executed by the controller 51 of the store code reader device 50, and first payment management processing, which is an example of payment management processing executed by the controller 11 of the server 10 are shown in this order from the left.

The flowchart shown in FIG. 4Q is modified from the flowchart shown in FIG. 3D to be applicable to both the online state and the offline state, and the frame indicating the offline state in the flowchart shown in FIG. 3D is deleted, and the step A250 is replaced with operation A350.

After operation A240, when the code display operation is performed by the user of the terminal 20, for example, without limitation thereto, the controller 21 performs first code display processing (operation A350). Then, the controller 21 proceeds to operation A290.

Note that, although FIG. 3D and FIG. 4Q show processing ending after operation A290, the processing is actually looped.

Specifically, the controller 21 returns to operation A110 if a code acquisition operation performed by the user of the terminal 20 is detected after operation A290, for example, without limitation thereto.

On the other hand, if the code display operation performed by the user of the terminal 20 is detected after operation A290, the controller 21 returns to operation A250 (in the case of the processing shown in FIG. 3D) or operation A350 (in the case of the processing shown in FIG. 4Q).

FIG. 4R is a flowchart showing an example flow of the first code display processing.

First, the controller 21 determines the communication state (online state/offline state) of the terminal (operation D110). The method for determining (detecting) the communication state is as described above.

Thereafter, the code-related information display controller 2115 acquires control content that is stored in association with the communication state determined in operation D110 with respect to control targets for which “Yes” is stored as information indicating whether or not to apply control, for example, without limitation thereto, by referring to the code-related information display control data 2835 (operation D120).

Thereafter, the code display processing unit 2113 displays the code display screen in the display 24 based on the control content acquired in operation D120 (operation D130). Specifically, the code display screen shown in any of FIGS. 4M to 4P, for example, is displayed in the display 24 based on the control content acquired in operation D120. Then, the code display processing unit 2113 ends the first code display processing.

### Code

In the processing described above, the terminal 20 requests generation of a terminal display code image to the server 10, and the terminal display code image generated by the server 10 is transmitted to the terminal 20, but there is no limitation thereto. For example, the terminal 20 may request generation of original information (in this example, a payment number) to the server 10, and the original information generated by the server 10 may be transmitted to the terminal 20.

Specifically, in the processing shown in FIG. 3A, the controller 21 transmits code generation request information to request generation of original information (in this example, a payment number) to the server 10 in operation A110. Then, the controller 11 generates the original information based on the code generation request information in operation C120, and transmits the generated original information to the terminal 20 in operation C130. Upon receiving the original information from the server 10 in operation A130, the controller 21 generates a terminal display code image based on the received original information (in this example, the payment number). Then, the controller 21 displays the generated terminal display code image in the display 24.

Similarly, in the processing shown in FIGS. 3D and 4Q, upon receiving the original information (in this example, the payment number) from the server 10 in operation A130, the controller 21 stores the received original information (in this example, the payment number) in the terminal-display-code stock data 2831 in operation A240. Then, the controller 21 reads the stocked original information from the terminal-display-code stock data 2831 and generates a terminal display code image based on the read original information. Then, the controller 21 displays the generated terminal display code image in the display 24 in operations A250 and A350.

Alternatively, a configuration may optionally be employed in which the terminal 20 requests generation of a terminal display code image to the server 10 and the terminal display code image generated by the server 10 is transmitted to the terminal 20, but the terminal 20 stocks original information that is acquired through decoding from the terminal display code image received from the server 10, rather than stocking the terminal display code image received from the server 10.

### Effects of First Embodiment

In the first embodiment, the terminal 20 receives a terminal display code (a code image or a payment number, a non-limiting example of first information) transmitted from the server 10 via the communication I/F 22 (a non-limiting example of a communication unit of the terminal).

Also, the controller 21 of the terminal 20 (a non-limiting example of a controller of the terminal) stores the received terminal display code in the terminal-display-code stock data 2831 (a non-limiting example of a storage of the terminal).

Also, the terminal 20 displays a terminal display code image (a non-limiting example of a first code image) based on the terminal display code stored in the terminal-display-code stock data 2831, in the display 24 (a non-limiting example of a display region of the terminal).

The terminal 20 is configured to control, by means of the controller 21, code-related information (a non-limiting example of second information) displayed in the display 24 in which the terminal display code image is displayed, based on the communication state of the terminal 20 (online state/offline state, a non-limiting example of a communication state of the terminal).

In this configuration, the controller of the terminal controls the second information displayed in the display region in which the first code image is displayed, based on the communication state of the terminal, and therefore this configuration has an effect of enabling the terminal to inform the user of the terminal of the communication state of the terminal when the user makes a payment.

Also, in the first embodiment, the terminal 20 includes a processor that reads the payment application program 282 from a memory in which the payment application program 282 is stored, and executes payment application processing based on the payment application program 282.

The processor receives the terminal display code (the code image or the payment number, a non-limiting example of the first information) transmitted from the server 10 via the communication I/F 22 (a non-limiting example of the communication unit of the terminal).

Also, the processor stores the received terminal display code in the terminal-display-code stock data 2831 (a non-limiting example of the storage of the terminal).

Also, the processor displays the terminal display code image (a non-limiting example of the first code image) based on the terminal display code stored in the terminal-display-code stock data 2831, in the display 24 (a non-limiting example of the display region of the terminal).

The processor is configured to control code-related information (a non-limiting example of the second information) displayed in the display 24 in which the terminal display code image is displayed, based on the online or offline state (a non-limiting example of the communication state of the terminal).

This configuration also has the same effect as that described above.

The first embodiment also shows a configuration in which the controller 21 of the terminal 20 performs control to display a display of a first display mode (a non-limiting example of a first display) as the code-related information in the code display screen when the communication state of the terminal is the online state (a non-limiting example of the first communication state), and performs control to display a display of a second display mode (a non-limiting example of a second display) as the code-related information in the display 24 when the communication state of the terminal is the offline state (a non-limiting example of the second communication state).

In this configuration, the terminal varies what is displayed, depending on whether the communication state is the first communication state or the second communication state, and therefore this configuration has an effect of enabling the terminal to inform the user of the terminal of the communication state of the terminal in such a manner that the user can easily recognize the communication state.

The first embodiment also shows a configuration in which the code-related information includes the frame color and the background color of the code display screen (non-limiting examples of color information regarding the display region).

This configuration has an effect of enabling the terminal to control, by means of the controller, the color information regarding the display region in which the first code image is displayed.

The first embodiment also shows a configuration in which the code-related information includes information regarding a code use time limit of the terminal display code image displayed in the code display screen.

This configuration has an effect of enabling the terminal to control, by means of the controller, information regarding a period of validity of the first code image.

In this case, the controller 21 can perform control to display the online code use time limit or the remaining time of the online code use time limit (a non-limiting example of information regarding a first period of validity) as the code-related information in the code display screen when the communication state is the online state, and perform control to display the offline code use time limit that is shorter than the online code use time limit or the remaining time of the offline code use time limit (a non-limiting example of information regarding a second period of validity) as the code-related information in the code display screen when the communication state is the offline state.

This configuration has an effect of enabling the terminal to display information regarding different periods of validity in the display region according to the communication state of the terminal, to notify the user of the information.

The first embodiment also shows a configuration in which the code-related information includes information regarding luminance or the like of the code display screen (a non-limiting example of brightness information regarding the display region).

This configuration has an effect of enabling the terminal to control, by means of the controller, the brightness information regarding the display region.

The first embodiment also shows a configuration in which the code-related information is displayed in the code display screen when the communication state is such that the communication amount of the terminal 20 is smaller than a set communication amount.

This configuration has an effect of enabling the terminal to display the second information in the display region to notify the user when the communication state is such that the communication amount of the terminal is smaller than the set communication amount.

The first embodiment also shows a configuration in which the code-related information includes the terminal-payment-completion-notification unreceivable state information.

This configuration has an effect of enabling the terminal to give a notification indicating that a payment completion notification will not be transmitted.

### First Variation (1)

The code-related information shown in the code-related information display control data 2835 described above and the method for controlling the code-related information are merely examples, and there is no limitation thereto.

For example, characters (the size, font, color, thickness, etc., of characters) displayed in the code display screen may be set as a control target of the screen display mode information, and control may be performed to display the characters differently depending on the communication state (online state/offline state).

Also, the layout of the code display screen (the position (region) where a code image is arranged, the size, decoration, etc., of the screen) may be set as a control target of the screen display mode information, and the layout may be varied depending on the communication state (online state/offline state).

### First Variation (2)

In the first embodiment, at least one terminal display code image may also be stored in the terminal-display-code stock data 2831 as a terminal display code image that can be used in case of an emergency. In this case, a flag indicating that the code is for an emergency can be set in association with the terminal display code for an emergency in the terminal-display-code stock data 2831, for example, without limitation thereto.

In this case, the terminal display code for an emergency can be set in the terminal 20 through a selection operation performed by the user of the terminal 20, for example. A list of terminal display codes that are stored in the terminal-display-code stock data 2831 is displayed by the payment application, for example, without limitation thereto. Then, the user is urged to select (e.g., through a touch operation) a terminal display code for an emergency, and the flag indicating that the code is for an emergency is set in association with the selected terminal display code.

Note that a plurality of (two or more) terminal display codes may be set as terminal display codes for an emergency.

In this case, the plurality of (two or more) terminal display codes may be selected by the user as the terminal display codes for an emergency.

### First Variation (3)

In the first embodiment, it is assumed that the “first information (code information)” in the present disclosure is a payment number or a terminal display code image including a payment number, but there is no limitation thereto. For example, a token, which is a type of authentication information, or a terminal display code image including a token may also be employed as the “first information (code information)” in the present disclosure. The “first information” may contain information that enables a fund transfer from a mobile terminal (e.g., the terminal 20) to the store POS system 40, and may be presented to a product seller or a service provider (e.g., the store code reader device 50 of the store POS system 40) so that a customer (e.g., the user of the terminal 20) tenders a payment in exchange for goods and services.

In this case, a token that is issued using a method (algorithm) for generating a random token may be included in the terminal display code image, for example, without limitation thereto, rather than a payment number being included in the terminal display code image. In this case, in the server 10, identification information for identifying the terminal 20 or the user of the terminal 20 can be stored in association with the issued token in the code management data of the code management database 159 in the storage 15.

The “token” is a type of authentication information for authenticating, by the server 10, the terminal 20 or the user of the terminal 20 as an authorized terminal 20 or an authorized user of the terminal 20, for example, without limitation thereto. The “authentication information” is information that is issued by a certification authority, and the token described above serves as authentication information that is issued by the server 10, which serves as the certification authority, to authenticate the terminal 20 or the user of the terminal 20.

Note that the token can also be referred to as a “random token”, an “access token”, or a “payment token”, for example. Since the token is issued at random as described above, a different token is issued every time a terminal display code is generated. Accordingly, the token serves as a one-time password.

Also, in addition to the payment number or the token, information such as a URL (Uniform Resource Locator) for accessing a payment page that is a type of web page provided by the server 10 may be included as an example of access information that is used by the store code reader device 50 to access a web site or a web page provided by the server 10 after reading the terminal display code image.

### First Variation (4)

A configuration is also possible in which, when the terminal 20 cannot communicate with the server 10 using the first communication method, the terminal 20 communicates with the server 10 using the second communication method to receive the terminal payment completion notification from the server 10.

FIGS. 4S to 4X are diagrams showing an example of the code display screen according to this variation.

Similarly to the code display screen shown in FIG. 4P, the code display screen shown in FIG. 4S is an example of the code display screen displayed in the offline state, and a pop-up message “Offline Notification You are currently offline, and cannot receive a notification after payment is complete. (You can receive a notification next time you are online). Do you want to continue payment?” is displayed as an example of the terminal-payment-completion-notification unreceivable state information.

Also, an “OK” icon is displayed to express an intention to approve the content of this notification, and a “not now” icon is displayed to express an intention not to approve the content of this notification at present.

Also, since this is the case of the offline state, the code use period is set to the offline code use period of “3 minutes”, and the remaining time of the offline code use time limit is displayed while being counted down from “3 minutes”, as described above.

If the “OK” icon is touched by the user, a pop-up message “Do you want to access a wireless network?” is displayed as an example of information for confirming the user's intention to perform communication with the server 10 using the second communication method, as shown in FIG. 4T, for example, without limitation thereto.

Also, an “OK” icon is displayed to express an intention to approve the content of this notification, and a “not now” icon is displayed to express an intention not to approve the content of this notification at present.

If the “OK” icon shown in FIG. 4T is touched, a selection screen is displayed as shown in FIG. 4U, for example.

In the selection screen, a selection box for selecting a wireless network is displayed at the center of the screen, and the user of the terminal 20 selects a wireless network from candidate wireless networks displayed in the selection box.

When a wireless network is selected in the selection screen shown in FIG. 4U, communication is attempted using the wireless network. If the communication is OK (successful), the information displayed in the pop-up window is hidden.

Thereafter, when a terminal display code image displayed in the code display screen is read by the store code reader device 50 as shown in FIG. 4V, for example, payment processing is carried out by the server 10. Then, the terminal payment completion notification is transmitted from the server 10 to the terminal 20.

Note that, in FIG. 4V, the remaining time of the offline code use time limit (in this example, “3 minutes”) is updated based on the amount of time that has elapsed from when display of the code display screen was started in FIG. 4S.

Upon receiving the terminal payment completion notification from the server 10 using the second communication method, the terminal 20 displays payment completion notification information that includes a message “Payment is complete. You can check details in “payment history”.” is displayed in a pop-up window as shown in FIG. 4W, for example. After displaying the payment completion notification information, the terminal 20 hides the code display screen and again displays the top screen, for example.

Note that in the online state, a period (e.g., “5 minutes”) that is longer than the offline code use period (e.g., “3 minutes”) can be set as the online code use period, as described in the first embodiment.

Accordingly, if communication using the second communication method is successful after information regarding the offline code use time limit is displayed in the code display screen in the offline state, the displayed information regarding the offline code use time limit may be changed (switched) to information regarding the online code use time limit.

FIG. 4X is a diagram showing an example of the code display screen in this case.

If communication using the wireless network selected in the selection screen shown in FIG. 4U is OK (successful), the information displayed in the pop-up window is hidden, and the screen shown in FIG. 4X is displayed, for example.

In this code display screen, a pop-up message “Online Notification You are currently online, and the code use time limit is 5 minutes” is displayed.

Also, as a result of the offline code use time limit being changed to the online code use time limit, the code use period is changed to the online code use period of “5 minutes”, and the remaining time of the online code use time limit is displayed while being counted down from “5 minutes”.

In this variation, the terminal 20 includes the communication I/F 22 (a non-limiting example of a first communication unit) and a communication I/F for the second communication method. The communication state (online state/offline state) of the terminal 20 refers to the communication state of the communication I/F 22, and when the communication state is such that the communication amount of the terminal 20 is smaller than a set communication amount, the controller 21 executes control to hide the code display screen including the terminal display code image upon receiving the terminal payment completion notification (a non-limiting example of information regarding completion of payment) transmitted from the server 10 (a non-limiting example of a communication device) via the communication I/F for the second communication method.

This configuration has an effect of making it possible to hide the first code image from the display region if the information regarding completion of payment transmitted from the communication device is received via a second communication unit when the communication amount of the terminal is smaller than the set communication amount.

### First Variation (5)

In the first embodiment, when the terminal 20 displays a terminal display code image in the display 24, the controller 21 may instruct (guide) the user to present the displayed terminal display code image so as to be read by the store code reader device 50, for example, without limitation thereto. This processing is an example of processing relating to payment.

Specifically, a message such as “present displayed code image to be read by the code reader of the store” can be displayed in a region different from the region where the terminal display code image is displayed in the code display screen, for example, without limitation thereto.

### First Variation (6)

The display screen of the payment application described in the first embodiment is merely an example, and design changes can be appropriately made. For example, it is also possible to display a “code (offline) icon” that is shown as “code (offline)”, other than the “code icon” described above, in the top screen of the payment application. In this case, a configuration may be employed in which, if it is determined that the terminal 20 is in the online state, a terminal display code is displayed when the “code icon” is operated, and if it is determined that the terminal 20 is in the offline state, a terminal display code is displayed when the “code (offline) icon” is operated.

### First Variation (7)

In the processing shown in FIG. 3D or 4-16, the terminal 20 may perform the processing performed in operation A240 and the processing performed in operation A250 or A350 to display a terminal display code in the display 24 upon receiving the terminal display code from the server 10 in operation A130.

In this case, the display can be directly switched to the code display screen including the terminal display code after the code icon is touched in the top screen (e.g., FIG. 3B) of the payment application, for example, without limitation thereto.

### First Variation (8)

In the online state, the server 10 communicates with the terminal 20 and can recognize that the terminal display code is displayed in the terminal 20, and therefore can identify the code display time point (code display date and time) based on time measurement information output from the clock unit 19.

However, in the offline state, the server 10 cannot communicate with the terminal 20, and therefore cannot be aware of whether or not the terminal display code is displayed in the terminal 20 and cannot identify the code display time point (code display date and time).

Accordingly, in the offline state, the server 10 cannot determine whether or not the present time is within the code use time limit (whether or not the code use time limit has expired).

Therefore, the following processing can be performed, for example, without limitation thereto.

FIG. 4Y is a flowchart showing an example flow of processing that is executed by the devices in this variation. Second payment application processing, which is an example of the payment application processing executed by the controller 21 of the terminal 20, second store payment processing, which is an example of the store payment processing executed by the controller 51 of the store code reader device 50, and second payment management processing, which is an example of the payment management processing executed by the controller 11 of the server 10 are shown in this order from the left.

A portion of the flowchart shown in FIG. 4Y is modified from the flowchart shown in FIG. 3D. Differences from the flowchart shown in FIG. 3D are processing steps (e.g., operations A450, B450, B460, and C470) in the offline state, for example, without limitation thereto.

In this processing, identification information for identifying the terminal 20 or the user of the terminal 20 will be described as the application ID described above, for example.

After operation A240, when the code display operation is performed by the user of the terminal 20 in the offline state, for example, without limitation thereto, the controller 21 performs extended terminal display code generation processing, and the code display processing unit 2113 performs code display processing (operation A450).

Here, a payment code that is processed (subjected to data processing, generated, displayed, etc.) in the terminal 20 based on a terminal display code stocked in operation A240 will be referred to as an “extended terminal display code”, and a code image of the extended terminal display code will be referred to as an “extended terminal display code image”.

Similarly to the terminal display code, the extended terminal display code is used for payment of the payment type “terminal code display”, but can be used not only for an online payment but also for an offline payment.

Note that the extended terminal display code can be used not only for an offline payment but also for an online payment. That is, the terminal 20 does not necessarily have to determine (detect) whether or not the communication state is the offline state, and payment can be made using the extended terminal display code irrespective of whether the communication state is the online state or the offline state.

In the extended terminal display code generation processing, an extended terminal display code image is generated, for example, without limitation thereto. Specifically, a payment number that is stocked in the terminal-display-code stock data 2831 or is acquired through decoding from a terminal display code image stocked in the terminal-display-code stock data 2831 and time stamp information that is generated by the controller 21 are encoded and expressed as a figure (image) to generate the extended terminal display code image.

Here, the time stamp information indicates date and time, a date, or a time point at which a specific phenomenon (specific event) occurred, and serves as an electronic time certificate for certifying that information or data (here, the extended terminal display code) that is associated with the time stamp information reliably existed at the time point.

In this example, the specific phenomenon is “the extended terminal display code image being displayed in the display 24 of the terminal 20”, and the controller 21 of the terminal 20 generates time stamp information that includes a code display time point at which the extended terminal display code image is displayed (display of the code image is started). The code display time point and the time stamp information are examples of “time information”, and are generated based on information obtained through time measurement by the clock unit 29A of the terminal 20.

Note that, depending on the store, there are cases where two-dimensional codes cannot be read, but one-dimensional codes can be read. Therefore, an extended terminal display code image that is represented as a one-dimensional code (non-limiting examples of which include barcodes) may be generated in addition to a two-dimensional code (non-limiting examples of which include QR codes).

Also, time stamp information that includes “code display date and time”, which includes information regarding a date in addition to a time point, instead of the code display time point, may be generated.

Also, information that is obtained by encrypting the payment number or the time stamp information may be encoded so that a third party cannot obtain the original information through decoding.

Also, the code display time point or the code display date and time may be encoded, rather than encoding the time stamp information.

In the code display processing, a code display screen that includes at least the extended terminal display code image is displayed in the display 24, for example, without limitation thereto.

Note that, if a two-dimensional extended terminal display code image is generated in the extended terminal display code generation processing as described above, the two-dimensional extended terminal display code image can be displayed, for example, without limitation thereto.

Also, if a one-dimensional extended terminal display code image is also generated in the extended terminal display code generation processing, the one-dimensional extended terminal display code image can also be displayed in addition to the two-dimensional extended terminal display code image, for example, without limitation thereto. In this case, the payment number may be displayed in the vicinity of the one-dimensional extended terminal display code image.

Thereafter, when the extended terminal display code image displayed in the display 24 is presented to a store clerk or the like by the user of the terminal 20, the controller 51 controls the code reader 58 to read the extended terminal display code image displayed in the display 24 of the terminal 20 (operation B450).

The controller 51 accesses the server 10 by means of the communication I/F 54. Then, the controller 51 transmits, by means of the communication I/F 54, to the server 10, payment request information that includes at least the payment number and the time stamp information acquired through decoding, store identification information, and a to-be-paid amount (operation B460).

Upon receiving the payment request information from the store code reader device 50 by means of the communication I/F 14 (operation C160), the controller 11 performs payment processing (operation C470).

Specifically, the controller 11 determines whether or not the payment number included in the received payment request information is stored in the code management database 159 in association with the application ID. Upon determining that the payment number has been stored, the controller 11 determines whether or not the present time is within the code use time limit by comparing the code use period with a difference between a time measured by the clock unit 19 of the server 10 and the code display time point identified from the time stamp information included in the received payment request information. If the present time is within the code use time limit, the controller 11 determines that “payment can be made”, and carries out payment by subtracting the to-be-paid amount from the balance stored in payment management data corresponding to the application ID in the payment management database 157A.

### Second Embodiment

The second embodiment is an embodiment in which the controller 21 controls settings relating to payment that is based on a terminal display code, based on the communication state of the terminal 20.

As described above, the terminal 20 can receive the terminal payment completion notification from the server 10 in the online state.

In contrast, the terminal 20 cannot receive the terminal payment completion notification from the server 10 in the offline state. Accordingly, there is a problem in terms of security in that, even if a terminal display code image displayed in the display 24 is stolen through screenshotting or the like and is used for payment by a third person, for example, the user of the terminal 20 may be left unaware.

Matter described in the second embodiment can also be applied to other embodiments and variations.

Constitutional elements that are the same as those already described are denoted with the same reference numerals as those used for corresponding elements, and a redundant description thereof is omitted.

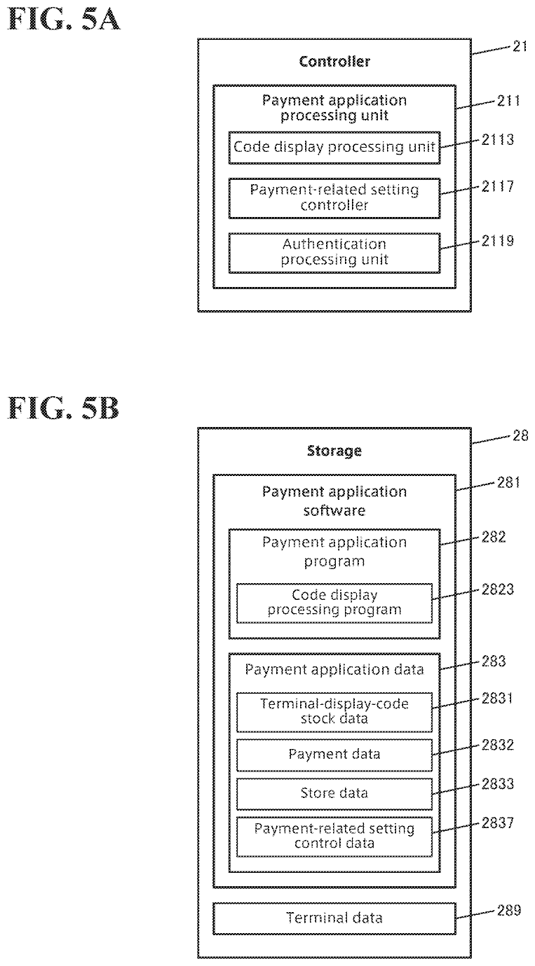

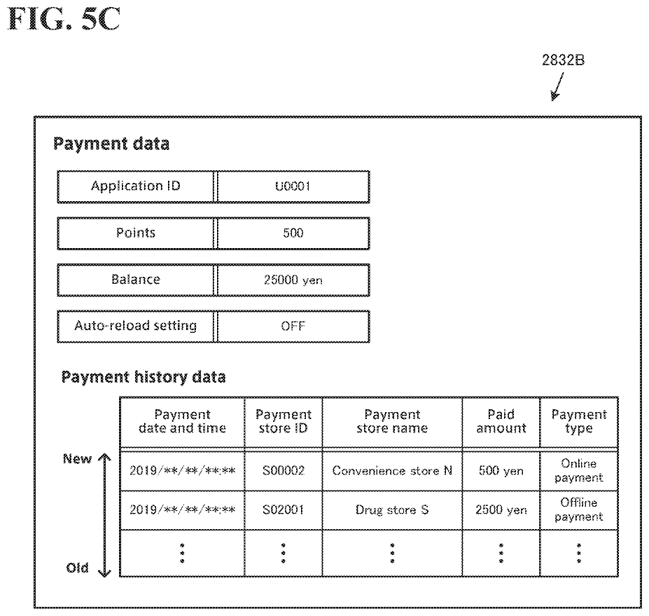

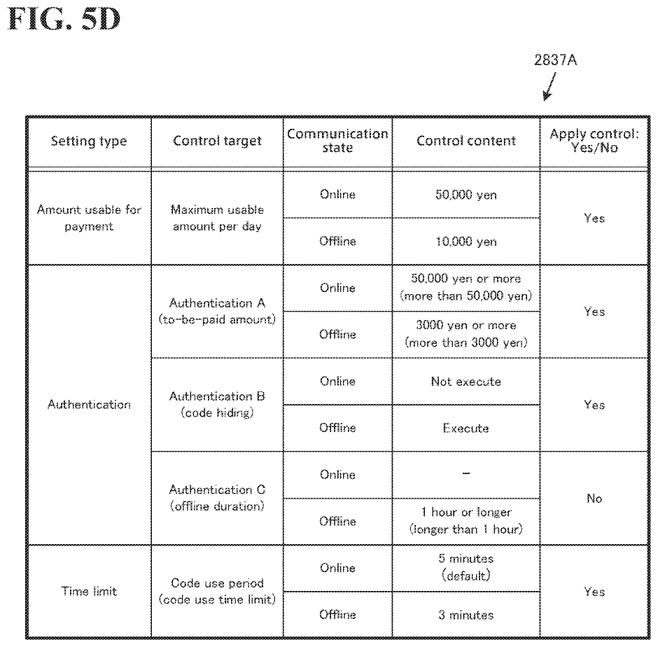

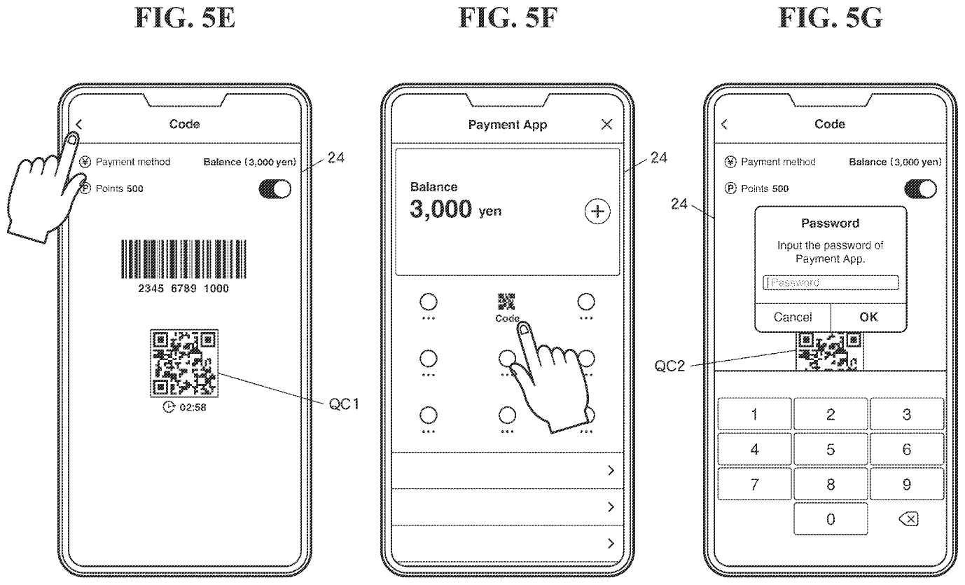

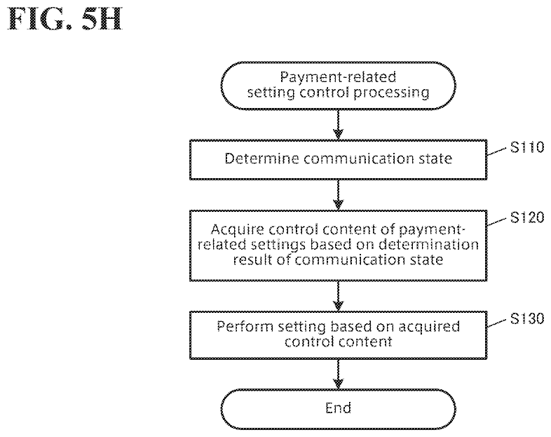

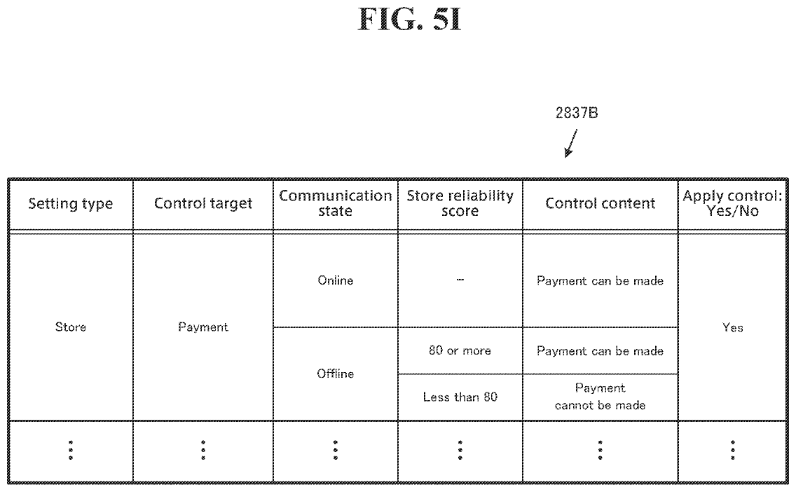

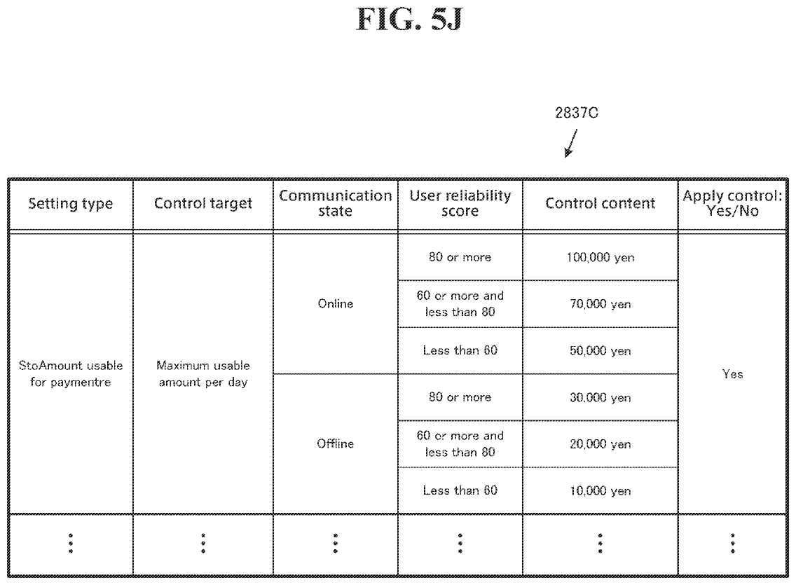

FIG. 5A is a diagram showing an example of functions that are implemented by the controller 21 of the terminal 20 in the present embodiment.

The payment application processing unit 211 of the controller 21 includes a payment-related setting controller 2117 and an authentication processing unit 2119 in addition to the code display processing unit 2113, for example, without limitation thereto.

FIG. 5B is a diagram showing an example of information that is stored in the storage 28 of the terminal 20 in the present embodiment.

The payment application data 283 includes payment-related setting control data 2837 in addition to the terminal-display-code stock data 2831, the payment data 2832, and the store data 2833, for example, without limitation thereto.

FIG. 5C is a diagram showing an example structure of second payment data 2832B, which is an example of the payment data 2832 in the present embodiment.

An application ID, points, the balance, an auto-reload setting, and payment history data are stored in the second payment data 2832B, for example, without limitation thereto.

Payment date and time, a payment store ID, a payment store name, a paid amount, and a payment type are stored in association with each other in time series in the payment history data, for example, without limitation thereto.

The type of payment (online payment/offline payment) corresponding to the communication state of the terminal 20 is stored as the payment type.

The payment type can be determined as described below, for example.

The controller 21 of the terminal 20 counts down the time (elapsed time) passed from when a code display screen is displayed (display is started) to when the terminal payment completion notification is received from the server 10 based on time measurement information that is output from the clock unit 29A. If the elapsed time is no longer than a predetermined time, it is determined that payment indicated by the received terminal payment completion notification is “online payment”, and if the elapsed time is longer than the predetermined time, it is determined that payment indicated by the received terminal payment completion notification is “offline payment”.

This is because, in the case of an offline payment, the terminal 20 cannot receive the terminal payment completion notification from the server 10 until the terminal 20 returns from the offline state to the online state, and accordingly, if it takes a certain time to receive the terminal payment completion notification after the code display screen is displayed, it can be presumed that an offline payment is highly likely to have been made.

The payment-related setting control data 2837 is data that is used by the payment-related setting controller 2117 to control payment-related settings, and FIG. 5D shows an example data structure of first payment-related setting control data 2837A, which is an example of the payment-related setting control data 2837.

A setting type, a control target, a communication state, control content, and apply control: Yes/No are stored in association with each other in the first payment-related setting control data 2837A, for example, without limitation thereto.

Setting types include “amount usable for payment”, “authentication”, and “time limit”, for example, without limitation thereto.

The amount usable for payment is a setting regarding an amount that can be used by the user of the terminal 20 for payment.

The authentication is a setting regarding authentication processing that is executed by the authentication processing unit 2119 to authenticate the user of the terminal 20 as an authorized user in payment.

The time limit is a setting regarding a time limit of the terminal display code that is used for payment.

With respect to each setting type, items that are controlled by the payment-related setting controller 2117 are set as control targets.

With respect to each control target, “online” that indicates the online state of the terminal 20 and “offline” that indicates the offline state of the terminal 20 are set as communication states.

How the payment-related setting controller 2117 controls the control target is set as the control content.

Apply control: Yes/No is information (e.g., a flag) that indicates whether or not control of a control target is applied, and “Yes” indicating that control is to be applied is stored in association with a control target for which control is applied, and “No” indicating that control is not to be applied is stored in association with a control target for which control is not applied.

The following describes specific examples in detail.

### (1) Amount Usable for Payment

With respect to the amount usable for payment, “maximum usable amount per day” is set as a control target.

Note that the maximum usable amount per day is as described in the first embodiment.

“50,000 yen” is set as the control content corresponding to the communication state “online”, and “10,000 yen” is set as the control content corresponding to the communication state “offline”.

This means that when the terminal 20 is in the online state, control is performed with the maximum usable amount per day set to “50,000 yen”, and when the terminal 20 is in the offline state, control is performed with the maximum usable amount per day set to “10,000 yen”.

The safety of payment is low in the offline state, when compared to the online state, and therefore control is performed with the maximum usable amount per day in the offline state set to be smaller (lower) than the maximum usable amount per day in the online state.

In this case, the controller 21 of the terminal 20 determines the communication state of the terminal 20 upon detecting the code display operation performed by the user of the terminal 20, for example, without limitation thereto. Then, if a cumulative amount that is calculated by summing up amounts paid that day is smaller than (or not larger than) the maximum usable amount per day associated with the determined communication state, the controller 21 determines that “payment can be made”, and otherwise determines that “payment cannot be made”.

If it is determined that “payment cannot be made”, the controller 21 does not display a code display screen in the display 24 or displays a code display screen that includes only an error message in the display 24, so that the terminal display code image cannot be read, for example, without limitation thereto.

Also, in this case, a cumulative paid amount can be calculated for each communication state, for example, without limitation thereto.

Specifically, a cumulative amount (hereinafter referred to as an “online cumulative paid amount”) that is calculated by summing up amounts paid in an online payment and a cumulative amount (hereinafter referred to as an “offline cumulative paid amount”) that is calculated by summing up amounts paid in offline payment can be separately calculated based on the payment type included in payment history data of the second payment data 2832B (see FIG. 5C), for example, without limitation thereto.

Note that a cumulative amount may be calculated by summing up paid amounts regardless of the communication state (online state/offline state) without distinguishing the communication state.

In this example, the “maximum usable amount per day” is set as the control target, but there is no limitation thereto.

The maximum usable amount can also be set with respect to a predetermined past period that is longer than a day (e.g., the past week, past two weeks, or the past month), instead of the maximum usable amount per day.

### (2) Authentication

With respect to the authentication, “authentication A (to-be-paid amount)”, “authentication B (code hiding)”, and “authentication C (offline duration)” are set as control targets. With respect to each type of authentication, information that is used to determine whether or not to execute authentication of the type is shown in parenthesis.

With respect to the control target “authentication A (to-be-paid amount)”, “50,000 yen or more (or more than 50,000 yen)” is set as the control content corresponding to the communication state “online”, and “3000 yen or more (or more than 3000 yen)” is set as the control content corresponding to the communication state “offline”.

This means that when the terminal 20 is in the online state, authentication is executed if the to-be-paid amount is 50,000 yen or more (or more than 50,000 yen), and when the terminal 20 is in the offline state, authentication is executed if the to-be-paid amount is 3000 yen or more (or more than 3000 yen).

The safety of payment is low in the offline state, when compared to the online state, and accordingly authentication is executed in the offline state even when the to-be-paid amount is small (low), when compared to the online state.

However, in the case of the payment type “terminal code display”, when a terminal display code image displayed in the display 24 is read by the store code reader device 50, a to-be-paid amount that is input to the store code reader device 50 is transmitted to the server 10. Therefore, the terminal 20 cannot be aware of the to-be-paid amount.

Therefore, after the code display screen is displayed in the terminal 20, a store clerk or the like inputs the to-be-paid amount to the store code reader device 50 before the terminal display code image is read by the store code reader device 50, for example, without limitation thereto. Then, the input to-be-paid amount is transmitted from the store code reader device 50 to the terminal 20 through near field communication or the like. The authentication processing unit 2119 can execute authentication processing upon receiving the to-be-paid amount from the store code reader device 50.

Note that the store clerk or the like may also orally inform the user of the terminal 20 of the to-be-paid amount input to the store code reader device 50.

Also, the to-be-paid amount may also be displayed in a display that is provided together with the code register 60 as a single unit or is provided separately from the code register 60 and includes a display surface configured to face a customer.

In these cases, the user of the terminal 20 may also manually input the to-be-paid amount to the terminal 20. In this case, the authentication processing unit 2119 can execute authentication processing when the to-be-paid amount is input.

Also, in the payment-related setting control data 2837, control content may be set in association with a paid amount, instead of the to-be-paid amount. For example, in association with an amount paid in a predetermined past period (e.g., the past day or the past week), “100,000 yen or more (or more than 100,000 yen)” may be set as the control content corresponding to the online state and “10,000 yen or more (or more than 10,000 yen)” may be set as the control content corresponding to the offline state.

With respect to the control target “authentication B (code hiding)”, “not execute” is set as the control content corresponding to the communication state “online”, and “execute” is set as the control content corresponding to the communication state “offline”.

Here, “code hiding” indicates that after the user of the terminal 20 has caused a terminal display code (terminal display code image) to be displayed in the display 24, the user hides the displayed terminal display code (terminal display code image) by operating a return button (close button) that is displayed in the code display screen or operating a home button, for example.

This means that when the terminal 20 is in the online state, authentication is not executed even if a displayed code (code image) is hidden, but when the terminal 20 is in the offline state, authentication is executed if a displayed code (code image) is hidden.

The terminal display code in the present disclosure can be used not only in the online state but also in the offline state as described above. In the online state, the terminal 20 can receive the terminal payment completion notification from the server 10 immediately after payment is carried out by the server 10. Accordingly, after receiving the terminal payment completion notification, the terminal 20 can delete data regarding the terminal display code used for payment from the terminal-display-code stock data 2831, for example, without limitation thereto.

However, in the offline state, the terminal 20 cannot receive the terminal payment completion notification from the server 10 until the terminal 20 returns to the online state, and therefore the terminal 20 cannot be aware of whether or not payment has been carried out by the server 10. Accordingly, even if the user of the terminal 20 used a terminal display code for payment (presented the terminal display code so as to be read by the store code reader device 50) in the offline state, for example, the terminal 20 cannot delete the terminal display code. Therefore, there is a risk in that the user of the terminal 20 may cause the terminal display code that has been used for payment to be displayed again and use the terminal display code again for payment, for example.

Therefore, in the offline state, if the user of the terminal 20 causes a terminal display code to be displayed in the display 24 and thereafter hides the displayed terminal display code, authentication is performed at either of the following timings, for example, without limitation thereto.

(1) A timing at which a terminal display code is newly displayed in the display 24 after a terminal display code (terminal display code image) is hidden.

(2) A timing at which a terminal display code (terminal display code image) is hidden.

Note that authentication may be performed when a terminal display code is hidden a set number of times (e.g., “three times” or “five times”) or more (or more than the set number of times) in the offline state, for example, without limitation thereto, rather than authentication being performed every time a terminal display code is hidden.

With respect to the control target “authentication C (offline duration)”, “- (none)” is set as the control content corresponding to the communication state “online”, and “1 hour or longer (or longer than 1 hour)” is set as the control content corresponding to the communication state “offline”.

This means that when the terminal 20 is in the online state, authentication is not executed, but when the terminal 20 is in the offline state, authentication is executed if the offline state has continued for 1 hour or longer (or longer than 1 hour).

Note that authentication may be executed based on the number of times or frequency at which the terminal 20 has entered the offline state during a unit period (e.g., the past day or the past week), instead of or in addition to the offline duration.

For example, authentication may be executed if the terminal 20 has entered the offline state at least a set number of times (or more than the set number of times) or at a frequency that is higher than or equal to a set frequency (or higher than the set frequency) during the unit period.

The authentication A to C described above may be authentication of the same element or different elements.

As authentication of different elements, it is possible to apply authentication that is based on information regarding knowledge of the user (e.g., authentication performed using a password or a secret question), authentication that is based on information possessed by the user (e.g., authentication performed using a one-time password or a token), and authentication that is based on bio-information regarding the user (e.g., fingerprint authentication or face authentication), for example, without limitation thereto.

Also, whether or not to execute the authentication described above may be determined based on a combination of two or more conditions.

For example, a configuration may be employed in which “code hiding” of the authentication B and “offline duration” of the authentication C are combined, and authentication is not executed in the online state, but is executed in the offline state if “a code is hidden and the offline duration is longer than or equal to a set period (or longer than the set period)”, for example, without limitation thereto.

(3) Time Limit

With respect to the time limit, “code use period (code use time limit)” is set as a control target.

“5 minutes (default)” is set as the control content corresponding to the communication state “online”, and “3 minutes” is set as the control content corresponding to the communication state “offline”.

Similarly to the first embodiment, this means that when the terminal 20 is in the online state, the code use period is set to the default period of “5 minutes”, and when the terminal 20 is in the offline state, the code use period is set to “3 minutes”. Display Screen Examples

FIGS. 5E to 5G is a diagram showing authentication processing executed in the terminal 20 in the present embodiment. Display screens may be presented to a user in the order of FIGS. 5E, 5F, and 5G.

FIG. 5E shows a state where a code display screen including a two-dimensional terminal display code image QC1 is displayed in the display 24 of the terminal 20 in the offline state, and the user of the terminal 20 touches a return button (close button) displayed at the upper left of the screen. In this case, the code display screen is hidden as a result of the return button being touched, and the top screen of the payment application is displayed.

Here, assume that the code icon of the payment application has been touched by the user of the terminal 20 as shown in FIG. 5F, for example. In this case, a new terminal display code is displayed in the display 24 after the terminal display code that has been displayed in the display 24 in the offline state is hidden, and therefore the authentication processing unit 2119 performs authentication processing, for example, without limitation thereto.

Specifically, a code display screen that includes the new terminal display code image (in this example, a two-dimensional terminal display code image QC2) is displayed in the display 24 as shown in FIG. 5G, for example, and at this time, an authentication screen for performing authentication is displayed, for example.

In this example, a password display field in which an input password is to be displayed is displayed in a pop-up window together with a message “Password Input the password of Payment App”. Also, numeric keys to be used by the user to input a password are displayed in a lower portion of the screen.

The input password is compared with a password (authentication password) that is stored in the storage 28 of the terminal 20. If the authentication result is OK, the pop-up window is erased, and the terminal display code image displayed in the background appears and can be used for payment.

### Processing

FIG. 5H is a flowchart showing an example flow of payment-related setting control processing that is executed by the controller 21 of the terminal 20 in the present embodiment.

First, the controller 21 determines the communication state (online state/offline state) of the terminal (operation S110). The method for determining (detecting) the communication state is as described above.

Thereafter, the payment-related setting controller 2117 acquires control content that is stored in association with the communication state determined in operation S110 with respect to control targets for which “Yes” is stored as the information indicating whether or not to apply control, by referring to the payment-related setting control data 2837 (operation S120).

Then, the payment-related setting controller 2117 performs setting (control setting) for performing control based on the control content acquired in S120 (operation S130). After this, the payment-related setting controller 2117 controls payment-related settings based on the control setting, in the payment application processing. Then, the controller 21 ends the payment-related setting control processing.

### Effects of Second Embodiment

In the second embodiment, the terminal 20 receives a terminal display code (a code image or a payment number, a non-limiting example of the first information) transmitted from the server 10 via the communication I/F 22 (a non-limiting example of the communication unit of the terminal).

Also, the controller 21 of the terminal 20 (a non-limiting example of the controller of the terminal) stores the received terminal display code in the terminal-display-code stock data 2831 (a non-limiting example of the storage of the terminal).

The terminal 20 is configured to control, by means of the controller 21, a payment-related setting relating to payment (a non-limiting example of a setting relating to payment) that is based on the terminal display code, based on the communication state of the terminal 20 (online state/offline state, a non-limiting example of the communication state of the terminal).

In this configuration, the controller of the terminal controls the setting relating to payment that is based on the first information, based on the communication state of the terminal, and therefore this configuration has an effect of enabling the terminal to make the user make a payment based on the settings corresponding to the communication state of the terminal.

Also, in the second embodiment, the terminal 20 includes a processor that reads the payment application program 282 from a memory in which the payment application program 282 is stored, and executes payment application processing based on the payment application program 282.

The processor receives the terminal display code (the code image or the payment number, a non-limiting example of the first information) transmitted from the server 10 via the communication I/F 22 (a non-limiting example of the communication unit of the terminal).

Also, the processor stores the received terminal display code in the terminal-display-code stock data 2831 (a non-limiting example of the storage of the terminal).

The processor is configured to control a payment-related setting relating to payment (a non-limiting example of the setting relating to payment) that is based on the terminal display code, based on the communication state of the terminal (online state/offline state, a non-limiting example of the communication state of the terminal).

This configuration also has the same effect as that described above.

Also, the second embodiment shows a configuration in which the controller 21 performs a setting (a non-limiting example of a first setting) as the payment-related setting if the communication state of the terminal is the online state, and performs another setting (a non-limiting example of a second setting) as the payment-related setting if the communication state of the terminal is the offline state.

This configuration has an effect of enabling the terminal to control, by means of the controller, different settings according to the communication state.

Also, the second embodiment shows a configuration in which the payment-related setting includes a setting regarding an amount usable for payment (a non-limiting example of an amount that can be used for payment).

This configuration has an effect of enabling the terminal to control, by means of the controller, the setting regarding the amount that can be used for payment according to the communication state.

Also, the second embodiment shows a configuration in which the payment-related setting includes a setting regarding authentication (e.g., authentication of the user of the terminal that is performed to execute processing relating to payment).

This configuration has an effect of enabling the terminal to control, by means of the controller, the setting regarding authentication of the user of the terminal that is performed to execute processing relating to payment, according to the communication state.

Also, the second embodiment shows a configuration in which the controller 21 performs authentication as the payment-related setting in the online state if at least a first amount is paid, and performs authentication as the payment-related setting in the offline state if at least a second amount that is smaller than the first amount is paid.

This configuration has an effect of enabling the terminal to make authentication more likely to be performed in the second communication state when compared to the first communication state, the amount of communicated information being smaller in the second communication state than in the first communication state.

Also, in the second embodiment, the terminal 20 displays a terminal display code image that is based on the terminal display code, in the display 24. In the offline state, the controller 21 performs authentication as the payment-related setting if the terminal display code image (a non-limiting example of the first code image) is hidden from the display 24.

In this configuration, the terminal performs authentication if the first code image is hidden from the display region when the communication amount of the terminal is smaller than a set communication amount, and therefore this configuration has an effect of enabling the terminal to keep the first code image from being used again for payment.

Also, the second embodiment shows a configuration in which, if the communication state is the offline state, the controller 21 performs authentication based on the offline duration (a non-limiting example of a duration of a state where the communication amount is smaller than the set communication amount).

In this configuration, if the communication state of the terminal is such that the communication amount of the terminal is smaller than the set communication amount, the terminal performs authentication based on the duration of the state where the communication amount is smaller than the set communication amount, and therefore this configuration has an effect of enabling the terminal to enhance security of payment.

Also, in the second embodiment, the terminal 20 displays a terminal display code image (a non-limiting example of the first code image) that is based on a terminal display code, in the display 24. The payment-related setting includes a setting regarding a code use time limit of the terminal display code image (a non-limiting example of the period of validity of the first code image).

This configuration has an effect of enabling the terminal to control the setting regarding the period of validity of the first code image displayed in the display region.

### Second Variation (1)

The terminal 20 may control the payment-related settings based on the communication state of the terminal and reliability of the store.

In this case, a store reliability score is calculated or determined by the server 10 as an index value that indicates reliability of the store, for example, without limitation thereto.

The store reliability score is a numerical value, a rank, or the like that represents a social reliability of the store, and is calculated or determined based on the number of times or frequency of payments made in the store, solvency of the store, or credit information regarding the store, for example, without limitation thereto.

The store reliability score can be calculated or determined as a score from “0” to “100”, for example, without limitation thereto, where “100” indicates the highest reliability and “0” indicates the lowest reliability.

Note that the “store reliability score” may be simply referred to as a “store score”.

In this case, the “store score” does not necessarily have to be based on reliability of the store, and may be a numerical value (score), a rank, or the like with which the store is rated based on some evaluation criteria such as popularity, name recognition, or the rate of use of the store, for example, without limitation thereto.

The store reliability score calculated or determined by the server 10 can be transmitted to the terminal 20 periodically or at specific timings, for example, without limitation thereto. In this case, the terminal 20 stores or updates the store reliability score transmitted from the server 10 in the store data 2833.

FIG. 5I is a diagram showing an example data structure of third payment-related setting control data 2837B, which is an example of the payment-related setting control data 2837 in this variation.

A setting type, a control target, a communication state, a store reliability score, control content, and apply control: Yes/No are stored in association with each other in the third payment-related setting control data 2837B.

“Store” is set as the setting type, for example, without limitation thereto.

“Payment” that indicates whether or not payment can be made in the store is set as the control target, for example, without limitation thereto.

In this example, with respect to the “online” communication state of the terminal 20, “payment can be made” is set as the control content, irrespective of the store reliability score.

On the other hand, with respect to the “offline” communication state of the terminal 20, “payment can be made” is set as the control content corresponding to a store reliability score of “80 or more”, and “payment cannot be made” is set as the control content corresponding to a store reliability score “less than 80”.

This means that when the terminal 20 is in the offline state, payment can be made in a store that has a store reliability score of “80 or more”, but payment cannot be made in a store that has a store reliability score “less than 80”.

In this case, the controller 21 determines the communication state of the terminal 20 upon detecting a code operation performed by the user of the terminal 20, for example, without limitation thereto. Also, the controller 21 calculates the position of the terminal (hereinafter referred to as a “terminal position”) based on a result of detection performed by the position-calculation-information detecting unit 29B, and determines the store in which the terminal is located based on the calculated terminal position and information regarding the location of the store (e.g., position information regarding the store) that is stored in the store data 2833. Then, the controller 21 determines whether or not payment can be made in the store based on the determined communication state and a store reliability score that is stored in association with the determined store in the store data 2833.

However, the terminal 20 may be unable to calculate the position using a satellite positioning system in an environment in which the terminal 20 is in the offline state. Therefore, the controller 21 can calculate the position of the terminal through the inertial navigation operation described above or based on a beacon signal emitted from a beacon installed in the store, for example, without limitation thereto.

Note that the beacon signal can be received if a Bluetooth function is turned ON in the terminal 20, for example, without limitation thereto.

If it is determined that “payment cannot be made”, the controller 21 avoids displaying a code display screen in the display 24 or displays a code display screen that includes only an error message in the display 24, to keep the terminal display code image from being read, for example, without limitation thereto.

In this variation, the terminal 20 acquires, by means of the controller 21, information regarding the store to which payment is to be made. Then, the terminal 20 controls, by means of the controller 21, the payment-related setting based on the communication state of the terminal and the store reliability score of the store (a non-limiting example of reliability of the store) to which payment is to be made.

This configuration has an effect of enabling the terminal to appropriately control, by means of the controller, the setting relating to payment based on the communication state of the terminal and reliability of the store to which payment is to be made.

### Second Variation (2)

The terminal 20 may control the payment-related setting based on the communication state of the terminal and reliability of the user of the terminal.

In this case, a user reliability score is calculated or determined by the server 10 as an index value that indicates reliability of the user of the terminal 20, for example, without limitation thereto.

The user reliability score is a numerical value, a rank, or the like that represents social reliability of the user of the terminal 20, and is calculated or determined based on past records of payment that has been made by the user, the user's age, work style, annual income, or the like.

The user reliability score can be calculated or determined as a score from “0” to “100”, for example, without limitation thereto, where “100” indicates the highest reliability and “0” indicates the lowest reliability.

Note that the “user reliability score” may be simply referred to as a “user score”.

Also, in this case, the “user score” does not necessarily have to be based on reliability of the user, and may be a numerical value (score), a rank, or the like with which the user of the terminal 20 is rated based on some evaluation criteria such as an amount paid by the user irrespective of the communication state, an amount paid by the user in the offline state, the number of times or frequency of the user making payments using codes irrespective of the communication state, or the number of times or frequency of the user making payments using codes in the offline state, for example, without limitation thereto.

The user reliability score calculated or determined by the server 10 can be transmitted to the terminal 20 periodically or at specific timings. In this case, the terminal 20 stores or updates the user reliability score transmitted from the server 10 in the payment data 2832.

FIG. 5J is a diagram showing an example data structure of fourth payment-related setting control data 2837C, which is an example of the payment-related setting control data 2837 in this variation.

A setting type, a control target, a communication state, a user reliability score, control content, and apply control: Yes/No are stored in association with each other in the fourth payment-related setting control data 2837C.

In this example, the setting type “amount usable for payment” and the control target “maximum usable amount per day” described above are shown, and with respect to the “online” communication state of the terminal 20, “100,000 yen” is set as the control content corresponding to a user reliability score of “80 or more”, “70,000 yen” is set as the control content corresponding to a user reliability score of “60 or more and less than 80”, and “50,000 yen” is set as the control content corresponding to a user reliability score “less than 60”.

On the other hand, with respect to the “offline” communication state of the terminal 20, “30,000 yen” is set as the control content corresponding to a user reliability score of “80 or more”, “20,000 yen” is set as the control content corresponding to a user reliability score of “60 or more and less than 80”, and “10,000 yen” is set as the control content corresponding to a user reliability score “less than 60”.

With respect to both the “online” communication state and the “offline” communication state, the maximum usable amount per day is set to be larger the higher the user reliability score is.

Also, the maximum usable amount per day is set to be larger in the “online” communication state, when compared to the “offline” communication state.

In this case, the controller 21 determines the communication state of the terminal 20 upon detecting a code operation performed by the user of the terminal 20, for example, without limitation thereto. Also, the controller 21 determines the user reliability score by referring to the payment data 2832.

Then, the controller 21 sets the maximum usable amount per day based on the determined communication state and the determined user reliability score.

Although an example has been described in which the maximum usable amount per day is controlled, there is no limitation thereto.

With respect to the types of setting “authentication” and “time limit” shown in FIG. 5D as well, control content can be similarly set based on the user reliability score and the communication state.

Specifically, with respect to the authentication A (to-be-paid amount) shown in FIG. 5D, the to-be-paid amount that is used as the threshold for determining whether or not to perform authentication can be set to be higher the higher the user reliability score is, to make authentication less likely to be performed, for example, without limitation thereto. In this case, the to-be-paid amount can be set to be higher in the “online” communication state, when compared to the “offline” communication state.

Also, the authentication B (code hiding) shown in FIG. 5D can be set so as not to be executed even in the offline state if the user reliability score is higher than or equal to a predetermined score, for example, without limitation thereto.

Also, in a case where authentication is performed when a terminal display code has been hidden a set number of times or more (or more than the set number of times) in the offline state as described above, the set number of times can be set to be larger the higher the user reliability score is, to make authentication less likely to be performed.

Also, with respect to the authentication C (offline duration) shown in FIG. 5D, the offline duration that is used as the threshold for determining whether or not to perform authentication can be set to be longer the higher the user reliability score is, to make authentication less likely to be performed, for example, without limitation thereto. In this case, the offline duration can be set to be longer in the “online” communication state, when compared to the “offline” communication state.

Also, with respect to the code use period (code use time limit) shown in FIG. 5D, the code use period can be set to be longer the higher the user reliability score is, to make the code use time limit longer, for example, without limitation thereto. In this case, the code use period can be set to be longer in the “online” communication state, when compared to the “offline” communication state.

### Third Embodiment

A third embodiment is an embodiment relating to a user interface (UI) for hiding a code (code image) in the embodiments described above.

As described above, the terminal 20 can receive the terminal payment completion notification from the server 10 in the online state. Therefore, the terminal 20 can hide a code (code image) upon receiving the terminal payment completion notification from the server 10, for example, without limitation thereto.

In contrast, the terminal 20 cannot receive the terminal payment completion notification from the server 10 in the offline state. Therefore, if the offline state continues for a while, the terminal may miss a timing to hide a displayed code (code image).

Matter described in the third embodiment can also be applied to other embodiments and variations.

Constitutional elements that are the same as those already described are denoted with the same reference numerals as those used for corresponding elements, and a redundant description thereof is omitted.

### Configuration

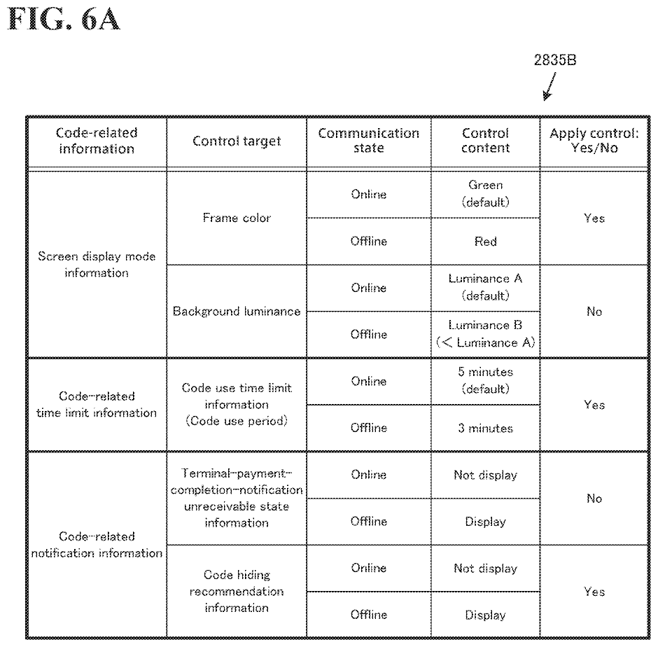

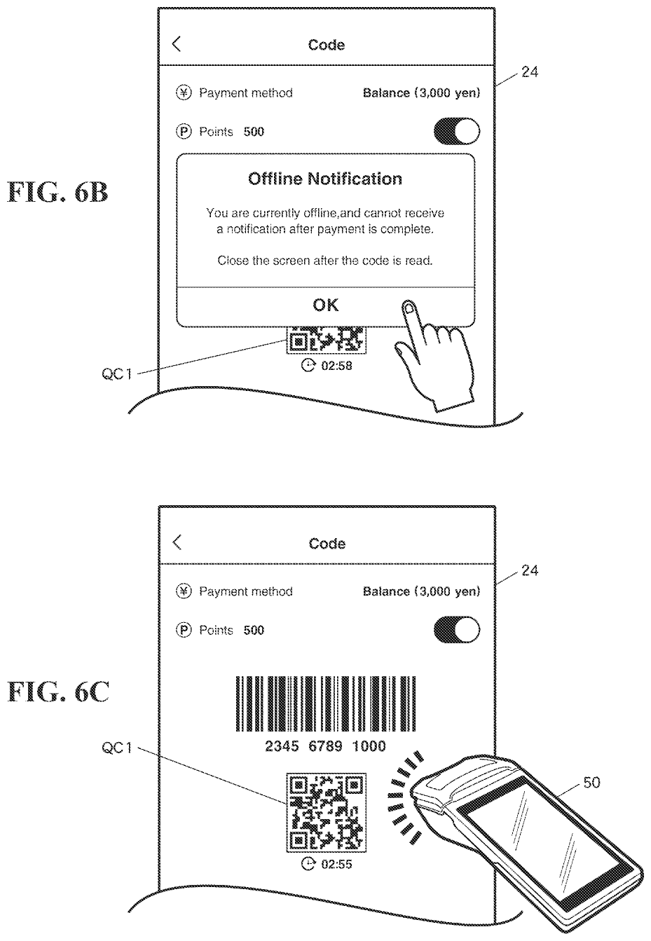

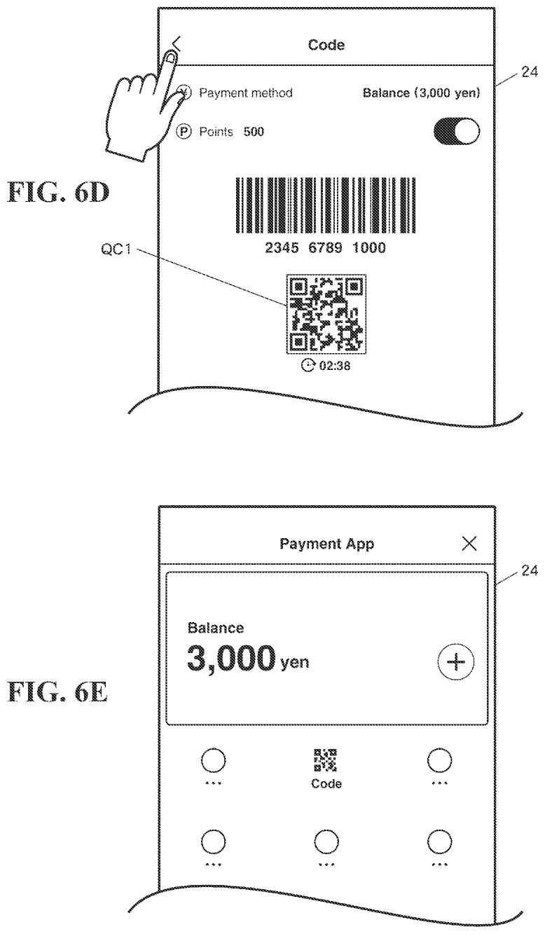

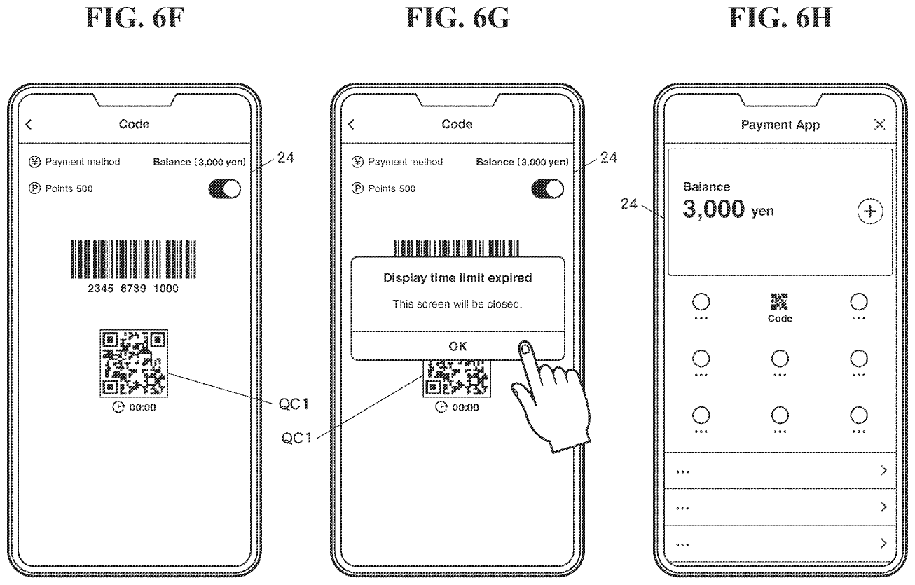

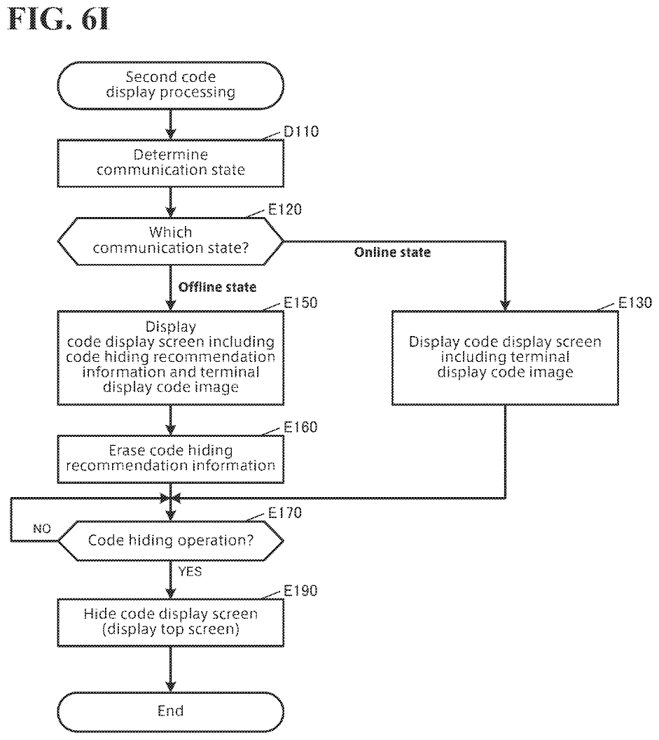

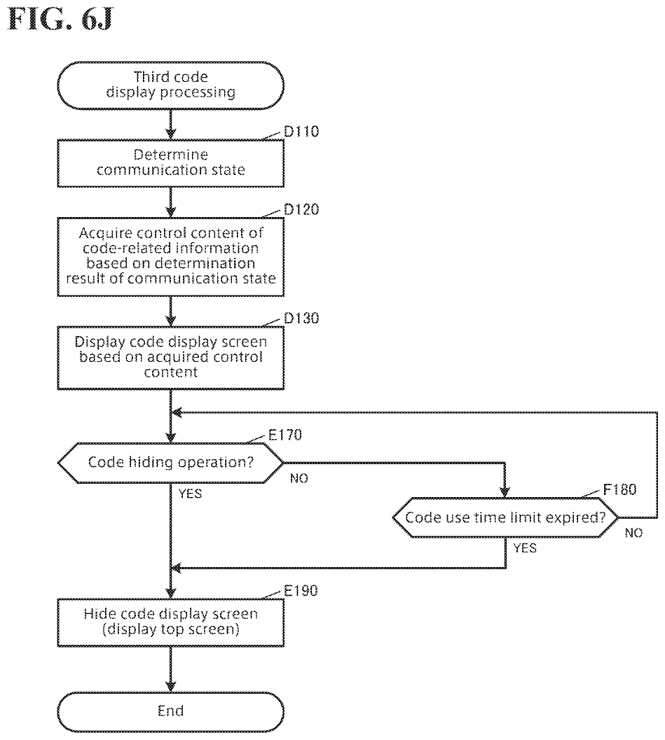

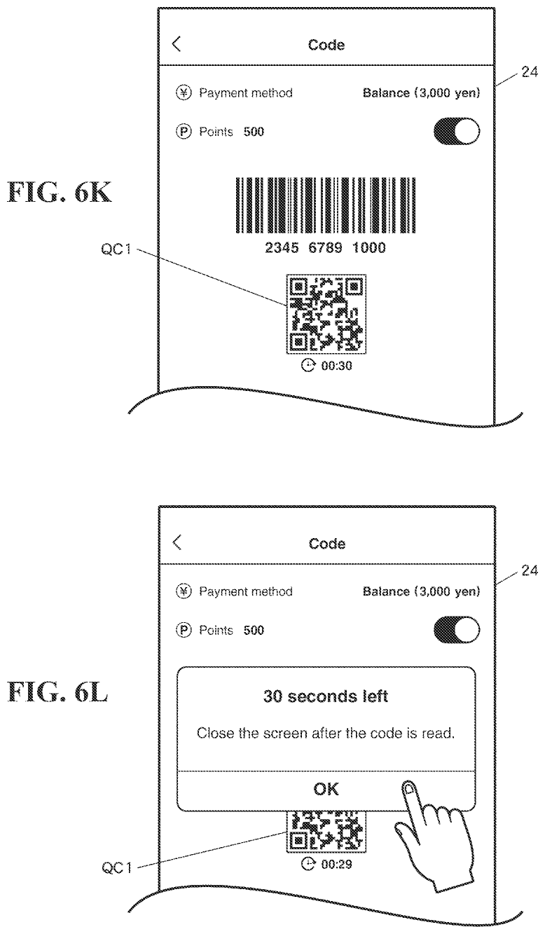

FIG. 6A is a diagram showing an example structure of second code-related information display control data 2835B, which is an example of code-related information display control data 2835 stored in the storage 28 of the terminal 20 in the present embodiment.

Although the data structure of the second code-related information display control data 2835B is similar to that of the first code-related information display control data 2835A, in this example, “code hiding recommendation information” is set as a control target with respect to the code-related information “code-related notification information”, in addition to the “terminal-payment-completion-notification unreceivable state information”.

The code hiding recommendation information is information that recommends the user of the terminal 20 (urges the user of the terminal 20) to manually hide a terminal display code image (code display screen) displayed in the display 24.

With respect to the control target “code hiding recommendation information”, “not display” is set as the control content corresponding to the communication state “online”, and “display” is set as the control content corresponding to the communication state “offline”.

This means that when the terminal 20 is in the online state, the code hiding recommendation information is not displayed, and when the terminal 20 is in the offline state, the code hiding recommendation information is displayed.

In the online state, the controller 21 performs control to hide the code display screen upon receiving the terminal payment completion notification from the server 10, for example, without limitation thereto. However, in the offline state, the terminal payment completion notification cannot be received from the server 10, and the controller 21 cannot automatically hide the code display screen, and therefore a notification is given to the user to manually hide the code display screen.

### Display Screen Examples

FIG. 6B is a diagram showing an example of the code display screen in the present embodiment.

This code display screen is displayed in the offline state, and a pop-up message “Offline Notification You are currently offline, and cannot receive a notification after payment is complete. Close the screen after the code is read” is displayed as an example of the code hiding recommendation information.

Also, an “OK” icon is displayed for the user to approve the content of this notification.

Based on the display, the user of the terminal 20 presents the terminal display code image displayed in the code display screen so as to be read by the store code reader device 50 as shown in FIG. 6C, for example, and then touches a “return button” that is displayed at the upper left of the code display screen as shown in FIG. 6D, for example, to return to a previous screen (in this embodiment, the top screen of the payment application). As a result, the code display screen is hidden, and the top screen of the payment application is displayed as shown in FIG. 6E, for example.

The “return button” is an example of an operation image to hide the code image, and can also be referred to as a “close button”.

FIGS. 6F to 6H are diagrams showing another example of the code display screen in the present embodiment. Display screens are presented to a user in the order of FIGS. 6F, 6G, and 6H.

This code display screen is an example of the code display screen that is displayed in the offline state, and shows a state where the remaining time of the code use time limit is “0 seconds”.

In this example, upon the remaining time of the code use time limit becoming “0 seconds”, a pop-up message “Display time limit expired. This screen will be closed” is displayed as an example of information indicating that the code use time limit has expired and the code will be hidden.

Also, an “OK” icon is displayed for the user to approve the content of this notification, and when the “OK” icon is touched by the user, the code display screen is hidden and the top screen of the payment application is displayed.

Note that the code display screen may be hidden upon the remaining time of the code use time limit becoming “0 seconds”, without the message and the like being displayed.

### Processing

### First Processing

The controller 21 performs the first code display processing shown in FIG. 4R as first processing.

If it is determined that the communication state is the offline state, and “Yes” is set as information indicating whether or not to apply control with respect to the code hiding recommendation information in the second code-related information display control data 2835B, the controller 21 displays the code display screen shown in FIG. 6B, for example, in the display 24.

### Second Processing

The controller 21 can execute second code display processing shown in FIG. 6I as second processing.

Note that the same steps as those shown in the flowcharts already described are denoted with the same reference numerals as those used for corresponding steps, and a redundant description thereof is omitted.

After operation D110, if the communication state is determined as being the online state (operation E120: online state), the code display processing unit 2113 displays a code display screen that includes a terminal display code image in the display 24 (operation E130).

Then, the code display processing unit 2113 determines whether or not an operation for hiding the code (hereinafter referred to as a “code hiding operation”) has been detected (operation E170). If the code hiding operation has not been detected (operation E170: NO), the code display processing unit 2113 waits in this state.

On the other hand, if the code hiding operation is detected (operation E170: YES), the code display processing unit 2113 performs control to hide the displayed code display screen, and displays the top screen of the payment application, for example (operation E190). Then, the code display processing unit 2113 ends the second code display processing.

On the other hand, if the communication state is determined as being the offline state (operation E120: offline state), the code display processing unit 2113 (code-related information display controller 2115) displays a code display screen (e.g., the code display screen shown in FIG. 6B) that includes code hiding recommendation information and a terminal display code image in the display 24 (operation E150).

Thereafter, the code-related information display controller 2115 erases the displayed code hiding recommendation information upon conditions for erasing the code hiding recommendation information being satisfied, for example, without limitation thereto (operation E160). Then, the code display processing unit 2113 proceeds to operation E170.

### Third Processing

The controller 21 can execute third code display processing shown in FIG. 6J as third processing.

Note that the same steps as those shown in the flowcharts already described are denoted with the same reference numerals as those used for corresponding steps, and a redundant description thereof is omitted.

This processing includes operations E170, F180, and E190 in addition to the processing shown in FIG. 4R.

After operation D130, the code display processing unit 2113 determines whether or not the code hiding operation has been detected (operation E170). If the code hiding operation has been detected (operation E170: YES), the code display processing unit 2113 proceeds to operation E190.

On the other hand, if the code hiding operation has not been detected (operation E170: NO), the code display processing unit 2113 determines whether or not the code use time limit has expired (operation F180).

Here, the code use period can be set to be shorter in the offline state than in the online state (e.g., “5 minutes” in the online state and “3 minutes” in the offline state), similarly to the first embodiment. In this case, the offline code use time limit is shorter than the online code use time limit.

Upon determining that the code use time limit has not expired (operation F180: NO), the code display processing unit 2113 returns to operation E170.

On the other hand, upon determining that the code use time limit has expired (operation F180: YES), the code display processing unit 2113 proceeds to operation E190. That is, upon determining that the code use time limit has expired, the controller 21 performs control to hide the code display screen.

In this processing, the code image is hidden by hiding the code display screen based on expiration of the code use time limit. Therefore, the code use time limit can also be referred to as a time limit (code display time limit) of displaying the code.

Note that the code image may be hidden by erasing the code image from the code display screen while continuously displaying the code display screen, rather than hiding the code display screen to hide the code image upon the code use time limit expiring.

Also, the code hiding recommendation information may be displayed only when the communication state is determined as being the offline state, or may be displayed irrespective of the communication state (online state/offline state) of the terminal 20.

### Effects of Third Embodiment

The third embodiment shows a configuration in which the controller 21 of the terminal 20 executes control to hide the terminal display code image when the offline code use time limit has expired.

This configuration has an effect of enabling the terminal to hide the first code image from the display region based on expiration of the second period of validity.

Also, the third embodiment shows a configuration in which the code-related information includes code hiding recommendation information (a non-limiting example of a notification regarding hiding of the first code image).

This configuration has an effect of enabling the terminal to give the notification regarding hiding of the first code image.

Also, the third embodiment shows a configuration in which the code hiding recommendation information is displayed if the communication state of the terminal 20 is the offline state (a non-limiting example of a state where the communication amount of the terminal is smaller than a set communication amount).

This configuration has an effect of enabling the terminal to give the notification regarding hiding of the first code image if the communication amount is smaller than the set communication amount. As a result, the user of the terminal can be prevented from forgetting to hide the first code image when the communication state is poor.

### Third Variation (1)

In the third embodiment, the code hiding recommendation information is displayed when the code display screen is displayed, but there is no limitation thereto.

FIGS. 6k and 6L are diagrams showing an example of the code display screen according to this variation.

This code display screen is an example of the code display screen that is displayed in the offline state, and FIG. 6K shows a state where the remaining time of the code use time limit is “30 seconds”, for example.

Upon the remaining time of the code use time limit becoming “30 seconds”, a pop-up message “30 seconds left. Close the screen after the code is read” is displayed as an example of the code hiding recommendation information as shown in FIG. 6L, for example.

Also, an “OK” icon is displayed for the user to approve the content of this notification.

In this case, even if the user of the terminal 20 forgets to close the code display screen after the code image is read in the store in the offline state, the user can close the code display screen because the code hiding recommendation information is displayed when a predetermined time elapses from when the code display screen is displayed.

Note that the code (code image) may be automatically hidden by performing control to automatically close the code display screen shown in FIG. 6L upon the remaining time of the code use time limit becoming “30 seconds”, for example.

### Third Variation (2)

When the terminal display code image displayed in the code display screen of the terminal 20 is read by the store code reader device 50, the code hiding recommendation information may be displayed in a display that is provided together with the code register 60 as a single unit or is provided separately from the code register 60 and includes a display surface configured to face a customer, for example, without limitation thereto.

Specifically, after transmitting the payment request information to the server 10, the controller 51 of the store code reader device 50 performs control to output, via the POS communication I/F 57 to the code register 60, a signal to instruct the code register 60 to display the code hiding recommendation information, for example.

Upon receiving the signal from the store code reader device 50 via the POS communication I/F 57, the code register 60 displays the code hiding recommendation information in the display.

Specifically, the code register 60 displays a message “Payment is complete. Close the code display screen” in the display, for example, without limitation thereto.

Also, when the terminal display code image displayed in the code display screen of the terminal 20 is read by the store code reader device 50, the store code reader device 50 may transmit information (payment completion information) indicating that payment is complete or the code hiding recommendation information to the terminal 20 through near field communication or the like to hide the code display screen, for example, without limitation thereto.

Also, the payment completion information or the code hiding recommendation information may be transmitted to the terminal 20 from a communication device (e.g., a beacon transmitter) that is installed in the store, rather than from the store code reader device 50, to hide the code display screen.

### Fourth Embodiment

A fourth embodiment is an embodiment relating to processing that is performed when the user of the terminal 20 hides a terminal display code (terminal display code image) by operating a home button or the like, after displaying the terminal display code in the display 24.

Matter described in the fourth embodiment can also be applied to other embodiments and variations.

Constitutional elements that are the same as those already described are denoted with the same reference numerals as those used for corresponding elements, and a redundant description thereof is omitted.

### Display Screen Examples

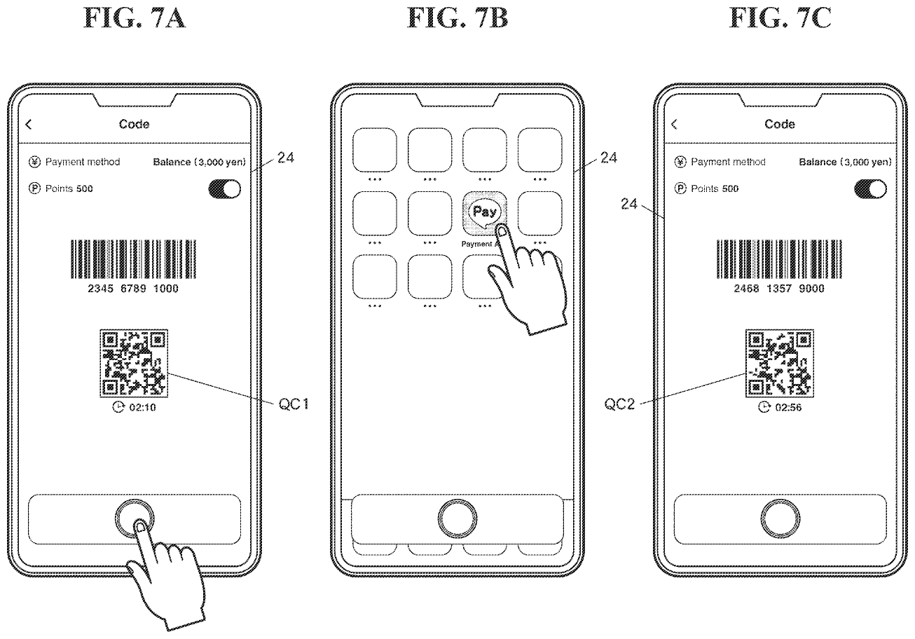

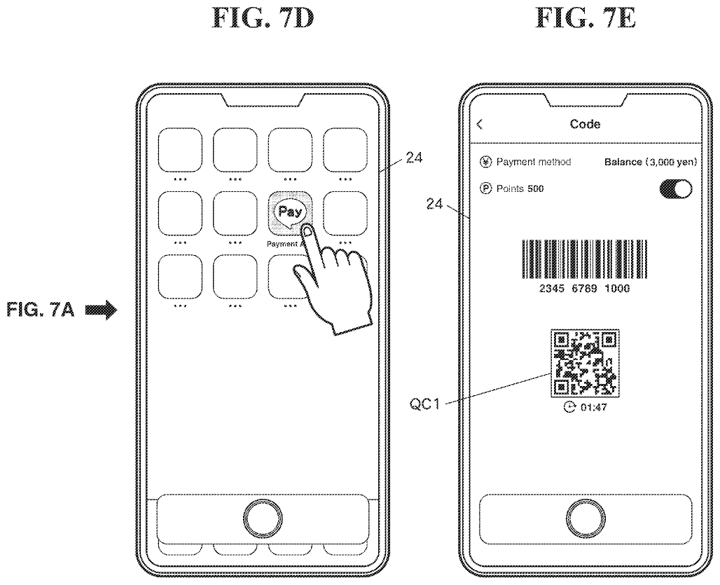

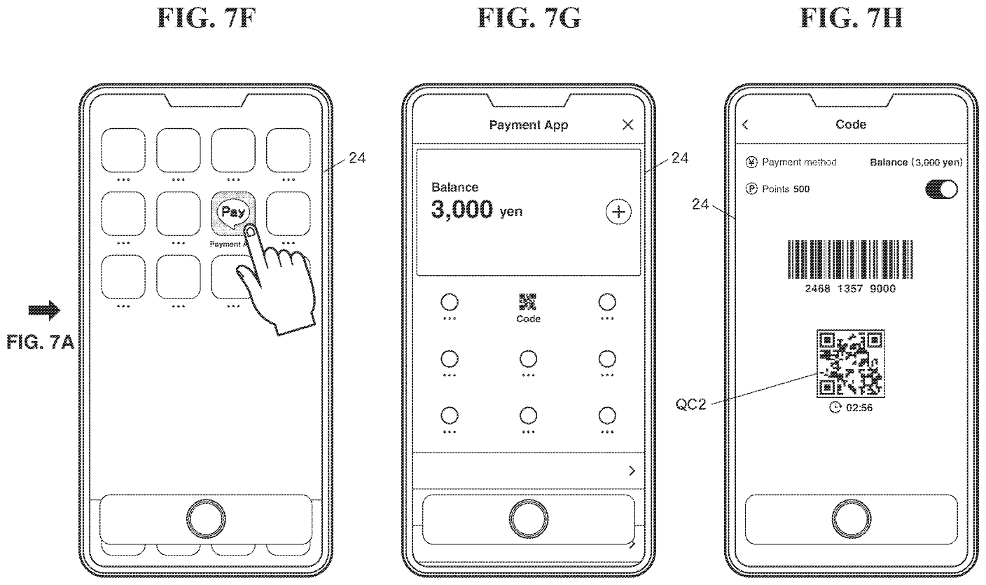

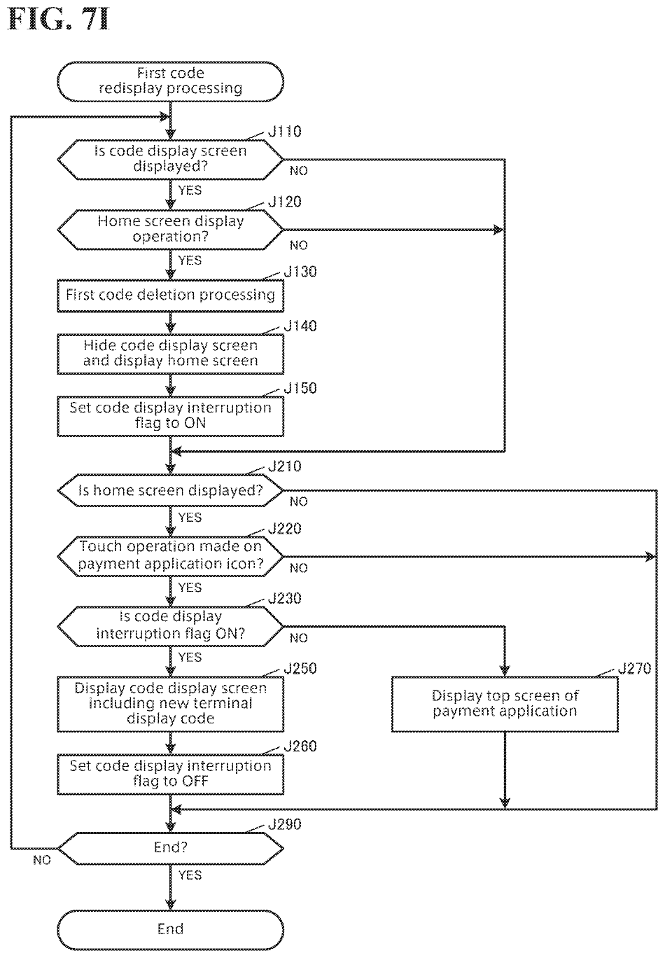

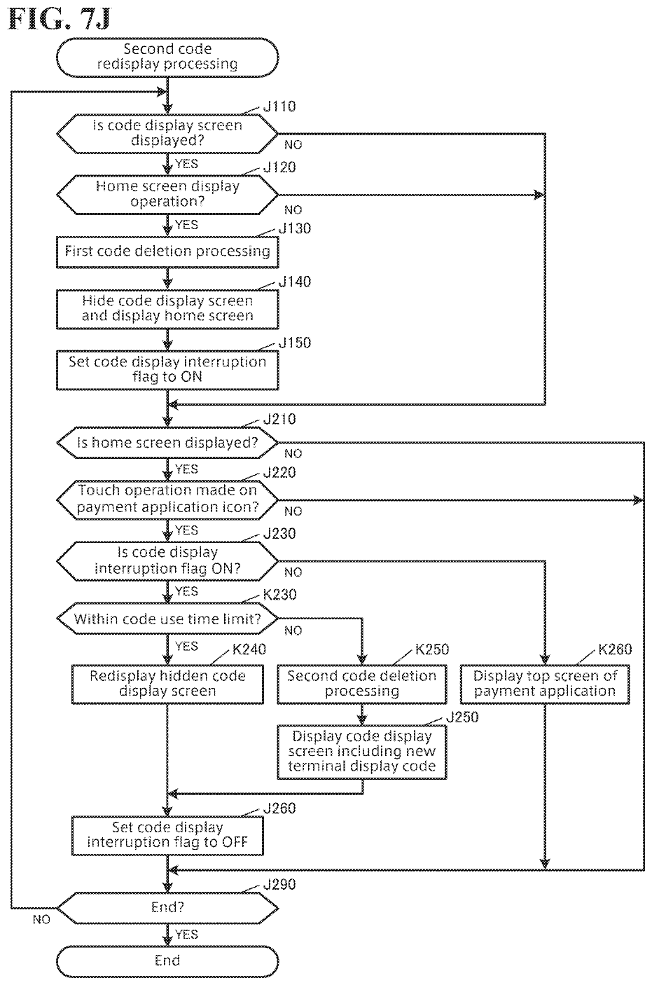

FIGS. 7A-7C are diagrams showing an example of transition of screens displayed in the display 24 of the terminal 20 according to this variation. Display screens are presented to a user in the order of FIGS. 7A, 7B, and 7C.

FIG. 7A shows a state where a code display screen including a two-dimensional terminal display code image QC1 is displayed in the display 24. A “home button” for displaying a home screen of the terminal 20 is displayed in a lower portion of the code display screen.

When the home button is touched by the user of the terminal 20, the home screen of the terminal 20 is displayed as shown in FIG. 7B, for example. As a result of the user of the terminal 20 touching an icon of the payment application (Payment App) out of icons of a plurality of types of application software (a plurality of types of application software stored in the terminal 20) that are displayed in the home screen, the code display screen is again displayed as shown in FIG. 7C. However, a terminal display code image displayed in the code display screen differs from the previously displayed terminal display code image.

Specifically, a terminal display code image that differs from the terminal display code image that had been displayed until the home button was touched is newly displayed. Specifically, data regarding a code that corresponds to the two-dimensional terminal display code image QC1 that had been displayed until the home button was touched is deleted from the terminal-display-code stock data 2831, and a code image or the like that includes a two-dimensional terminal display code image QC2 is displayed in the code display screen, as a code image of another terminal display code that is stored in the terminal-display-code stock data 2831.

FIGS. 7D and 7E are diagrams showing another example of transition of screens displayed in the display 24 of the terminal 20 according to this variation. Display screens may be presented to a user in the order of FIGS. 7A, 7D, and 7E.

This diagram is to be viewed in the same manner as that of FIGS. 7A to 7C, but the code display screen shown in FIG. 7A is omitted.

In this example transition, as a result of the user of the terminal 20 touching the icon of the payment application (Payment App) out of the icons of the plurality of types of application software displayed in the home screen shown in FIG. 7D, a code display screen that includes the terminal display code image QC1 is displayed as shown in FIG. 7E, for example. The code image displayed in the code display screen is the same as the previously displayed code image.

FIGS. 7F to 7H are diagrams showing another example of transition of screens displayed in the display 24 of the terminal 20 according to this variation. Display screens may be presented to a user in the order of FIGS. 7A, 7F, 7G, and 7H. This diagram is to be viewed in the same manner as that of FIGS. 7A to 7C, but the code display screen shown in FIG. 7A is omitted.

In this example transition, as a result of the user of the terminal 20 touching the icon of the payment application (Payment App) out of the icons of the plurality of types of application software displayed in the home screen shown in FIG. 7F, the top screen of the payment application is displayed as shown in FIG. 7G, for example.

Then, as a result of the user of the terminal 20 touching the “code icon” out of the icons displayed in the top screen shown in FIG. 7G, a code display screen including a terminal display code image that differs from the terminal display code image that had been displayed until the home button was touched is displayed as shown in FIG. 7H, for example. Specifically, a code that corresponds to the two-dimensional terminal display code image QC1 that had been displayed until the home button was touched is deleted, and a two-dimensional terminal display code image QC2 is displayed in the code display screen, as a code image of another terminal display code that is stocked in the terminal 20.

### Processing

### First Processing

FIG. 7I is a flowchart showing an example flow of first code redisplay processing that is executed by the controller 21 of the terminal 20 in the present embodiment. This processing is an example of processing for implementing transition of the screens shown in FIGS. 7A to 7C.

The controller 21 determines whether or not a code display screen is displayed in the display 24 (operation J110), and upon determining that the code display screen is displayed (operation J110: YES), determines whether or not an operation (hereinafter referred to as a “home screen display operation”) for displaying the home screen of the terminal 20 has been detected (operation J120).

If the home screen display operation has been detected (J120: YES), the controller 21 performs first code deletion processing (operation J130).

Specifically, the controller 21 deletes code data regarding a terminal display code image displayed in the code display screen from the terminal-display-code stock data 2831, for example, without limitation thereto.

If the communication state of the terminal is the online state, the controller 21 transmits code hiding information that includes an application ID and a code No. of the deleted terminal display code, for example, without limitation thereto, by means of the communication I/F 22 to the server 10. The code hiding information indicates that the terminal display code (terminal display code image) is hidden.

Note that information (hereinafter referred to as “code deletion information”) indicating that the terminal display code has been deleted or information (hereinafter referred to as “code usage information”) indicating that the terminal display code has been used may be transmitted from the terminal 20 to the server 10 instead of the code hiding information.

In this case, the controller 11 of the server 10 deletes code data corresponding to the code No. included in the received code hiding information from code management data corresponding to the application ID included in the code hiding information.

Thereafter, the controller 21 hides the code display screen, and displays the home screen in the display 24 (operation J140). Then, the controller 21 sets a flag (hereinafter referred to as a “code display interruption flag”) indicating that display of the code display screen is interrupted, to “ON” (operation J150).

Then, the controller 21 determines whether or not the home screen is displayed in the display 24 (operation J210), and upon determining that the home screen is displayed (operation J210: YES), determines whether or not a touch operation made on the icon of the payment application software has been detected (operation J220).

If a touch operation made on the icon of the payment application software has been detected (operation J220: YES), the controller 21 determines whether or not the code display interruption flag is set to “ON” (operation J230).

Upon determining that the code display interruption flag is set to “ON” (operation J230: YES), the controller 21 reads data regarding a terminal display code from the terminal-display-code stock data 2831, and displays a code display screen that includes a code image of the terminal display code, in the display 24 (operation J250). Then, the controller 21 sets the code display interruption flag to “OFF” (operation J260).

On the other hand, upon determining that the code display interruption flag is not set to “ON” (operation J230: NO), the controller 21 displays the top screen of the payment application in the display 24, for example (operation J270).

Then, the controller 21 determines whether or not to end the processing (operation J290), and upon determining to continue the processing (operation J290: NO), returns to operation J110. On the other hand, upon determining to end the processing (operation J290: YES), the controller 21 ends the first code redisplay processing.

### Second Processing

FIG. 7J is a flowchart showing an example flow of second code redisplay processing that is executed by the controller 21 of the terminal 20 in the present embodiment. This processing is an example of processing for implementing transition of the screens shown in FIGS. 7D and 7E.

Note that the same steps as those in the processing already described are denoted with the same reference numerals as those used for corresponding steps, and a redundant description thereof is omitted.

Upon detecting the home screen display operation in operation J120 (operation J120: YES), the controller 21 performs the processing in operations J140 and J150.

In this example, the processing in J130 is not performed, unlike the first code redisplay processing shown in FIG. 7I.

Also, in this example, the controller 21 continuously counts, in the background, the remaining time of the code use time limit of the terminal display code that is included in the code display screen hidden in operation J140.

Upon determining that the code display interruption flag is set to “ON” in J230 (J230: YES), the controller 21 determines whether or not the present time is within the code use time limit that is associated with the terminal display code included in the hidden code display screen (i.e., whether or not the code use time limit has not yet expired) (operation K230).

Upon determining that the present time is within the code use time limit (operation K230: YES), the controller 21 again displays the code display screen that was hidden in operation J140, in the display 24 (operation K240). Then, the controller 21 proceeds to operation J260.

On the other hand, upon determining that the present time is not within the code use time limit (operation K230: NO), the controller 21 performs second code deletion processing (operation K250).

Specifically, the controller 21 deletes, from the terminal-display-code stock data 2831, code data regarding the terminal display code image included in the code display screen that was hidden in operation J140, for example, without limitation thereto.

If the communication state of the terminal is the online state, the controller 21 transmits code hiding information that includes an application ID and a code No. of the deleted terminal display code, for example, without limitation thereto, by means of the communication I/F 22 to the server 10.

In this case, the controller 11 of the server 10 deletes code data corresponding to the code No. included in the received code hiding information from code management data corresponding to the application ID included in the code hiding information.

After operation K250, the controller 21 proceeds to operation J250.

Note that, in this example, the controller 21 continuously counts, in the background, the remaining time of the code use time limit of the terminal display code included in the code display screen that has been hidden in operation J140, but there is no limitation thereto.

Specifically, the controller 21 may stop counting the remaining time of the code use time limit after hiding the code display screen in operation J140. In this case, unless the remaining time of the code use time limit is “0 seconds” when the code display screen is hidden in operation J140, it is determined in operation K230 that the present time is within the code use time limit.

### Third Processing

In third processing, the controller 21 displays the top screen of the payment application in the display 24 as shown in FIGS. 7F to 7H, for example, upon determining that the code display interruption flag is set to “ON” in operation J230 of the first code redisplay processing shown in FIG. 7I.

Then, upon detecting the code display operation (e.g., detecting a touch operation made on the “code icon” as shown in FIGS. 7F to 7H) in a state where the top screen is displayed in the display 24, the controller 21 deletes, from the terminal-display-code stock data 2831, code data regarding the terminal display code image included in the code display screen that has been hidden in operation J140. Then, the controller 21 reads data regarding a terminal display code from the terminal-display-code stock data 2831, and displays a code display screen that includes a code image of the terminal display code, in the display 24.

This processing is an example of processing for implementing transition of the screens shown in FIGS. 7F to 7H.

Note that the processing described above is applicable irrespective of the communication state (online state/offline state) of the terminal 20, but setting may be performed by the terminal 20 or the server 10 such that different types of processing are performed according to the communication state of the terminal 20.

Specifically, setting is performed such that the second processing is performed when the communication state of the terminal 20 is the online state, for example, without limitation thereto. In contrast, setting is performed such that either of the first processing and the third processing is performed when the communication state of the terminal 20 is the offline state.

### Fifth Embodiment

A fifth embodiment is an embodiment relating to a method for informing the server 10 that a terminal display code (terminal display code image) is hidden.

As described in the fourth embodiment, if the communication state of the terminal is the online state, information such as the code hiding information can be transmitted from the terminal 20 to the server 10 when a terminal display code (terminal display code image) is hidden.

However, if the communication state of the terminal is the offline state, such information cannot be transmitted to the server 10, and there is a problem in that the server 10 cannot be aware of the fact that the terminal display code (terminal display code image) is hidden in the terminal 20, for example.

Matter described in the fifth embodiment can also be applied to other embodiments and variations.

Constitutional elements that are the same as those already described are denoted with the same reference numerals as those used for corresponding elements, and a redundant description thereof is omitted.

### Processing

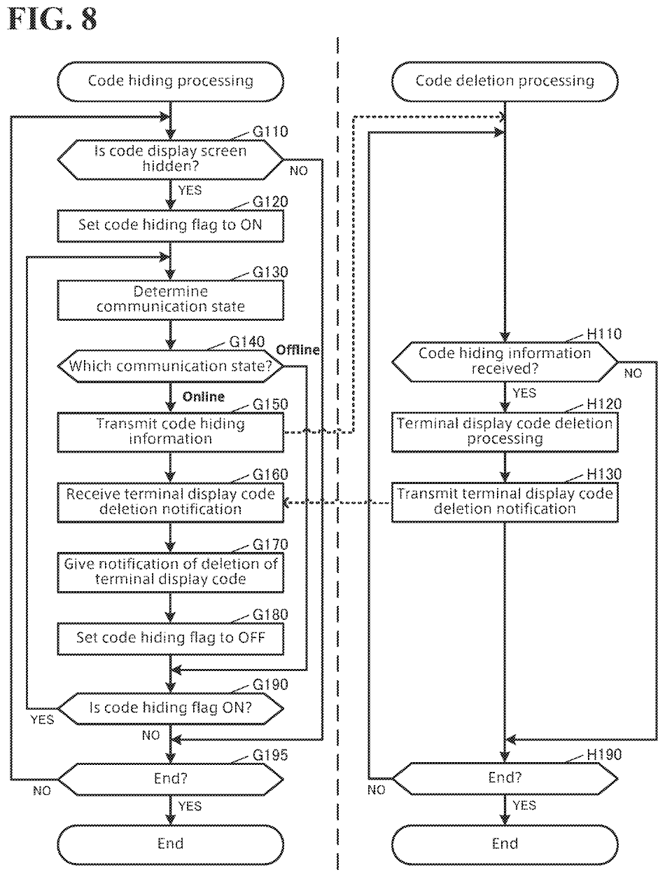

FIG. 8 is a flowchart showing an example flow of processing that is executed by the devices in the present embodiment. Code hiding processing that is executed by the controller 21 of the terminal 20 is shown on the left, and code deletion processing that is executed by the controller 11 of the server 10 is shown on the right.

The code hiding processing and the code deletion processing are respectively executed as sub processing (e.g., executed in the background) of the above-described payment application processing performed by the terminal 20 and the above-described payment management processing performed by the server 10, for example, without limitation thereto.

First, the controller 21 determines whether or not a code display screen is hidden (G110). Upon determining that the code display screen is hidden (operation G110: YES), the controller 21 sets a flag (hereinafter referred to as a “code hiding flag”) that indicates that a code (code image) is hidden, to “ON” (operation G120). Thereafter, the controller 21 determines the communication state of the terminal (operation G130).

If the communication state is determined as being the “offline state” (operation G140: offline state), the controller 21 proceeds to operation G190.

On the other hand, if the communication state is determined as being the “online state” (operation G140: online state), the controller 21 transmits code hiding information that includes an application ID and a code No. of the terminal display code displayed in the hidden code display screen, for example, without limitation thereto, by means of the communication I/F 22 to the server 10 (operation G150).

Upon receiving the code hiding information from the terminal 20 via the communication I/F 14 (operation H110), the controller 11 performs terminal display code deletion processing (operation H120). Specifically, the controller 11 deletes data regarding a terminal display code corresponding to the code No. included in the code hiding information received from the terminal 20, from code management data corresponding to the application ID included in the code hiding information, among code management data stored in the code management database 159, for example, without limitation thereto.

Thereafter, the controller 11 transmits a notification (hereinafter referred to as a “terminal display code deletion notification”) indicating that the terminal display code is deleted, via the communication I/F 14 to the terminal 20 (operation H130).

Upon receiving the terminal display code deletion notification from the server 10 by means of the communication I/F 22 (operation G160), the controller 21 informs the user of the terminal 20 by displaying a message indicating that the terminal display code has been deleted, in the screen of the payment application, for example (operation G170). Note that the processing in operation G170 may be omitted.

Thereafter, the controller 21 sets the code hiding flag to “OFF” (operation G180).

After operation G180 or if the communication state is determined as being the “offline state” (operation G140: offline state), the controller 21 determines whether or not the code hiding flag is set to “ON” (operation G190).

If the code hiding flag is set to “ON” (operation G190: YES), the controller 21 proceeds to operation G130.

In this case, the processing in operations G130 to G190 is looped. Then, when the communication state has changed from the offline state to the online state, the processing in operations G150 to G180 is performed, and the code hiding flag is set to “OFF”.

On the other hand, if the code hiding flag is set to “OFF” (operation G190: NO), the controller 21 makes a determination as to whether or not to end the processing (operation G195). Upon making a determination to continue the processing (operation G195: NO), the controller 21 returns to G110. On the other hand, upon making a determination to end the processing (operation G195: YES), the controller 21 ends the code hiding processing.

Note that in this processing, the code hiding information is transmitted from the terminal 20 to the server 10 when the communication state has changed from the offline state to the online state, but there is no limitation thereto.

Specifically, the code hiding information may also be transmitted from the terminal 20 to the server 10 at a specific timing if a code (code image) is hidden, for example, without limitation thereto. The specific timing may be set to a specific time (e.g., midnight) or a time at which a specific event (e.g., launching of the payment application) occurs.

Also, the terminal 20 may repeatedly transmit the code hiding information to the server 10 until the code hiding information is received by the server 10 and the terminal display code deletion notification is received from the server 10.

Also, if a terminal display code (terminal display code image) is hidden, the controller 21 may also delete code data regarding the hidden terminal display code from the terminal-display-code stock data 2831, similarly to the fourth embodiment, irrespective of whether the communication state is the online state or the offline state.

In this case, the controller 21 can transmit information such as the code hiding information, the code deletion information, or the code usage information to the server 10 upon deleting the terminal display code.

### Effects of Fifth Embodiment

In the fifth embodiment, the terminal 20 executes control, by means of the controller 21, to hide a code image (a non-limiting example of the first code image) of a stocked terminal display code from the display 24. In this case, the terminal 20 transmits code hiding information (a non-limiting example of third information indicating that the first code image is hidden from the display region) via the communication I/F 22 to the server 10.

This configuration has an effect of enabling the terminal to inform the server that the first code image is hidden from the display region.

Also, the fifth embodiment shows a configuration in which the code hiding information is transmitted via the communication I/F 22 to the server 10 based on the communication state of the terminal 20.

This configuration has an effect of enabling the terminal to inform the server that the first code image is hidden from the display region when the terminal can communicate with the server, for example.

Also, the fifth embodiment shows a configuration in which the code hiding information is transmitted via the communication I/F 22 to the server 10 at a timing (a non-limiting example of a set timing) at which the communication state has changed from the offline state to the online state.

This configuration has an effect of enabling the terminal to inform the server that the first code image is hidden from the display region, at the set timing.

### Fifth Variation

In the fifth embodiment, if the controller 21 of the terminal 20 has determined that the communication state is the offline state, the controller 21 may execute control to delete data regarding a terminal display code that has been displayed from the terminal-display-code stock data 2831, upon the code display screen being hidden, for example, without limitation thereto.

This control is an example of control to deactivate a code included in a code image, so as to make the code image unusable.

Note that the control described above is merely an example and there is no limitation thereto.

Data regarding the terminal display code does not necessarily have to be deleted from the terminal 20, and control to disable redisplay (control to prohibit redisplay) of the terminal display code may also be executed without deleting the data regarding the hidden terminal display code from the terminal 20.

In this case, a flag indicating “unusable” or “not allowed to be redisplayed” is stored in association with the hidden terminal display code in the terminal-display-code stock data 2831, for example, without limitation thereto. The terminal display code for which such a flag is set can be kept from being redisplayed.

If the controller 21 has determined that the communication state is the offline state, and a code display screen is hidden within the code use time limit, the hidden code display screen including a terminal display code is redisplayed in the display 24 in response to a code display operation made by the user of the terminal 20.

In contrast, if the communication state is determined as being the offline state and a code display screen is hidden based on expiration of the code use time limit, deactivation of the code image to make the code image unusable may be executed as described above.

Also, if the controller 21 has determined that the communication state is the offline state and has hidden a code display screen, a terminal display code that differs from the hidden terminal display code may be selected from the terminal-display-code stock data 2831 in response to a code display operation made by the user of the terminal 20, and a code display screen including a code image of the selected terminal display code may be displayed in the display 24.

According to this variation, if the communication state is such that the communication amount of the terminal is smaller than a set communication amount, the terminal can execute control, by means of the controller, to make the first code image unusable upon the first code image being hidden from the display region, so that the first code image that has been displayed and then hidden cannot be used for payment.

Also, according to this variation, if the communication state is such that the communication amount of the terminal is smaller than a set communication amount and the period of validity of the first code image has not expired, the terminal can hide the first code image from the display region and thereafter display the first code image in the display region based on input that is made to the terminal by the user of the terminal, so that the first code image that has been displayed and then hidden can be used for payment.

In contrast, if the communication state is such that the communication amount of the terminal is smaller than the set communication amount and the period of validity has expired, the controller may deactivate the first code image to make the first code image unusable, so that the first code image that was displayed and then hidden cannot be used for payment.

Also, according to this variation, if the communication state is such that the communication amount of the terminal is smaller than the set communication amount, the terminal can hide the first code image from the display region and thereafter display a second code image different from the first code image based on input that is made to the terminal by the user of the terminal, so that a code image different from the hidden code image can be used for payment.

### Sixth Embodiment

A sixth embodiment is an embodiment relating to supplementation of terminal display codes stocked in the terminal 20 and a user interface for the supplementation.

Matter described in the sixth embodiment can also be applied to other embodiments and variations.

Constitutional elements that are the same as those already described are denoted with the same reference numerals as those used for corresponding elements, and a redundant description thereof is omitted.

### Processing

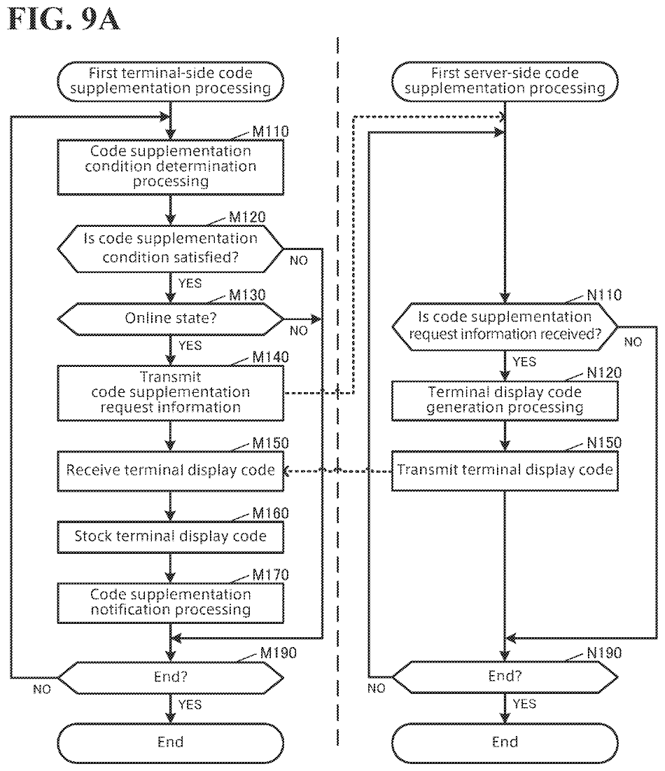

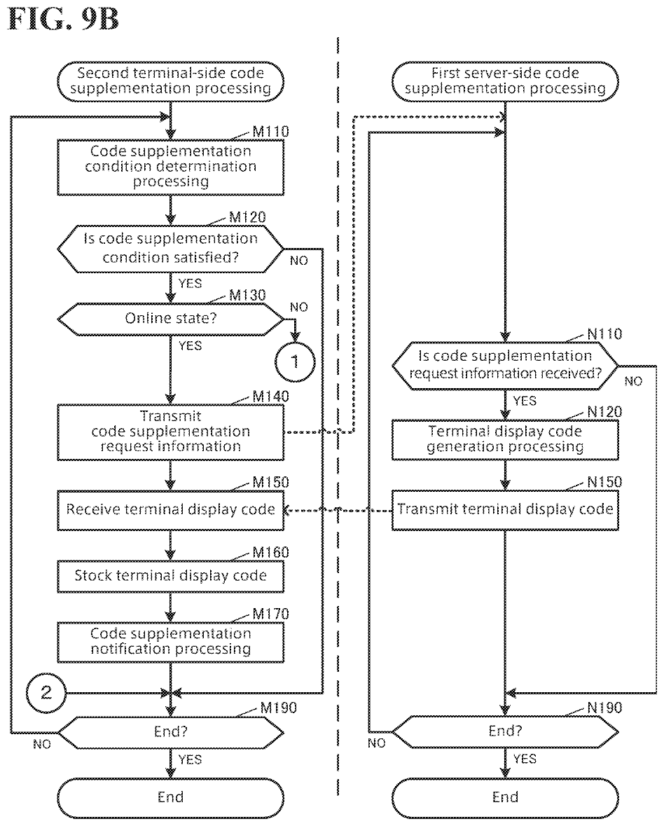

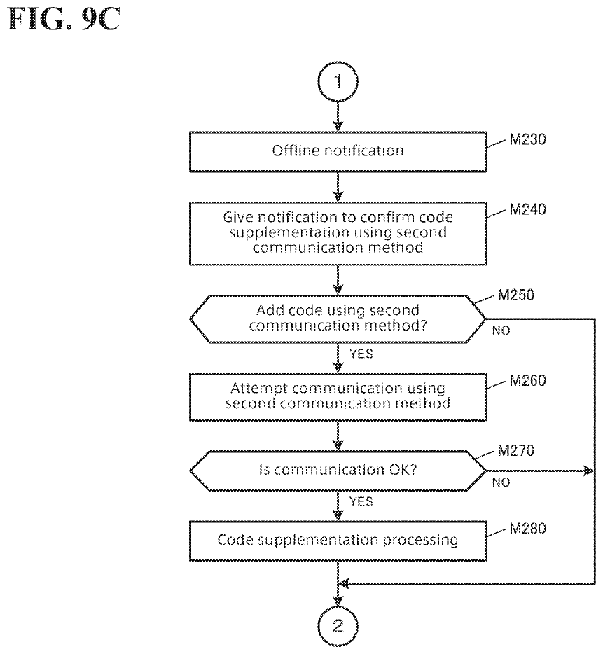

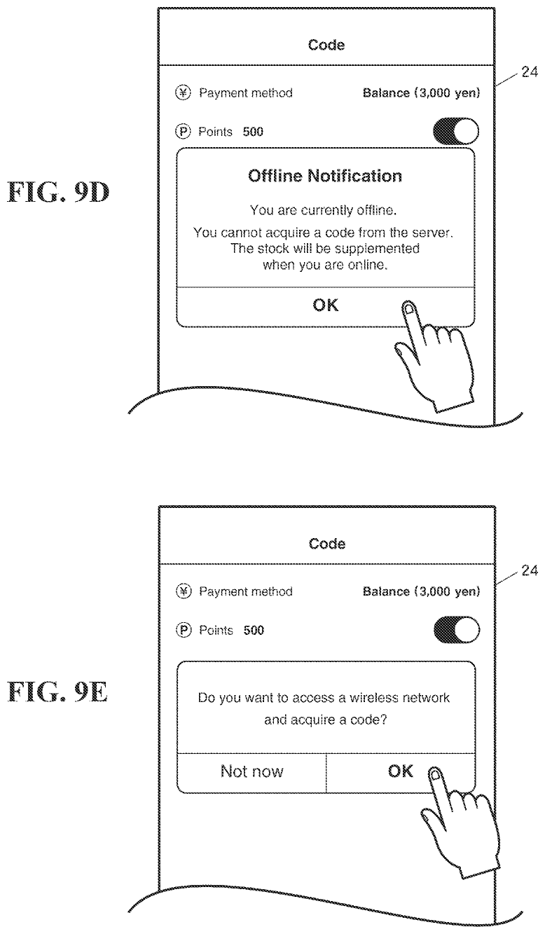

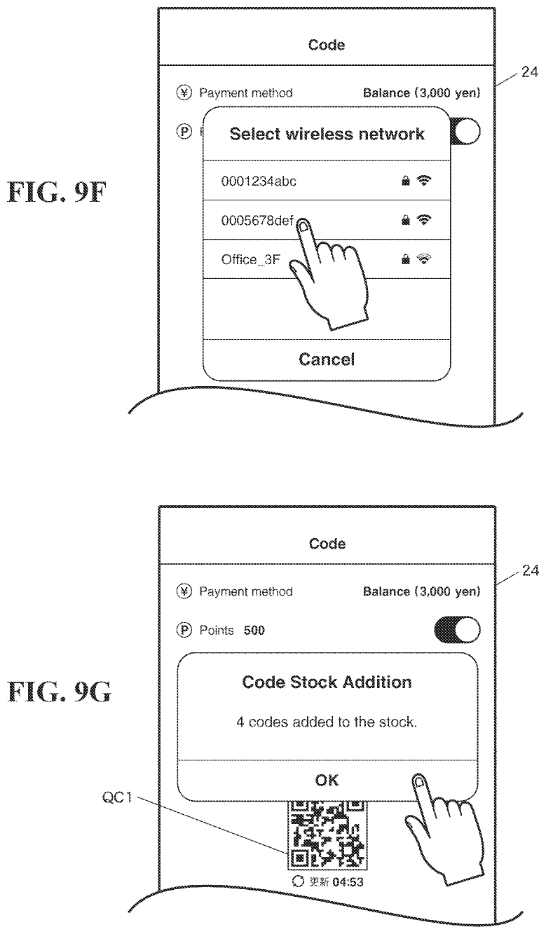

FIG. 9A is a flowchart showing an example flow of processing that is executed by the devices in the present embodiment. First terminal-side code supplementation processing that is executed by the controller 21 of the terminal 20 is shown on the left, and first server-side code supplementation processing that is executed by the controller 11 of the server 10 is shown on the right.

The first terminal-side code supplementation processing and the first server-side code supplementation processing are respectively executed as sub processing (e.g., executed in the background) of the above-described payment application processing performed by the terminal 20 and the above-described payment management processing performed by the server 10, for example, without limitation thereto.

First, the controller 21 performs code supplementation condition determination processing (operation M110). The following conditions can be set as code supplementation conditions, for example.

(1) A code supplementation operation is detected.

(2) An electromagnetic wave environment (communication environment) of the terminal has changed.

(3) A code update timing or a code update time has been reached.

The condition (1) is a condition indicating that a code is added when an operation (hereinafter referred to as a “code supplementation operation”) for adding a code that is made by the user of the terminal 20 is detected.

The condition (2) is a condition indicating that a code is added when the electromagnetic wave environment (communication environment) of the terminal 20 has changed. Note that radio waves are commonly used for communication, and accordingly a code may also be added based on a change in a radio wave environment, rather than a change in the electromagnetic wave environment.

When it is detected that the electromagnetic wave environment of the terminal 20 has changed from a “medium electromagnetic wave environment” to a “weak electromagnetic wave environment” based on the intensity of electromagnetic waves, for example, without limitation thereto, the terminal may enter the offline state, and accordingly a terminal display code can be added.

The condition (3) is a condition indicating that a code is added periodically (e.g., every 12 hours or every 24 hours) or at a specific time (e.g., midnight).

In operation M110, the controller 21 determines whether or not at least one of the code supplementation conditions described above is satisfied, for example, without limitation thereto.

Note that the code supplementation conditions described above are merely examples, and other conditions may also be set.

Also, a combination of two or more of the code supplementation conditions described above may also be set as a code supplementation condition, for example, without limitation thereto.

Also, which of the code supplementation conditions described above is to be applied may also be selected and set by the user of the terminal 20, for example, without limitation thereto.

Upon determining that a code supplementation condition is satisfied (operation M120: YES), the controller 21 determines whether or not the communication state is the online state (operation M130). Upon determining that the communication state is the online state (operation M130: YES), the controller 21 transmits code supplementation request information that includes at least an application ID, for example, without limitation thereto, by means of the communication I/F 22 to the server 10 (operation M140).

Note that the code generation request information described above may be transmitted from the terminal 20 to the server 10 instead of the code supplementation request information.

The controller 11 of the server 10 determines whether or not the code supplementation request information has been received from the terminal 20 (operation N110). Upon determining that the code supplementation request information has been received (operation N110: YES), the controller 11 performs terminal display code generation processing (operation N120). Then, the controller 11 transmits the generated terminal display code by means of the communication I/F 14 to the terminal 20 (operation N150).

Thereafter, the controller 11 makes a determination as whether or not to end the processing (operation N190), and upon making a determination to continue the processing (operation N190: NO), returns to N110. Upon making a determination to end the processing (operation N190: YES), the controller 11 ends the first server-side code supplementation processing.

If no code supplementation request information has been received from the terminal 20 (operation N110: NO), the controller 11 proceeds to operation N190.

Upon receiving the terminal display code from the server 10 by means of the communication I/F 22 (operation M150), the controller 21 adds and stores the received terminal display code in the terminal-display-code stock data 2831 (operation M160).

Thereafter, the controller 21 performs code supplementation notification processing (operation M170). In the code supplementation notification processing, processing is performed to display information (hereinafter referred to as “code supplementation notification information”) indicating that the stock of terminal display codes has been supplemented, in the display 24.

Specifically, if the payment application is not being executed, the code supplementation notification information is displayed in the display 24 using a push notification that is associated with the payment application, for example, without limitation thereto.

On the other hand, if the payment application is being executed, the code supplementation notification information is displayed in the screen (e.g., the code display screen) of the payment application.

Thereafter, the controller 21 makes a determination as to whether or not to end the processing (operation M190), and upon making a determination to continue the processing (M190: NO), returns to M110. Upon making a determination to end the processing (operation N190: YES), the controller 21 ends the first terminal-side code supplementation processing.

If it is determined that the code supplementation conditions are not satisfied (M120: NO), or it is determined that the communication state is not the online state (M130: NO), the controller 21 proceeds to M190.

Note that the code supplementation request information may be information that requests addition of a terminal display code, but may also be information that requests addition of a plurality of (two or more) terminal display codes. Specifically, in the terminal 20 or the server 10, an upper limit is set for the number of codes for which the terminal 20 requests the addition of at a time (or the number of codes to be generated by the server 10 at a time for addition), for example, without limitation thereto, rather than terminal display codes being added one-by-one. The user of the terminal 20 may add the upper limit number of terminal display codes through a single operation. In this case, the plurality of terminal display codes can be generated by the server 10, the generated terminal display codes can be transmitted to the terminal 20, and the received terminal display codes can be added in the terminal 20.

Also, the following method can be applied as an example of a method for supplementing a stock of terminal display codes in the offline state.

In the following description, a state where the terminal 20 and the server 10 cannot communicate with each other using the first communication method described above will be referred to as the “offline state”. Assume that the terminal 20 can communicate with the server 10 using the second communication method described above.

Processing

FIGS. 9B and 9C are flowcharts that show an example flow of processing that is executed by the devices in the present embodiment. Second terminal-side code supplementation processing that is executed by the controller 21 of the terminal 20 is shown on the left, and the first server-side code supplementation processing that is executed by the controller 11 of the server 10 is shown on the right.

The second terminal-side code supplementation processing and the first server-side code supplementation processing are respectively executed as sub processing (e.g., executed in the background) of the above-described payment application processing performed by the terminal 20 and the above-described payment management processing performed by the server 10, for example, without limitation thereto.

The flowcharts shown in FIGS. 9B and 9C include processing (operations M230 to M280) that is performed in the case of NO in M130, in addition to the processing included in the flowchart shown in FIG. 9A.

Upon determining that the communication state is not the online state in M130 (operation M130: NO), the controller 21 gives an offline notification (operation M230). Specifically, the controller 21 displays, in the display 24, information indicating that communication cannot be performed with the server 10 using the first communication method (offline state), for example, without limitation thereto.

Thereafter, the controller 21 gives a notification to confirm code supplementation using the second communication method (operation M240). Specifically, the controller 21 displays, in the display 24, information for confirming whether or not the user of the terminal 20 has an intention to add a terminal display code using the second communication method, for example, without limitation thereto.

Next, the controller 21 determines whether or not the user of the terminal 20 has made a selection to add a code using the second communication method (operation M250), and upon determining that the user has made a selection to add a code (operation M250: YES), attempts communication using the second communication method (operation M260).

If communication using the second communication method is successful (operation M270: YES), the controller 21 performs code supplementation processing (operation M280). Specifically, the controller 21 transmits the code supplementation request information described above to the server 10, acquires a terminal display code from the server 10, and supplements the terminal-display-code stock data 2831 by storing the terminal display code therein. Then, the controller 21 proceeds to operation M190.

Note that in order to add a code using the second communication method, a search application for searching for places (spots) such as stores and facilities where wireless LAN (e.g., WiFi (registered trademark)), which is an example of the second communication method, can be used is downloaded to the terminal 20 in advance and is stored in the storage 28, as an application that can cooperate with the payment application, for example, without limitation thereto.

If the user of the terminal 20 has made a selection to add a code using the second communication method when the notification to confirm code supplementation using the second communication method is given in operation M240, for example, the controller 21 may launch the search application stored in the terminal 20 and perform processing of searching for spots where the second communication method can be used.

### Display Screen Examples

FIG. 9D is a diagram showing an example of the code display screen in the present embodiment. This code display screen is displayed in operation M230 shown in FIG. 9C, for example, without limitation thereto.

In this code display screen, a pop-up message “Offline Notification You are currently offline and cannot acquire a code from the server. The stock will be supplemented when you are online” is displayed as an example of information indicating that communication cannot be performed with the server 10 using the first communication method and the first information cannot be received from the server. Also, an “OK” icon is displayed to express an intention to approve the content of this notification.

FIG. 9E is a diagram showing an example of a screen that is displayed when the “OK” icon is touched in the code display screen shown in FIG. 9D. This screen is displayed in M240 shown in FIG. 9C, for example, without limitation thereto.

In this screen, as the notification to confirm code supplementation using the second communication method, a pop-up message “Do you want to access a wireless network and acquire a code?” is displayed as an example of information that confirms whether or not the user of the terminal 20 has an intention to add a terminal display code using the second communication method. Also, an “OK” icon is displayed to express an intention to approve the content of this notification, and a “not now” icon is displayed to express an intention not to approve the content of this notification at present.

If the “OK” icon shown in FIG. 9E is touched, a screen is displayed as shown in FIG. 9F, for example.

In this screen, a selection box for selecting a wireless network is displayed at the center of the screen, and the user of the terminal 20 selects a wireless network from candidate wireless networks shown in the selection box.

When a wireless network is selected in FIG. 9F, communication is attempted using the selected wireless network. If the communication is OK, a terminal display code is acquired from the server 10, and a screen shown in FIG. 9G is displayed, for example.

This example shows a case where information that requests addition of four terminal display codes is transmitted as code supplementation request information from the terminal 20 to the server 10, four terminal display codes are generated by the server 10, the generated four terminal display codes are transmitted to the terminal 20, and the received four terminal display codes are added to the stock in the terminal 20, and a pop-up message “Code Stock Addition 4 codes added to the stock” is displayed.

### Effects of Sixth Embodiment

In the sixth embodiment, if the communication state is the offline state, the terminal 20 displays, in the display 24, information indicating that communication cannot be performed by the terminal 20. Based on a touch operation that is made by the user of the terminal 20 (a non-limiting example of input that is made by the user of the terminal) with respect to the information indicating that communication cannot be performed by the terminal 20, the terminal 20 displays, in the display 24, setting information (a non-limiting example of information regarding a setting of communication performed by the terminal) for adding a code using the second communication method.

This configuration has an effect of enabling the terminal to inform the user of the terminal that communication cannot be performed by the terminal, and perform setting of communication performed by the terminal based on the input made by the user of the terminal. Therefore, even if communication cannot be performed using the first communication method, for example, if the second communication method is set, communication can be performed with the server using the second communication method.

Also, the sixth embodiment shows a configuration in which the information indicating that communication cannot be performed by the terminal 20 includes information indicating that a terminal display code cannot be received from the server 10.

This configuration has an effect of enabling the terminal to inform the user that the first information cannot be received from the server.

While not restricted thereto, an example embodiment can be embodied as computer-readable code on a computer-readable recording medium. The computer-readable recording medium is any data storage device that can store data that can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network-coupled computer systems so that the computer-readable code is stored and executed in a distributed fashion. Also, an example embodiment may be written as a computer program transmitted over a computer-readable transmission medium, such as a carrier wave, and received and implemented in general-use or special-purpose digital computers that execute the programs. Moreover, it is understood that in example embodiments, one or more units of the above-described apparatuses and devices can include circuitry, a processor, a microprocessor, etc., and may execute a computer program stored in a computer-readable medium.

The foregoing exemplary embodiments are merely exemplary and are not to be construed as limiting. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. An information processing method to be carried out by a terminal configured to execute a payment processing operation related to a payment based on first information for making the payment using a code image, the information processing method comprising:
receiving, by a communication interface of the terminal, the first information transmitted from a server;
storing, by a processor of the terminal, the first information in a memory of the terminal; and
controlling, by the processor, a payment setting related to the payment that is based on the first information, based on a communication state of the terminal.

2. The information processing method according to claim 1,
wherein, when the communication state is a first communication state, the processor is configured to set the payment setting to a first payment setting, and when the communication state is a second communication state, the processor is configured to set the payment setting to a second payment setting which is different from the payment first setting,
wherein a second communication amount of communicated information in the second communication state is smaller than a first communication amount of communicated information in the first communication state.

3. The information processing method according to claim 1,
wherein the payment setting includes an amount setting related to an amount that to be used for the payment.

4. The information processing method according to claim 1,
wherein the payment setting includes an authentication setting related to authentication of a user of the terminal, the terminal being configured to execute the payment processing operation related to the payment.

5. The information processing method according to claim 4,
wherein the processor is configured to:
control the authentication as the payment setting when more than a first payment amount is paid as an amount of the payment and the communication state of the terminal is a first communication state; and
control the authentication as the payment setting when more than a payment second amount is paid as the amount of the payment and the communication state of the terminal is a second communication state,
wherein the second amount is smaller than the first amount,
wherein a second communication amount of communicated information in the second communication state is smaller than a first communication amount of communicated information in the first communication state.

6. The information processing method according to claim 4, further comprising
displaying a first code image that is based on the first information in a display region of the terminal,
wherein, when the communication state of the terminal is such that a communication amount of the terminal is smaller than a set communication amount, the processor is configured to control the authentication as the payment setting, based on the first code image that is hidden from the display region.

7. The information processing method according to claim 4,
wherein, when the communication state of the terminal is such that a communication amount of the terminal is smaller than a set communication amount, the processor is configured to control the authentication based on a duration during which the communication amount is smaller than the set communication amount.

8. The information processing method according to claim 1, further comprising
displaying a first code image that is based on the first information in a display region of the terminal,
wherein the payment setting includes a validity period setting related to a period of validity of the first code image.

9. The information processing method according to claim 1, further comprising:
acquiring, by the processor, store information related to a store at which the payment is to be made; and
controlling, by the processor, the payment setting based on the communication state of the terminal and reliability of the store.

10. The information processing method according to claim 1, further comprising:
displaying a first code image that is based on the first information in a display region of the terminal; and
controlling a display of the terminal, by the processor, to display second information based on the communication state of the terminal, in the display region in which the first code image is displayed.

11. The information processing method according to claim 10,
wherein the second information includes a notification related to hiding of the first code image when the communication state of the terminal is such that a communication amount of the terminal is smaller than a set communication amount.

12. The information processing method according to claim 10,
wherein, when the communication state of the terminal is a first communication state, the processor is configured to control a display of the terminal to display first validity period information related to a first period of validity as the second information in the display region of the display, and
when the communication state of the terminal is a second communication state, the processor is configured to control the display to display second validity period information related to a second period of validity as the second information in the display region,
wherein the second period of validity is shorter than the first period of validity,
wherein a second communication amount of communicated information in the second communication state is smaller than a first communication amount of communication information in the first communication state, and
when the second period of validity has expired, the processor is configured to control the display to hide the first code image from the display region of the display.

13. The information processing method according to claim 10,
wherein the terminal includes a first communication interface and a second communication interface which is different from the first communication interface,
the communication state of the terminal is a first communication state of the first communication interface of the terminal, and
the information processing method further includes, when the communication state of the terminal is such that a communication amount of the terminal is smaller than a set communication amount, controlling a display of the terminal, by the processor, to hide the first code image from the display region of the display based on payment completion information related to completion of the payment, the payment completion information being transmitted from a communication device and received by the second communication interface of the terminal.

14. The information processing method according to claim 1, further comprising:
displaying a first code image that is based on the first information in a display region of the terminal;
controlling a display of the terminal, by the processor, to hide the first code image from the display region of the display; and
transmitting, by the communication interface, third information indicating that the first code image is hidden from the display region to the server.

15. The information processing method according to claim 14,
wherein the third information is transmitted by the communication interface to the server based on the communication state of the terminal.

16. The information processing method according to claim 14,
wherein the third information is transmitted by the communication interface to the server at a set timing.

17. The information processing method according to claim 1, further comprising:
displaying a first code image that is based on the first information in a display region of the terminal; and
when the communication state of the terminal is such that a communication amount of the terminal is smaller than a set communication amount, disabling, by the processor, the first code image based on the first code image being hidden from the display region.

18. The information processing method according to claim 10,
wherein the second information is related to a period of validity of the first code image, and
the information processing method further includes:
when the communication state of the terminal is such that a communication amount of the terminal is smaller than a set communication amount and the period of validity has not expired, controlling a display of the terminal, by the processer, after hiding the first code image from the display region of the display, to display the first code image in the display region based on input in respect with the terminal by a user of the terminal, and
when the communication state of the terminal is such that the communication amount of the terminal is smaller than the set communication amount and the period of validity has expired, controlling the display, by the processor, to disable the first code image.

19. The information processing method according to claim 1,
wherein a plurality of the first information are stored in the memory, and
the information processing method further includes:
displaying a first code image that is based on one of the plurality of the first information, in a display region of the terminal; and
when the communication state of the terminal is such that a communication amount of the terminal is smaller than a set communication amount, controlling a display of the terminal, by the processor, after hiding the first code image from the display region of the display, to display a second code image which is different from the first code image in the display region based on input in respect with the terminal by a user of the terminal, the second code image being based on one of the plurality of the first information.

20. The information processing method according to claim 1, further comprising:
when the communication state of the terminal is such that a communication amount of the terminal is smaller than a set communication amount, displaying, in a display region of the terminal, communication status information indicating that communication cannot be performed by the terminal; and
displaying, in the display region, a setting of communication performed by the terminal based on an input by a user of the terminal with respect to the communication status information indicating that communication cannot be performed.

21. The information processing method according to claim 20,
wherein the communication status information indicating that communication cannot be performed indicates that the first information cannot be received from the server.

22. A non-transitory computer readable storage medium storing program instructions that are executable by a processor of a terminal, to perform an information processing method, the terminal being configured to perform a payment processing operation related to a payment based on first information for making the payment using a code image, the information processing method comprising:
receiving, by a communication interface of the terminal, the first information transmitted from a server;
storing, by the processor, the first information in a memory of the terminal; and
controlling, by the processor, a payment setting related to the payment that is based on the first information, based on a communication state of the terminal.

23. A terminal configured to execute a payment processing operation relating to a payment based on first information for making the payment using a code image, the terminal comprising:
a memory configured to store computer-readable program instructions; and
one or more processors configured to execute the program instructions to:
receive the first information from a server;
control the memory to store the first information in the memory of the terminal; and
control a payment setting related to the payment that is based on the first information, based on a communication state of the terminal.
